(19) United States
(12) Patent Application Publication
(10) Pub. No.: US 2012/0317058 A1
(43) Pub. Date: Dec. 13, 2012

(54) DESIGN OF COMPUTER BASED RISK AND SAFETY MANAGEMENT SYSTEM OF COMPLEX PRODUCTION AND MULTIFUNCTIONAL PROCESS FACILITIES-APPLICATION TO FPSO'S

(76) Inventor: Kingsley E. ABHULIMEN, Westbury, NY (US)

(21) Appl. No.: 13/158,873

(22) Filed: Jun. 13, 2011

(51) Int. Cl. G06N 7/04; G06N 3/06; G06N 7/02

(52) U.S. Cl. 706/2; 706/52

(57) ABSTRACT

A method for predicting risk and designing safety management systems of complex production and process systems which has been applied to an FPSO System operating in deep waters. The methods for the design were derived from the inclusion of a weight index in a fuzzy class belief variable in the risk model to assign the relative numerical value or importance a safety device or system has contain a risk hazards within the barrier. The weights index distributes the relative importance of risk events in series or parallel in several interactive risk and safety device systems. The fault tree, the FMECA and the Bow Tie now contains weights in fizzy belief class for implementing safety management programs critical to the process systems. The techniques uses the results of neural networks derived from fuzzy belief systems of weight index to implement the safety design systems thereby limiting use of experienced procedures and benchmarks. The weight index incorporate Safety Factors sets SFri {0, 0.1, 0.2 . . . 1}, and Markov Chain Network to allow the possibility of evaluating the impact of different risks or reliability of multifunctional systems in transient state process. The application of this technique and results of simulation to typical FPSO/Riser systems has been discussed in this invention.

### BACKGROUND OF THE INVENTION

1. Field of the Invention

The present invention generally relates to a method and expert system for risk assessment and safety management, more particularly, to a real-time method and system for detecting, predicting, assessing and managing risk events and providing Safety reliability of FPSO process and systems and managing information corresponding thereto to complex multifunctional process systems, such as Offshore Platforms/flow lines and Risers, Deepwater Assets, Subsurface drillings, Well Completions and Placements, complex pipeline network, complex refinery, chemical, complex systems, Industry Processes, Power Plants, Electrical Production and Transmission Systems, Construction Projects, Rig Managements etc. The present invention may be employed with respect to risk management and safety, for process systems, pipelines, storage tanks of process systems, facility and asset systems, exploration studies, energy production and distribution, design and construction of offshore floating and fixed structures, business corporate enterprise systems.

2. The Prior Art

Risk and reliability analysis forms part of an integral program for process design and development of any system. Several techniques have been presented in literature for reliability and risk analysis (1). Among the most frequently used are quantitative risk analysis, the probabilistic safety analysis, worst-case methodology and optimal risk analysis, markov chain for transient systems (2). Significant advancement has been made in developing newer method for hazard and risk assessment, consequence modeling and user friendly tools. However, while foreseeing worst-case scenarios is common, little attention is paid in envisioning credible scenarios. In evaluating risk assessment studies conducted by different group, there exist the problems on how the analysts view the accident scenarios. Hence, different analyst may view the risk associated with an event differently and can provide different representations on the actual potential of the risk. This problem exists because of absence of a unified method for quantifying the magnitude of risk and envisaging accident scenarios and credibility assessment.

The historic approach to process and plant design relied primarily on the expertise of the technical persons in charge, and in the better cases, used standards incorporating the learning of prior experience (1). This applied to many aspects of design, and particularly to safety and reliability analysis. More recently, emphasis has been on using well-defined work processes that lead engineers to solutions that are beyond personal experience. Hazard and operability (HAZOP) analysis, fault tree analysis and similar techniques have been used to carry out hazard analysis and engineered risk control. Reliability Centered Maintenance (RCM and RCM-II) and similar techniques have been introduced recently to improve the reliability of process and plant systems. Data analysis of typical multifunctional system like the floating production Oil and Gas system in a Deep Offshore Water can become cumbersome. Some equipment can be critical to safe operation.

There are many methodologies proposed for reliability, risk and safety analysis for most, if not all, process industries known today. Among the most popular ones are quantitative risk analysis, probabilistic safety analysis, worst-case methodology for risk assessment and optimal risk analysis. The optimal risk analysis (ORA) appears to be the most suitable, as it is fast, less expensive to implement, less time consuming and more precise than alternative analysis. ANSI/ISA S84.01-1996 is the consensus standard for process safety in the U.S., deemed to meet the OSHA 1910.119 PSM regulation.

Three methodologies are proposed in the (TR84.02) report published by ISA (International Standard Association). They are simplified equations, fault tree analysis, and Markov modeling to implement the safety performance requirements of the standard. The standard requires that the average probability failure on demand (PFDavg) be used in this analysis.

Various methods have been proposed to monitor pipelines. U.S. Pat. No. 7,451,003 entitled METHOD AND SYSTEM OF MONITORING; SENSOR VALIDATION AND PREDICTIVE FAULT ANALYSIS employs sensors. The sensor data is continuously analyzed to provide predictive alarms using models of normal process operation. Fuzzy logic is used in various fault situations to compute certainty factors to identify faults and/or validate underlying assumptions. Our prior U.S. Pat. No. 6,970,808 is entitled REALTIME COMPUTER ASSISTED LEAK DETECTION/LOCATION REPORTING AND INVENTORY LOSS MONITORING SYSTEM OF PIPELINE NETWORK SYSTEMS. The system utilizes a flow model and deterministic criteria based on a Liapunov Stability Theory. A deviation matrix is constructed based on the flow model and deterministic criteria to generate eigenvalues. However, neither of these patents suggests constructing a Risk Safety Matrix having weights for each risk event along with a safe index system. Furthermore, the prior art does not disclose weights derived from a weight index in a Fuzzy class belief system to assign relative numerical values of a safety device. Other approaches have been discussed in our publication, hereinafter referred to as the Abhulimen publication. The publication is entitled MODEL FOR RISK AND RELIABILITY ANALYSIS OF COMPLEX PRODUCTION SYSTEMS: APPLICATION TO FPSO/FLOW-RISER SYSTEMS, appeared in Computers and Chemical Engineering, Vol. 33, Issue 7, pages 1306-1321 (2009).

U.S. Pat. No. 7,673,525 entitled SENSOR SYSTEM FOR PIPE AND FLOW CONDITION MONITORING OF A PIPELINE CONFIGURED FOR FLOWING HYDROCARBON MIXTURES provides Doppler profiles through a pipeline section to monitor and/or measure deposits and corrosion on the pipe. Thermal sensors and acoustic impedance sensors may be used in combination with the Doppler sensors to provide for determination of flow assurance or pipeline monitoring. U.S. Patent Application 2008/0163692 entitled SYSTEM AND METHOD FOR USING ONE OR MORE THERMAL SENSOR PROBES FOR FLOW ANALYSIS; FLOW ASSURANCE AND PIPE CONDITION MONITORING OF A PIPELINE FOR FLOWING HYDROCARBONS uses at least one thermal sensor probe to determine flow properties and/or pipeline conditions. A network of noninvasive sensors may provide output data that may be data-fused. U.S. Pat. No. 7,359,931 entitled SYSTEM TO FACILITATE PIPELINE MANAGEMENT, SOFTWARE; AND RELATED METHODS describes a computer network that is adapted for pipeline facility management. The network includes a company server to store software and database records, that is, coupled to a processor, display and user interface. Remote computers access pipeline information and communicate it to the server.

While the benefits of these methods have been well demonstrated in many publications, it appears that the development of a system that captures the intrinsic behavior of the risk events and reliability status of typical complex multifunctional system has not been sufficiently investigated or understood. The problems are normally associated with the complexity of the interacting components and the associate process hazards that could lead to failure, as discussed in the Abhulimen publication.

A system model that incorporates the use of a weight function in a fuzzy belief structure to capture the behavior of complex risk and safety behavior of the interacting components of the subsystem have been presented in this patent as a novel solution to solve multicomponent-multifunctional dimensional risk system analysis.

It would be helpful to consider Risk, not as the possibility of danger, as presented in most literatures, but as an integral part of any system or process, which could be present or absent. Risk is the presence of danger that has a potential to undermine the integrity of a system (process or a facility).

The main objectives of risk analysis are:
To provide a basis for prioritizing between alternative solutions and actions.
To provide a basis for deciding whether reliability and risk are acceptable.
To provide a basis for evaluating the profitability of a project.
To provide a basis for the development of safe and effective procedures for the operation or the monitoring of the process or the equipment.
To undertake a systematic description of undesirable events and their potential consequences.
To achieve improved system knowledge as a result of analysis of connection and interaction of the components in the system. To develop competence and motivation for systematic follow up.

Safety on the other hand is immunity from danger as no system can be claimed to be totally risk free. This understanding changes the view point on how operators should determine risk or conduct safety as against previous art which says that risk is the probability of danger.

The limitations of conventional systems for risk and reliability management based on methods for hazard and risk analysis has made the introduction of a sound method inevitable. Some of the limitations are:

Complexity of Interacting Risk Events in Multifunctional Systems making risk analysis difficult.

Lack of Performance Based Methods for Reliability and Risk Analysis in Variable Hazard Rate Systems

Mostly Empirical Based & System Specific Methods. Risks, Reliability and Safety Studies Rely on Failure Data which are Specific to the System and do not readily offer itself as a Tool to other prospective users.

As can be appreciated, because of inherent shortcomings of previous risk, reliability and safety management system based methods, a need exist for better methods and systems for risk and reliability management of process systems that have fast response time and produce real time risk assessment and safety management of process systems and facilities which generates no false alarms at optimal cost and can predict accurately risk in multifunctional complex process systems. Also the system model should be universal to most if not all process systems and locate risk events in components precisely, and detect faults in minutes through an assisted computer information feedback system.

Advances in web based enabled interface and protocols with enhanced security features, has created a vacuum gap between conventional risk and reliability assessment software available in the market and need for enhanced web enable risk and Safety technologies for effective information and safety management.

The historic approach to process plant design relied primarily on the expertise of the technical persons in charge, and in the better cases, used standards incorporating the learning of prior experience, as discussed in the Abhulimen publication. This applied to many aspects of design, and particularly to safety and reliability analysis. More recently, emphasis has been on using well-defined work processes that lead engineers to solutions that are beyond personal experience. Hazard and operability (HAZOP) analysis, fault tree analysis and similar techniques have been used to deal with hazard analysis and engineered risk control. Reliability Centered Maintenance (RCM and RCM-II) and similar techniques have been introduced recently to improve the reliability of process plants. However Data analysis of typical risk and hazard components multifunctional FPSO system of complex accident paths are non-existent. Some equipment can be critical to safe operation, as discussed in the Abhulimen publication.

In engineering safety analysis, intrinsically vague information may coexist with conditions of “lack of specificity” originating from evidence not strong enough to completely support a hypothesis but only with degrees of belief or credibility, as discussed in the Abhulimen publication, based on the concept of belief function is well suited to modeling subjective credibility induced by partial evidence.

The D-S theory enlarges the scope of traditional probability theory, describes and handles uncertainties using the concept of the degrees of belief, which can model incompleteness and ignorance explicitly. It also provides appropriate methods for computing belief functions for combination of evidence, as discussed in the Abhulimen publication. Besides, the D-S theory also shows great potentials in multiple attribute decision analysis (MADA) under uncertainty, where an evidential reasoning (ER) approach for MADA under uncertainty has been developed, on the basis of a distributed assessment framework and the evidence combination rule of the D-S theory, as discussed in the Abhulimen publication.

Although FPSOs and other Offshore Systems for Oil/Gas Production are becoming more common, operational safety performance may still be considered somewhat unproven, especially when compared to fixed installations. Furthermore, floating installations are more dependent on continued operation of some of the marine control systems, during a critical situation. There is accordingly a need to understand the aspects of operational safety for FPSOs, in order to enable a proactive approach to safety, particularly in the following areas:
Turret operations and flexible risers
Simultaneous marine and production activities
Vessel movement/weather exposure
Production, ballasting and offloading

Although FPSOs are becoming more common, operational safety performance may still be considered somewhat unproven, especially when compared to fixed installations. Furthermore, floating installations are more dependent on continued operation of some of the marine control systems, during a critical situation. There is accordingly a need to understand the aspects of operational safety of FPSOs operating in a deep water environment, especially in design of Bowtie systems used to model accident pathways in order to enable a proactive real-time approach to mitigate against threat and provide for safety, particularly in the following areas: (1). Turret operations and flexible risers (2) Simultaneous marine and production activities (3) Vessel movement-weather exposure (4) Production, ballasting and offloading. Some efforts have also been devoted to modeling of operational safety. These methods are mainly descriptive, not predictive, and are thus not very effective in determining how to prevent accidents.

Hazard evaluation and risk analysis for FPSO systems falls under the following class. (1) Accident during tank operations, including ballasting, loading and off-loading (2) Tank explosion during intervention (3) Riser failure due to inadequate response to rapid wind change (4) Loss of hydrocarbon containment due to failure during load handling by cranes (5). Organizational reliability study. Major accidents may occur due to technical and or operational failures, the latter may be caused by human and organizational errors. The benefits of using better predictive tools in risk and safety modeling cannot be over emphasized; some of which are: 1.) Determination of which equipment, instruments and hazards are truly critical to reliability. A typical risk based inspection model is established by intrinsically representing actual hazards, MTBF (mean time before 60% failure), hazard shape function βᵢ and safety function in a weighted-fuzzy class belief index. More recently, emphasis has been on using well-defined work processes that lead engineers to solutions that are beyond personal experience. Hazard and operability (HAZOP) analysis, fault tree analysis and similar techniques have been used to deal with hazard analysis and engineered risk control. Reliability Centered Maintenance (RCM and RCM-II) and similar techniques have recently been introduced to improve modeling risk and reliability of process plants. Nevertheless because of difficulty in measuring hazard and safety data of components present in complex accident pathways of multifunctional FPSO system, computing hazard rates relating to failures especially for new designs are typical non-existent. Some equipment can be critical to safe operation (2) and data relating to the possible hazards and safety aspects may not be available.

In engineering safety analysis, intrinsically vague information may coexist with conditions of “lack of specificity” originating from evidence not strong enough to completely support a hypothesis but only with degrees of belief or credibility (Binaghi and Madella, 1999). Dempster-Shafer (D-S) theory of evidence (Dempster, 1968; Shafer, 1976) based on the concept of belief function is well suited to modeling subjective credibility induced by partial evidence (Smets, 1988).

The D-S theory enlarges the scope of traditional probability theory that describes and handles uncertainties using the concept of the degrees of belief, which can used to model incompleteness and ignorance explicitly. It also provides appropriate methods for computing belief functions for combination of evidence (Pearl, 1988). Besides, the D-S theory also shows great potentials in multiple attribute decision analysis (MADA) under uncertainty, where an evidential reasoning (ER) approach for MADA under uncertainty has been developed, on the basis of a distributed assessment framework and the evidence combination rule of the D-S theory (Yang and Singh 1994; Yang and Sen 1994, 1997; Yang, 2001; Yang and Xu, 2002a, b).

According to (HSE, 2002) (10) accidents are often initiated by errors induced by human and organizational factors (HOF), technical (design) failures or a combination of both. Effective means to prevent or mitigate the effects of potential operational accidents are therefore important for the offshore and marine industries at large. It has been reported that (HSE 2002) predictive risk and reliability techniques have been used in the North Sea offshore industry for almost 20 years, and have contributed to the reduction of the incidence rate of severe accidents. These techniques are traditionally focused more on technical aspects of design, construction and operation, than on human and organizational aspects. The inclusion of weights index in reliability and risk modeling to account for safety and hazard shape function. The methods used to provide compensation for the safety aspects and hazard shaped function associated with each process systems shapes perception of modeling Bow Tie Systems in the following ways:
Selection of a more safety and maintenance requirements strategy based on the information of the hazard weights values of the different component of the system.
Provide a basis for providing information on redundant systems not critical to the safety or risk to the process or facility.
Providing a measure of the correlation of the complexity of safety-risk pair of complimentary hazards and the reliability of the systems to prevent loss in containment.

Allows a measure of the performance and effectiveness of safety devices

In this invention the possibility of realizing these benefits has been demonstrated using fuzzy belief-class weight index to construct numerical measure of actual field data hazards which are relevant to represent failure consequence data for hazard rate data that are questionable or unavailable. Further, the method have been demonstrated to give a measure of the safety aspects and hazard shape function in risk modeling in Bow Tie Systems that methods accident pathways in typical FPSO systems using Industry and Literature Data.

These techniques have traditionally focused more on technical aspects of design, construction and operation, than on human and organizational aspects. Some efforts have also been devoted to modeling of operational safety. These methods are mainly descriptive, not predictive, and are thus not very effective in determining how to prevent accidents.
Accident during tank operations, including ballasting, loading and off-loading
Tank explosion during intervention
Riser failure due to inadequate response to rapid wind change
Loss of hydrocarbon containment due to failure during load handling by cranes
Organizational reliability study

Major accidents may occur due to technical and/or operational failures, the latter may be caused by human and organizational errors. A model is now provided using hazard data derived from weighted risk fuzzy reasoning, neural networks and belief systems to construct numerical measure for safety integrity under the impact of FPSO's risk systems. The main benefits are it:
Determines which equipment, instruments and hazards are truly critical to reliability. A typical risk based inspection model is established by intrinsically connecting actual hazards, MTBF (mean time before 60% failure), hazard shape function βᵢ and safety function. The introduction of weights index incorporated in reliability and risk modeling provides a new consideration for the safety aspects that are linked to hazard systems for process systems.
Helps the designer to explore and select a more reliable model and maintenance requirements strategy based on the information of the weights of the different component of the system.
Provide a basis for providing information on redundant systems not critical to the safety or risk to the process or facility.
Providing a measure of the correlation of the complexity of safety-risk pair of complimentary hazards and the reliability of the systems to prevent loss in containment.

Allows a measure of the performance and effectiveness of safety devices.

This present invention revolutionize risk and safety management techniques in setting designs for Bow-Tie Diagrams derived from fuzzy reasoning, neural networks and belief systems to construct numerical measure for safety integrity under the impact of FPSO's risk systems. Current thresholds of deviation in assessment studies for risk and safety systems for multicomponent and multifunctional process systems used today are serious concerns coupled with the slow level of response time feedback, hence making most risk and safety management system impractical and difficult to use. There is a need for a more robust risk and safety management system that is error proof and has fast response feedback time, which is enabled by a web based interactive platform for expert risk and reliability assessment and management that would reduce the time lag between detection and maintenance.

### SUMMARY OF THE INVENTION

The problems stated above, as well as other related problems of the prior art, are solved by the present invention, which is directed to a software based risk and safety management expert system built on sound methods for risk and fault, assessment, monitoring and reliability methods as well as safety management techniques, implemented by an expert computer assisted feedback system, that achieves real time fault-risk detection and planned safety maintenance, no false alarm thresholds and have strong robust attributes, which can analyze risk events in any process and facility system or combination of both.

The invention is an online web based enabled real time risk and safety information management system that allows users the flexibility to assess information and interact with the process and facility system to track faults in any process or network of systems, enhanced by use of security features like enhanced web based encrypted capability with backup failed server platform.

The invention consist of system of source codes with their plurality of sub codes connected to a web based information expert system constructed in Java Script program source codes which is installable in a laptop or server computer as an OEM license or derivable as a computer CD.

The invention consist of a system that can detect, assess and track faults and risk events in any complex network of process systems and can trigger an alarm to operators or users through a fax\modem, a web modem or voice modem in any part of the world accurately at response time of less than a minute. The computer host server is coupled online for intercommunication to a plurality of stations or clients from which respective authorized users each have a browser-based interface with the computer.

The methods invented for fault detection, risk analysis and safety management completely eliminates false alarms associated with instrument error or error generated by complexity of model describing the risk events.

This invention differs from conventional risk detection and assessment systems primarily because it uses a weight matrix in a fuzzy class belief structure randomized within certain limits of safety factors which cannot be less than zero or greater than 1 to capture the risk events of subcomponents in the System or Process Systems considered either in series or parallel mode or a network existing as a network of both modes in a transition matrix.

Furthermore this invention uses the Safety Deviation Matrix to show shift in the safe operating or design position of the plant or process systems with respect to the process operating and design variables, and demonstrate and how a shift in process operating or design variables can move the process or facility to an unsafe mode is presented.

This invention also evaluates the limit of safety as the position when the Safety Matrix is 1 in absolute terms, and values below −1 indicates a risk event and values above 1 indicates a reliable system.

A safety matrix of the process system based on the reliability and risk superstructure can be evolved for any process or facility system with the method presented in this patent report, with all the process variables that can lead to offset or failure systematically identified. The safe and constrained functions of the process system can be modeled, and the optimum matrix of safety determined.

These and other related objects are achieved according to an embodiment of the invention by a first aspect of the invention including an apparatus for detecting faults and risk events of complex multifunctional systems and sub-systems arranged in a hierarchy. The apparatus includes a plant having a pipeline layout design for transporting petroleum products in accordance with a plant process which comprises the systems and sub-systems in the hierarchy. A sensor measures operational and design variability of the systems and sub-systems in the hierarchy and provides sensor data output. A memory device stores a database and a set of instructions which are programmed to (i) analyze sensor data output and construct a Risk Safety Matrix System within the database having weights for each risk event, and (ii) provide a hazard chain modified safe bowtie system HR-EFECT-COM-SAFE BOWTIE to identify all hazards, and analyzed threats. In this document HR is defined as the Hazard Risk. The instructions also provide a safe index systems using the weight index to quantify the level of safety to control and manage the threats against release of containment from complex multifunctional systems and subsystems, wherein the weights are derived from a weight index in a fuzzy class belief variable in the Risk Safety Matrix System to assign the relative numerical value of a safety device.

The set of instructions are programmed to establish weights according to a Weighting Ranking Function used to construct a Fault Tree Weighted Superstructure that assigns relative weight to each Risk or Safety event in N-interacting Events, the weights being indicative of the safety index of the risk system. The Weighting Ranking Function is variable in time, process and system type, operating conditions and environment allowing the capturing of the Overall Risk or Reliability of the system and subsystems. The apparatus further includes a history of Curve Failure data stored within the database that uses real time measurements from the sensor over a specified period of time.

The risk is assessed by neural networks and fuzzy belief systems in combination with the Weighting Ranking Function to collectively provide reliability modeling to implement the safety aspects to risk systems. The fuzzy belief systems and neural network weights representing actual hazard data are used to construct hazard data from Monte-Carlo Simulations that are stored in the database. The safety index is assessed on the basis of three fundamental parameters comprising (1) Failure Rate (FR), (2) Consequence Severity (CS), and (3) Failure Consequence Probability.

The Failure Rate (FR) is expressed as a Homogeneous Poisson Process (HPP) probability distribution function given by:

$$f ( n ) = \frac{{( {ω}_{avg} λ t )}^{n} exp ( - {ω}_{avg} λ t )}{n !} n = 0 , 1 , 2 … \qquad ( 7 )$$

t is the time and λ is the constant failure or arrival rate. The cumulative failure distribution function is given by

$$\begin{matrix}F = {\sum }_{i = 0}^{n} \frac{{( {ω}_{avg} λ t )}^{i} exp ( - {ω}_{avg} λ t )}{i !} & ( 8 ) \\ {R}_{st} ( t ) = {\sum }_{i = 0}^{n} \frac{{( {ω}_{avg} λ t )}^{i} {e}^{- λ {ω}_{vg} t}}{i !} . & ( 9 )\end{matrix}$$

The fuzzy belief systems include belief degrees in a rule that are accounted for by considering the relative weight of each rule among all rules (the rule weight), and the relative weight of each antecedent attribute (the attribute weight). The weights representing the safety aspects, hazard shape functions and numerical relation between series/parallel hazards in risk and reliability modeling can be combined thus:

$$\begin{matrix}{\sum }_{i} ( {ω}_{i} {⋃}_{i} ) ⊆ {U}_{RPROCES SYSTEM} & ( 1 ) \\ {\prod }_{i = 1}^{N} ( {ω}_{i} {⋃}_{i} ) ⊆ {U}_{RPROCES SYSTEM} & ( 2 )\end{matrix}$$

Where i can represent, human, environment, process, mechanical, operational, environment hazards, and ω̅ᵢ takes only numerical values to qualify contributions of the safety aspects, and wherein the Weibull, gamma and Log-Normal Density functions can be used as representative Probability Functions, where Weights index in risk modeling provides consideration for the critical safety elements that may prevent human failure, in which the risk potential including weights is provided:

$$\begin{matrix}Risk Potential = \frac{1 - {\prod }_{i = 1}^{n} {( 1 - {r}_{i} )}^{{ω}_{I}}}{{\prod }_{i = 1}^{n} {( {R}_{si} )}^{{ω}_{I}}} & ( 3 ) \\ Risk Potential = \frac{{\prod }_{i = 1}^{n} {r}_{i}^{{ω}_{I}}}{1 - {\prod }_{i = 1}^{n} {( 1 - {R}_{si} )}^{{ω}_{I}}} & ( 4 )\end{matrix}$$

Where the ri inputs are expressed as exponential distributions

rᵢ(t)=1−e^{-λ}^{_{ω}}^{t}

Rₛᵢ(t)=e^{-λ}^{_{ω}}^{t}.

The apparatus also includes a sub apparatus for providing a real-time computer based expert management and decision support systems for risk and safety design and management of FPSO's operating in a deepwater not relying on prior experience by use of a fuzzy-belief systems to enable operates have a smart framework model for implementing critical safe decisions to advert loss in containment and profits.

A second aspect of the invention relates to a method for detecting faults and risk events of complex multifunctional systems and sub-systems arranged in a hierarchy. The method includes providing a plant having a pipeline layout design for transporting petroleum products in accordance with a plant process which comprises the systems and sub-systems in the hierarchy. Next the step of sensing operational and design variability of the systems and sub-systems in the hierarchy and providing sensor data output. A database and a set of instructions are stored in a memory device, for programming the set of instructions to perform the steps of (i) analyzing sensor data output and constructing a Risk Safety Matrix System within the database having weights for each risk event, and (ii) providing a hazard chain modified safe bowtie system HR-EFECT-COM-SAFE BOWTIE to identify all hazards, and analyzed threats. A safe index systems uses the weight index to quantify the level of safety to control and manage the threats against release of containment from complex multifunctional systems and subsystems. The final step involves deriving the weights from a weight index in a fuzzy class belief variable in the Risk Safety Matrix System to assign the relative numerical value of a safety device.

The programming step further includes establishing weights according to a Weighting Ranking Function used to construct a Fault Tree Weighted Superstructure and assigning relative weight to each Risk or Safety event in N-interacting Events, the weights being indicative of the safety index of the risk system. The Weighting Ranking Function is variable in time, process and system type, operating conditions and environment allowing the capturing of the Overall Risk or Reliability of the system and subsystems. The method includes a history of Curve Failure data within the database that uses real time measurements from the sensor over a specified period of time.

The method further includes assessing the risk by neural networks and fuzzy belief systems in combination with the Weighting Ranking Function and collectively providing reliability modeling to implement the safety aspects to risk systems. The fuzzy belief systems and neural network weights represent actual hazard data, and wherein the method further includes constructing further hazard data from Monte-Carlo Simulations that are stored in the database. The safety index is assessed on the basis of three fundamental parameters comprising (1) Failure Rate (FR), (2) Consequence Severity (CS), and (3) Failure Consequence Probability.

The method also includes expressing the Failure Rate (FR) as a Homogeneous Poisson Process (HPP) probability distribution function given by:

$$f ( n ) = \frac{{( {ω}_{avg} λ t )}^{n} exp ( - {ω}_{avg} λ t )}{n !} n = 0 , 1 , 2 … \qquad ( 7 )$$

t is the time and λ is the constant failure or arrival rate. The cumulative failure distribution function is given by

$$\begin{matrix}F = {\sum }_{i = 0}^{n} \frac{{( {ω}_{avg} λ t )}^{i} exp ( - {ω}_{avg} λ t )}{i !} & ( 8 ) \\ {R}_{st} ( t ) = {\sum }_{i = 0}^{n} \frac{{( {ω}_{avg} λ t )}^{i} {e}^{- λ {ω}_{vg} t}}{i !} . & ( 9 )\end{matrix}$$

The fuzzy belief systems include belief degrees in a rule that are accounted for by considering the relative weight of each rule among all rules (the rule weight), and the relative weight of each antecedent attribute (the attribute weight). The weights representing the safety aspects, hazard shape functions and numerical relation between series/parallel hazards in risk and reliability modeling can be combined thus:

$$\begin{matrix}{\sum }_{i} ( {ω}_{i} {⋃}_{i} ) ⊆ {U}_{RPROCES SYSTEM} & ( 1 ) \\ {\prod }_{i = 1}^{N} ( {ω}_{i} {⋃}_{i} ) ⊆ {U}_{RPROCES SYSTEM} & ( 2 )\end{matrix}$$

Where i can represent, human, environment, process, mechanical, operational, environment hazards, and ω̅ᵢ takes only numerical values to qualify contributions of the safety aspects, and wherein the Weibull, gamma and Log-Normal Density functions can be used as representative Probability Functions, where Weights index in risk modeling provides consideration for the critical safety elements that may prevent human failure, in which the risk potential including weights is provided:

$$\begin{matrix}Risk Potential = \frac{1 - {\prod }_{i = 1}^{n} {( 1 - {r}_{i} )}^{{ω}_{I}}}{{\prod }_{i = 1}^{n} {( {R}_{si} )}^{{ω}_{I}}} & ( 3 ) \\ Risk Potential = \frac{{\prod }_{i = 1}^{n} {r}_{i}^{{ω}_{I}}}{1 - {\prod }_{i = 1}^{n} {( 1 - {R}_{si} )}^{{ω}_{I}}} & ( 4 )\end{matrix}$$

Where the ri inputs are expressed as exponential distributions

rᵢ(t)=1−e^{-λ}^{_{ω}}^{t}

Rₛᵢ(t)=e^{-λ}^{_{ω}}^{t}.

The method further includes a sub apparatus for providing a real-time computer based expert management and decision support systems for risk and safety design and management of FPSO's operating in a deepwater not relying on prior experience by use of a fuzzy-belief systems to enable operates have a smart framework model for implementing critical safe decisions to advert loss in containment and profits.

### BRIEF DESCRIPTION OF THE DRAWINGS

The advantages, nature and various additional features of the invention will appear more fully upon consideration of the illustrative embodiments now to be described in detail in connection with the accompanying drawings. In the drawings wherein like reference numerals denote similar components throughout the views:

FIG. 1A is a diagram of a standby redundancy model.

FIG. 1B is a flowchart of the steps in the Monte Carlo method.

FIG. 2 is a diagram of a neural network modeled using inputs from numerical sets of Fuzzy Belief linguistic classifications.

FIG. 3 is a bowtie diagram.

FIGS. 4A through 4G are a series of diagrams showing a Hazard Chain.

FIGS. 5A through 5F are a series of flowcharts showing Risk Assessment and Risk Tolerance.

FIGS. 6A through 6E are a series of diagrams showing potential hazards relating to the bowtie.

FIG. 7 is a graph of the Hazard Shape Index.

FIGS. 8A through 8D are tables containing weight data by Fuzzy Class.

FIG. 9 is a graph of a further Hazard Shape Function.

FIG. 10 is a graph of another Hazard Shape Index.

FIG. 11 is a diagram of a safety system.

FIG. 12 is a diagram of a probability tree.

FIG. 13 is a table containing weight arrays for different shape factors and safety functions.

FIG. 14 is another diagram showing Risk Assessment.

FIG. 15 is a further diagram showing Risk Tolerance.

FIG. 16 is a diagram of a Risk-Safety Matrix.

FIG. 17 is a diagram of riser flow line system.

FIG. 18 is a transient diagram for a riser flow line system.

FIG. 19 is an organizational diagram.

FIG. 20 is a table containing risk analysis and risk systems.

FIGS. 21A-H is a Typical FPSO Hazard Register Data that is divided across eight pages.

FIGS. 22A-B is a pair of Fuzzy Class Log in No Tables.

FIG. 23 is an FPSO Based Production Facility Table.

FIG. 24 is a Hazard Register Consequence Table.

FIG. 25 is a Threats table.

FIG. 26 is a Safeguards, Release, Mitigation and Consequences Table.

FIGS. 27-46 are a series of graphs showing curves for various Hazard and Belief variables.

### DETAILED DESCRIPTION OF THE PREFERRED EMBODIMENTS

The entire idea of this invention is to provide a real time assisted computer expert system that is web based interactive and proactive, which allows operators and users set up an information management system and be proactive in fault detection and risk assessment, with capability to locate faults in any process system to advert the consequences of the risk of failure of process systems. The processes involved in the life cycle to translate this architecture design into an operating software involves the following stages: project planning, software development platform requirement and specification, definition of standards, specification of development language, building the source codes, interfacing the source codes, integrating the source codes with other license software using a interconnecting source codes, integrating the software into a web based platform, running the software program, debugging, constructing a pilot test program, rerunning the software program codes, standardization, implementation on a real Process and Plant system, integrating into a web based servers. Current invention features the description of a sound model for fault detection, risk and reliability assessment and management, construction of the system architecture, definition of project requirements, and construction of source codes, and sub codes, definition of development platform. The publication entitled MODEL FOR RISK AND RELIABILITY ANALYSIS OF COMPLEX PRODUCTION SYSTEMS: APPLICATION TO FPSO/FLOW-RISER SYTEMS, in Computers and Chemical Engineering, Vol. 33, Issue 7, pages 1306-1321 (2009) by Dr. Kingsley Abhulimen is incorporated herein by reference thereto. Throughout this specification the publication shall be referred to as the “Abhulimen publication.”

A bowtie diagram is a three part graphical representation for describing and assessing risk. The first part is a fault tree, the middle is a hazard and the last part is an event tree. For example, the hazard might consist of a pipeline leak. The fault tree then specifies all the possible causes of a leak and may be expanded to include threat controls, or systems or personnel that are responsible for managing each potential threat. The event tree then outlines the possible consequences of the potential hazard and may include mitigation factors.

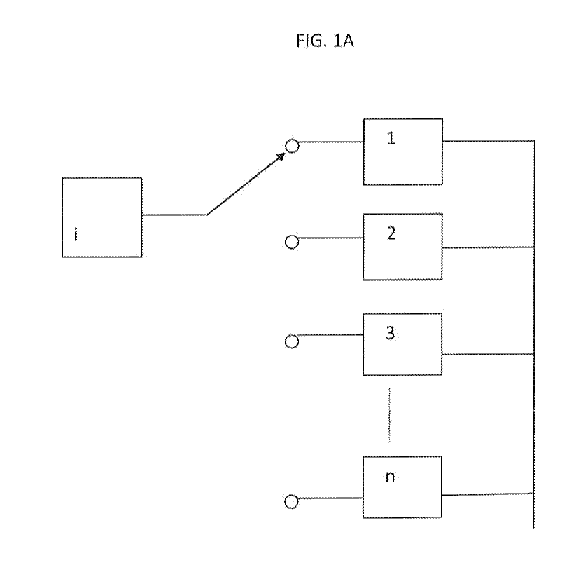

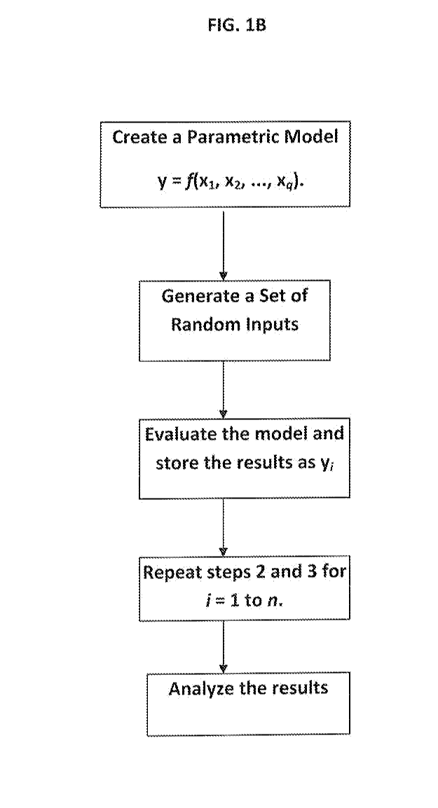

An FPSO is a floating production, storage and offloading unit contained in a floating structure. It processes hydrocarbons pumped onto it from a drilling platform and stores them until a tanker is available to receive the product. For example, some oil tankers have been equipped with production facilities to process raw materials and store them until they can be offloaded onto a transportation ship. A diagrammatic representation and corresponding description of a typical FPSO with riser systems connected is shown in FIG. 1 of the Abhulimen publication.

The present invention embodies a database component for collecting and recording data on process systems, operational and design data, risk events, fault scenarios status, hazard rate, FMECA (Fault Mode and Effect, Critical Limits) and transposing these data into a plurality of scenarios for decision or monitoring purpose coming either come in a fax, e-mail or voice modem mode at user's discretion. This database component forms part of an active subsystem of the integrated fault detection and reliability safety management system. The database component which consist of application source codes that manages entry, storage and retrievable of data associated with risk events and process operation variables, process integrity loss is executed on a license Oracle Software database platform. Furthermore, the application includes a database information section, a file management section, and a report generating section.

One advantage of the present invention is that the characteristic eigenvalues generated from a Safety Deviation Matrix of Safety, allows users fast response time and detection of faults in the hierarchy, fast response to maintenance or repair to faulty parts in the system and greater flexibility of managing the information flow and wider accessibility through a web based internet interface about process or plant Integrity Status, Fault Modes and Reliability.

Another advantage of the present invention is that all information can be managed in one central database assessable by a plurality of user database station.

Other features and advantages of the present invention will be apparent from the following more detailed descriptions, taken in conjunction with the accompanying drawings which illustrate, by way of example, the principle of the invention.

This invention presents a method for detecting faults and risk events of complex and multifunctional complex interacting systems. The method describes in this invention requires a SCADA Software System that interfaces database our user sensing instruments that measures operational and design variability of the subsystems and systems in the hierarchy. Our methods uses the process or plant layout design, measurements of the propagating operational process variables, design conditions and operating environment, and using the Hazop and FMECA analysis for studied systems to construct the Risk Safety Matrix Systems having Subcomponent Matrix System for the Process Systems where weights to each risk events are added sequentially which can contribute to an overall risk failure.

The invention uses the Weighting Ranking function, to construct a Fault Tree Weighted Superstructure that assigns relative weight to each Risk or Safety events in N-Interacting Events, the weights being indicative of the safety index of the risk systems.

The weighting function which is a variable in time, process and system type, operating conditions and environment allows the capturing of the Overall Risk or Reliability of the System and Subsystems of the studied process and facility.

The present invention also relies on history Curve of Failure Data, but uses real time measurement collated for process systems and experience use of the system over a specified period of use of the software system, rather than manual computation based from previous study.

This present invention provides methods for implementing safety management programs of FPSO (Floating Production Storage and Offloading) systems. The techniques combine neural networks, fuzzy belief systems and weight index in risk in reliability modeling to implement the safety aspects to risk systems to advert hazards that may lead to loss in containment using a modified Bow-Tie model. Floating installations in general and FPSO systems in particular are dependent on operational safety control for hazards atypical of marine environment. A Bow Tie system is normally used to model the accident pathways by linking hazards, causes, threat, safeguards that could lead to loss in containment and the necessary recovery methods after release in a single flowchart. Hazard data is constructed from Monte-Carlo Simulation of the fuzzy belief system and using neural networks weights representative of the actual hazard data was used to derive the actual failure rate given limited data.

Developments in Risk and Safety Methods.

Constructing a Fuzzy Rule-base with the Belief Structure precludes using Fuzzy logic reasoning that are knowledge-based or rule-based in the form of fuzzy IF-THEN rules can have important impact in modeling safety levels in hazard based risk systems.

Accordingly three fundamental parameters used to assess the safety level of an engineering system on a subjective basis are failure rate (FR), consequence severity (CS) and failure consequence probability (FCP).

The belief degrees in a rule are accounted for by considering the relative weight of each rule among all rules (the rule weight), as well as the relative weight of each antecedent attribute (the attribute weight). Fuzzy rules for Hazard systems can be extended in the following way.

Weights representing the safety aspects, hazard shape functions and numerical relation between series/parallel hazards in risk and reliability modeling can be combined thus:

$$\begin{matrix}{\sum }_{i} ( {ω}_{i} {⋃}_{i} ) ⊆ {U}_{RPROCES SYSTEM} & ( 1 ) \\ {\prod }_{i = 1}^{N} ( {ω}_{i} {⋃}_{i} ) ⊆ {U}_{RPROCES SYSTEM} & ( 2 )\end{matrix}$$

Where i can represent, human, environment, process, mechanical, operational, environment hazards, and ω̅ᵢ takes only numerical values to qualify contributions of the safety aspects.

The Weibull, gamma and Log-Normal Density functions can be used as representative Probability Functions. Weights index in risk modeling provides consideration for the critical safety elements that may prevent human failure.

The risk potential including weights is provided:

$$\begin{matrix}Risk Potential = \frac{1 - {\prod }_{i = 1}^{n} {( 1 - {r}_{i} )}^{{ω}_{1}}}{{\prod }_{i = 1}^{n} {( {R}_{si} )}^{{ω}_{1}}} & ( 3 ) \\ Risk Potential = \frac{{\prod }_{i = 1}^{n} {r}_{i}^{{ω}_{1}}}{1 - {\prod }_{i = 1}^{n} {( 1 - {R}_{si} )}^{{ω}_{1}}} & ( 4 )\end{matrix}$$

Where the ri inputs are expressed as exponential distributions

rᵢ(t)=1−e^{-λ}^{_{ω}}^{t}

Rₛᵢ(t)=e^{-λ}^{_{ω}}^{t}.

Hazard Functions can be express as a product sum or normally sum of the linear independent variables:

$$\begin{matrix}{λ}_{ω} = {\sum }_{i = 1}^{N} {ω}_{i} {λ}_{i} & ( 5 ) \\ {λ}_{ω} = \prod {λ}^{{ω}_{i}} & ( 6 )\end{matrix}$$

Failure rate or risk can be expressed as a Homogeneous Poisson process (HPP) probability distribution function given by:

$$f ( n ) = \frac{{( {ω}_{avg} λ t )}^{n} exp ( - {ω}_{avg} λ t )}{n !} n = 0 , 1 , 2 … \qquad ( 7 )$$

t is the time and λ is the constant failure or arrival rate. The cumulative failure distribution function is given by

$$\begin{matrix}F = {\sum }_{i = 0}^{n} \frac{{( {ω}_{avg} λ t )}^{i} exp ( - {ω}_{avg} λ t )}{i !} & ( 8 ) \\ {R}_{st} ( t ) = {\sum }_{i = 0}^{n} \frac{{( {ω}_{avg} λ t )}^{i} {e}^{- λ {ω}_{vg} t}}{i !} & ( 9 )\end{matrix}$$

Standby redundancy of flow line-riser system is one useful application where the system reliability of the (n+1) units in which one unit is operating and the n units on the standby mission until operating unit fails is given by equation. As can be seen in FIG. 1A a Standby Redundancy Model is illustrated where variable i utilizes unit 1 with units 2,3 . . . n as standby units in the event of failure of the unit being utilized.

Binomial Probability distribution is used to modelled possibility of K out of N systems (flow line risers) failing.

$${R}_{k / n} ( t ) = {\sum }_{i = k}^{n} ( \begin{matrix}n \\ i\end{matrix} ) {( {e}^{- ω λ t} )}^{i} {( 1 - {e}^{- λ ω t } )}^{n - i} \qquad ( 10 )$$

Human reliability methods including weights index defines critical elements that differentiates capacity for error by different human operatives and is expressed as:

$$\begin{matrix}{R}_{h} ( t ) = exp ( - {\int }_{0}^{t} ω ( t ) e ( t ) d t ) & ( 11 ) \\ Where : {ω}_{i} ( t ) = ( 1 - {SRF}_{i} ) {( \frac{t}{{η}_{i}} )}^{{β}_{i} - 1} & ( 12 ) \\ ln {R}_{h} ( t ) = - e ( t ) ω ( t ) + ( 1 - SRfi ) ( \frac{( {β}_{i} - 1 )}{{η}_{i}} ) ( t ) {\int }_{0}^{t} e ( t ) {( \frac{t}{{η}_{i}} )}^{{β}_{i} - 2} & ( 13 )\end{matrix}$$

Weights are derived from the Weibull function. The model is presented in equation below

$${ω}_{{avg}_{i}} = \frac{( 1 - {SRF}_{i} ) ( η / {β}_{i} ) ( {( {t}_{ma x} / η )}^{{β}_{i}} - {( {t}_{m i n} / η )}^{{β}_{i}} )}{{t}_{m ax} - {t}_{m i n}} \qquad ( 14 )$$

The safety fraction SFRi provides considerations for safety levels applied to different hazard systems as well as showing capacity of different hazard shape functions.

Fuzzy Class Belief Reasoning as Safety Tools in FPSOs Risk and Reliability Methods.

Fuzzy Reasoning in general assume that the five antecedent parameters describes FCP (Failure Consequence Probability), F1=Very Likely, F2=Likely, F3=Unlikely, F4=Very Unlikely and F5=Remote. This hazard estimates can be described by Ji linguistic terms {Fij; j=1; . . . ; N}; i=1; 2; 3; 4; 5 respectively. Based on a new rule for modeling hazards and risk using weights, Risk must be a function of intrinsic hazard shape function Bi and safety systems SRFi used to protect system, so that a typical risk system is intrinsic increasingly safe if the hazard shape function Bi {0, 0.2, 0.4,0.6,0.8, 1,1.2,1.4,1.6,1.8.2.0,2.2,2.4,2.6,2.8,3.0} and Safety Fraction SRi{0, 0.1, 0.2 . . . 1} are such that its numerical weights values described by N linguistic terms tends to higher levels, i.e. ωₖₙ, k=1 . . . 10, n=1, . . . 10 (ω₁, ω₂ . . . ω_{N}). Let Fᵢⱼ^{ω}^{ₖₙ} be a linguistic term corresponding to the ith variable in the jth class using the safety weight rule in the kth hazard shape function and nth safety class: Thus the kth rule in a rule-base can be written as follows: The weights are computed from:

$${ω}_{i} ( t ) = ( 1 - {SRF}_{i} ) {( \frac{t}{{η}_{i}} )}^{{β}_{i} - 1} \qquad ( 15 )$$

βᵢ is the shape function and SRfi is the safety fraction to the weight function. This together with the hazard rate determines the level of risk that can be experienced.

Corresponding to the rule-base (1), the general input from corresponding to the antecedent attribute in the fuzzy rule is given as follows:

{Fᵢⱼ^{ω}^{ₖₙ},εᵢⱼ}

Where εᵢⱼ expresses the degree of belief assigned by an expert to the association of the Fuzzy Class Fᵢⱼ{i=1 . . . N, j=1,2,3,4,5}which reflects the uncertainty in an input data. For example {Fᵢⱼ^{ω}^{ₖₙ},εᵢⱼ=75%} means we are 75% certain that the input can take values: F.

The input (Fᵢⱼ^{ω}^{ₖₙ},εᵢⱼ) or an antecedent attribute Fᵢⱼε(Fᵢ₁,Fᵢ₂,Fᵢ₃,Fᵢ₄,Fᵢ₅) can be assessed to a distribution representation of the linguistic terms using belief degrees as follows: S((Fᵢⱼ,εᵢ))=(Fᵢⱼ,αᵢⱼ;j=1 . . . Jᵢ), i=1,2,3,4,5 Fᵢⱼ(jε(1, . . . Jᵢ)) where the jth linguistic term of the ith attribute, αᵢⱼ the degree to which the input (Fᵢⱼ,εᵢⱼ) for Fᵢ belongs to the Fᵢⱼ linguistic term with and αᵢⱼ≧0 and

$${\sum }_{j = 1}^{N} {α}_{ij} \leq 1 ( i = 1 , 2 , 3 , 4 , 5 ) ,$$

αᵢⱼ can be formulated in the following way:

$${α}_{ij} = \frac{τ ( {F}_{i} , {F}_{ij} ) \cdot {ɛ}_{ij}}{{\sum }_{j = 1}^{{J}_{i}} ( τ ( {F}_{i} , {F}_{ij} ) )} , i = 1 , 2 , 3 , 4 , 5 ; j = 1 , … {J}_{i} \qquad ( 16 )$$

Where (Fᵢ,εᵢⱼ) is the actual input corresponding to the ith antecedent, τ is a matching function (τ:Fᵢ,Fᵢⱼ)=τᵢⱼ is a matching degree to which Fᵢ belongs Fᵢⱼ noted that ith αᵢⱼ≧0 and

$${\sum }_{j = 1}^{N} {α}_{ij} \leq 1 ( i = 1 , 2 , 3 , 4 , 5 ) ,$$

if Fᵢ completely belongs to the jth linguistic expression τ(Fᵢ,Fᵢⱼ)=1.

Subjective assessments (using linguistic variables instead of precise numbers in probabilistic terms) are more appropriate for analysis using these three parameters as they are always associated with great uncertainty, especially in the early design stage. These linguistic assessments can become the criteria for measuring safety levels. The second step in this component is to select the types of fuzzy membership functions used to define each input variable. It is possible to have some flexibility in the definition of membership functions to suit different situations.

The application of categorical judgments has been quite positive in several practical situations. It is also common and convenient for safety analysts to use categories to articulate safety information. The typical linguistic variables used to describe FR, CS, FCP of a particular element may be defined and characterized as follows.

FR describes failure frequencies in a certain period, which directly represents the number of failures anticipated during the design life span of a particular system or an item. To estimate FR, one may choose to use such linguistic terms as very low (VL), low (Lo), reasonably low (RLo), average (A), reasonably frequent (RF), frequent (F) and highly frequent (HF).

1. CS describes the magnitude of possible consequences, which is ranked according to the severity of failure effects. One may choose to use such linguistic terms as negligible (N), marginal (Ma), moderate (Mo), critical (Cr) and catastrophic (Ca).\
The Linguistic terms describing consequence takes the following numeric:

| Fuzzy Class | Fuzzy Numeric |
|---|---|
| Zero-Fatality (Negligible) | 0 |
| Minor (Marginal) | 1 |
| Major (Moderate) | 2-10 |
| Severe (Critical) | 11-50 |
| Fatality (Minor Catastrophic) | 51-100 |
| Disaster (Catastrophic) | 100+ |

FCP defines the probability that consequences happen given the occurrence of the event. For FCP, one may choose to use such linguistic terms as remote to occur, Very unlikely (U), unlikely (RU), likely (L), very likely (HL) and definite (D).

Fuzzy Class F {1, 2, 3, 4, 5} for Hazard Frequency and Occurrence Level

| | |
|---|---|
| Definite to [>10]/yr | |
| Very likely [>1-10]/yr assigned a value fuzzy set value | F(1) |
| Likely, [0.01-1]/yr assigned a value fuzzy set value | F(2) |
| Unlikely [0.0001-0.01]/yr assigned a value fuzzy set value | F(3) |
| Very unlikely [0.000001-0.0001]/yr assigned a value fuzzy set | F(4) |
| value | |
| Remote [0.00000001-0.000001]/yr assigned a value fuzzy set value | F(5) |

Hazards in each fuzzy class is computed randomly using Monte-Carlo simulation trained conveniently by an Excel Sheet by invoking the object RAND [ ].

FIG. 1B illustrate the steps in the Monte Carlo Methods. More particularly, the first step calls for Creating a Parametric Model. Next Generate a Set of Random Inputs, followed by Evaluating the model and storing the results as yᵢ. Next, steps 2 and 3 are repeated for i equaling 1 to n. Finally, the last step involves analyzing the results.

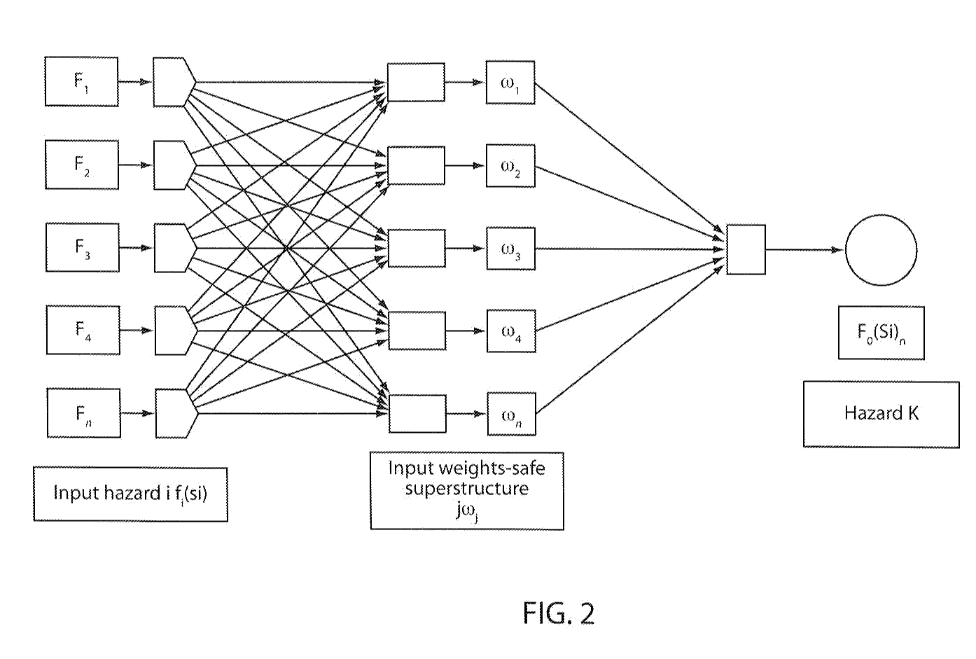

A neural network is modeled using inputs from numerical sets of Fuzzy Belief linguistic classifications as shown in FIG. 2. Multiple Input Hazards F₁, F₂ . . . F_{N} are correlated to various Input Weights ω₁, ω₂ . . . ω_{N} in determining the Hazard K represented by the function F_{O}.

Hazard Input Causing Events-in Synoptic Weight Training

$${ω}_{i + 1} = {ω}_{i} - \frac{{f}_{i} ( {ω}_{i} )}{\frac{d {f}_{i} ( {ω}_{i} )}{d {ω}_{i}}} \qquad ( 17 )$$

Hazard Outcome in-Synoptic Failure Event Turning and Training

$${Hs}_{i + 1} = {Hs}_{i} - \frac{{f}_{i} ( {fs}_{i} )}{\frac{d {f}_{i} ( {fs}_{i} )}{d {fs}_{i}}} . \qquad ( 18 )$$

Neural network learns to infer the relationship between the inputs and outputs by iteratively adjusting the weighting factors in two-stages propagate/adapt cycle. In the first stage of this cycle, the input values are propagated through each layer of the network until the output is generated. These outputs are then compared to the desired output and hazard weight error is registered numerically. The outputs are then compared to the desired output in a process known as Feed-Forward routine. This feedback-propagating cycle is iteratively executed until the weighting Index factors converge on values or Function that minimize the Average Root Mean Square (ARMS) error within the initial training to establish hazard condition or the safe status. Once the initial training is set to the weighting factors establishing equilibrium baseline are held constant. In this simulation study, 5000 neural network candidates to determine the optimal neural network. The actual training process involved 50 epochs cycles of back propagation training algorithm to locate the approximate solution of the local minimum error. This converges to minimize the ARMS error for the training set. The neural network can be expressed in a nested Scheme for the hazard function.

F(yᵢ=λᵢ)=f₁(x₁ᵢ, x₂ᵢ . . . xₙᵢ)

Where, yᵢ represents the risk of containment failure or loss output of several hazard components input xᵢ of the FPSO systems. The following attributes comprise the hazard input:

| | |
|---|---|
| weights index applied to hazard threats as safe index/risk | ωᵢⱼ |
| connectivity with other systems | |
| 67% probability to MTTF (Mean Time to Failure) | ηᵢ |
| Safety Variable | S_{FRi} |
| Hazard Shape of each risk input variable | βᵢ |

The mathematical model describing a neural network configuration by this present invention for modeling the risk aspects which are arises from consecutive inputs hazards resulting in loss of containments is now provided:

$$\begin{matrix}( y = {λ}_{i} ) = {a}_{1} ( {x}_{1 i}^{{ϖ}_{1 i}} \cdot {x}_{2 i}^{{ϖ}_{2 i}} \cdot … \cdot {x}_{ni}^{{ϖ}_{ni}} ) & ( 19 ) \\ {F}_{1} ( {x}^{′} , w ) = In ( {y}_{i} = {λ}_{i} ) = {\sum }_{j = 1}^{M} {w}_{jk} {ϕ}_{j} ( {\sum }_{i = 1}^{N} {w}_{ji} {x}_{i} - {κ}_{j} ) - {κ}_{k} & ( 20 )\end{matrix}$$

Where wₖⱼ is the synaptic weights from the neurons in the hidden layer j to the output neuron k and wᵢⱼ are the synaptic weights from the neurons in the input layer i to neurons in the hidden layer j and xᵢ is the i-the element of the input variable of the input vector \tilde{x}. The weight vectors w denote the entire set of synaptic weights ordered by layer, the neurons in the layer and the synapses in a neuron. The thresholds corresponding to the hidden and the output neurons are given by κ. The activation function

$$ϕ = \frac{1}{1 + {e}_{i}^{*}} \qquad ( 21 )$$

Where: \tilde{x}=x·ξ and ξ is the pre-process scaling vector and x is the raw input data and \tilde{y}=y·ξ is the post scaling factor

The error associated with output is defined

eᵢ=(λ_{ipredicted}−λ_{imeasured})i=1, 2 . . . n (22)

An improvement in the neural network is provided

The weight training model is provided for parallel system:

$$\begin{matrix}{H}_{o} ( {s}_{k} ) = {\sum }_{j = 1}^{N} {ω}_{jk} {\sum }_{i = 1}^{N} {ω}_{ji} ( {x}_{i} = {H}_{i} ) - {κ}_{jk} & ( 23 ) \\ {H}_{o} ( {s}_{k} ) = {\prod }_{j = 1}^{N} {ω}_{jk} {\prod }_{i = 1}^{N} ( {x}_{i} = {H}_{i}^{{ω}_{ji}} ) - {κ}_{jk} & ( 24 )\end{matrix}$$

κⱼₖ represents the threshold or the error associated with each training:

The weight training model is provided for series system:

$$ln {H}_{o} ( {s}_{k} ) = {\sum }_{j = 1}^{N} {ω}_{jk} {\sum }_{i = 1}^{N} {ω}_{ij} ln {f}_{i} ( Si ) - {κ}_{jk} \qquad ( 25 )$$

i-input index (1-N input Hazard Synoptic Function)

j-weight index (1-N interacting Hazard Synoptic Neuron functions)

k-output index in times (1-N Hazard Output Synoptic Function)

Typically expanding the neural network methods:

yᵢ= ω̅ᵢ₁(ωₗ₁x₁+ωₗ₂x₂+ . . . +ωₗₙ)+ ω̅ᵢ₂(ω₂₁x₁+ω₂₂x₂+ . . . +ω₂ₙxₙ)+ . . . + ω̅ᵢₘ(ωₘ₁x₁+ωₘ₂x₂+ . . . +ωₘₙxₙ) (26)

Where i=1, 2 . . . N inputs variables

Rearranging including thresholds associated with internal and external synaptic weights:

$$\begin{matrix}[ \begin{matrix}{y}_{1} \\ {y}_{2} \\ … \\ … \\ {y}_{N}\end{matrix} ] = [ \begin{matrix}{W}_{11} & {W}_{12} & … & {W}_{1 N} \\ {W}_{21} & {W}_{22} & … & {W}_{2 N} \\ … & … & … & … \\ … & … & … & … \\ {W}_{M 1} & {W}_{M 2} & … & {W}_{MN}\end{matrix} ] [ \begin{matrix}{x}_{1} \\ {x}_{2} \\ … \\ … \\ {x}_{N}\end{matrix} ] - [ \begin{matrix}{K}_{1} \\ {K}_{2} \\ … \\ … \\ {K}_{N}\end{matrix} ] & ( 27 ) \\ {W}_{11} = [ {\overline{ω}}_{11} {ω}_{11} + {\overline{ω}}_{12} {ω}_{21} + … + {\overline{ω}}_{1 m} {ω}_{m 1} ] & ( 28 ) \\ {W}_{12} = [ {\overline{ω}}_{11} {ω}_{12} + {\overline{ω}}_{12} {ω}_{22} + … + {\overline{ω}}_{1 m} {ω}_{m 2} ] & ( 29 ) \\ {W}_{1 N} = [ {\overline{ω}}_{11} {ω}_{1 N} + {\overline{ω}}_{12} {ω}_{2 N} + … + {\overline{ω}}_{1 m} {ω}_{mN} ] & ( 30 ) \\ {W}_{21} = [ {\overline{ω}}_{21} {ω}_{11} + {\overline{ω}}_{22} {ω}_{21} + … + {\overline{ω}}_{2 m} {ω}_{m 2} ] & ( 31 ) \\ {W}_{22} = [ {\overline{ω}}_{21} {ω}_{12} + {\overline{ω}}_{22} {ω}_{22} + … + {\overline{ω}}_{2 m} {ω}_{m 2} ] & ( 32 ) \\ {W}_{2 N} = [ {\overline{ω}}_{21} {ω}_{1 N} + {\overline{ω}}_{22} {ω}_{2 N} + … + {\overline{ω}}_{2 m} {ω}_{mN} ] & ( 33 ) \\ {W}_{N 1} = [ {\overline{ω}}_{N 1} {ω}_{11} + {\overline{ω}}_{N 2} {ω}_{21} + … + {\overline{ω}}_{Nm} {ω}_{m 2} ] & ( 34 ) \\ {W}_{N 2} = [ {\overline{ω}}_{N 1} {ω}_{12} + {\overline{ω}}_{22} {ω}_{22} + … + {\overline{ω}}_{Nm} {ω}_{m 2} ] & ( 35 ) \\ {W}_{NN} = [ {\overline{ω}}_{N 1} {ω}_{1 N} + {\overline{ω}}_{N 2} {ω}_{2 N} + … + {\overline{ω}}_{Nm} {ω}_{mN} ] & ( 36 ) \\ {K}_{1} = ( {κ}_{11} + {κ}_{12} + … + {κ}_{1 N} ) & ( 37 ) \\ {K}_{2} = ( {κ}_{21} + {κ}_{22} + … + {κ}_{2 N} ) \\ … ; & ( 38 ) \\ {K}_{N} = ( {κ}_{N 1} + {κ}_{N 2} + … + {κ}_{NN} ) & ( 39 )\end{matrix}$$

A Linear Network for Regression Analysis can be used to determine the weights thus: Expanding Equation 40 we have the following:

The Average Mean Squared Error is:

$$ARMS = {( \frac{1}{N} {\sum }_{i = 1}^{N} {e}_{i}^{2} )}^{\frac{1}{2}} \qquad ( 40 )$$

Where:

eᵢ=H_{Opredicted}−H_{omeasured} (41)

The Error Function can be deduced from the Gaussian function: The Gaussian function (also referred to as bell-shaped or “bell” curve) is of the following form:

$$G ( x ) = A {e}^{- \frac{{x}^{2}}{2 {σ}^{2}}} \qquad ( 42 )$$

where σ is referred to as the spread or standard deviation and A is a constant. The function can be normalized so that the integral from minus infinity to plus infinity equals one yielding the normalized Gaussian:

$$G ( x ) = \frac{1}{\sqrt{2 π} σ} {e}^{- \frac{{x}^{2}}{2 {σ}^{2}}} \qquad ( 43 )$$

By using the following definite integral:

$${\int }_{0}^{∞} {e}^{- a {x}^{2}} d x = \frac{1}{2} \sqrt{\frac{π}{a}} \qquad ( 44 )$$

The Gaussian function goes to zero at plus and minus infinity while all the derivatives of any order evaluated at x=0 are zero.

The error function equals twice the integral of a normalized Gaussian function between 0 and x

$$erf x = \frac{2}{\sqrt{π}} {\int }_{0}^{x} {e}^{- {u}^{2}} d u$$

The relation between the normalized Gaussian distribution and the error function equals:

$${\int }_{- x}^{x} G ( x ) d x = Erf ( \frac{x}{σ \sqrt{2}} ) \qquad ( 46 )$$

A series approximation for small value of x of this function is given by:

$$erf x = \frac{2}{\sqrt{π}} ( x - \frac{{x}^{3}}{3 \cdot 1 !} + \frac{{x}^{5}}{5 \cdot 2 !} + \frac{{x}^{7}}{7 \cdot 3 !} + … ) \qquad ( 47 )$$

While an approximate expression for large values of x can be obtained from:

$$erf x \tilde{=} 1 - \frac{{e}^{- {x}^{2}}}{\sqrt{π} x} ( 1 - \frac{1}{2 {x}^{2}} + \frac{1 \cdot 3}{{( 2 {x}^{2} )}^{2}} + \frac{1 \cdot 3 \cdot 5}{{( 2 {x}^{2} )}^{3}} + … ) \qquad ( 48 )$$

The complementary error function equals one minus the error function yielding:

$$erfc x = 1 - erf x = \frac{2}{\sqrt{π}} {\int }_{x}^{∞} {e}^{- {u}^{2}} d u \qquad ( 49 )$$

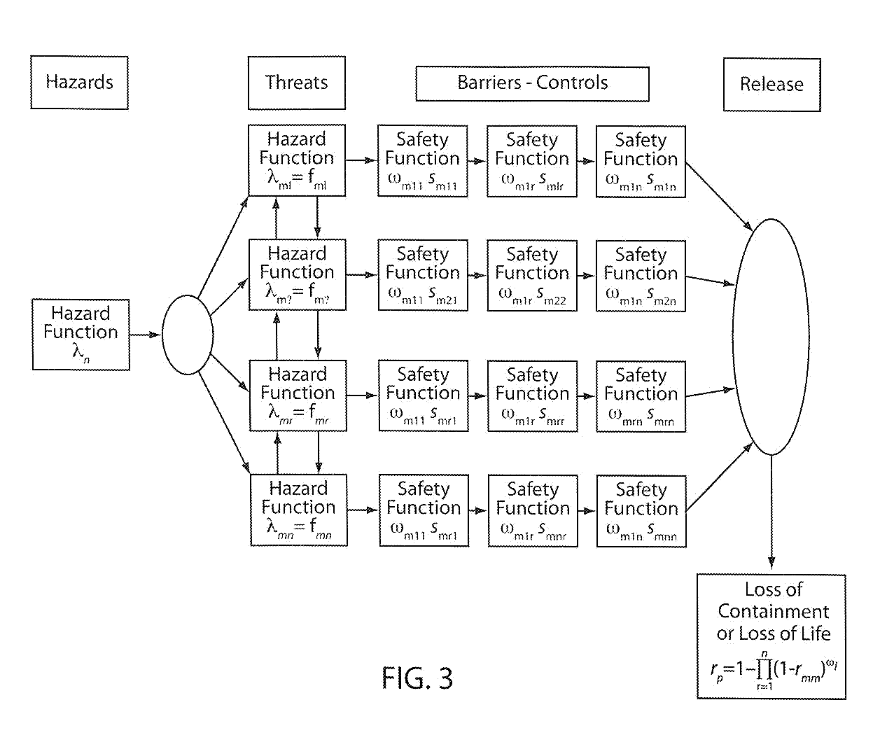

Typically neural network concepts can be applied to Bow Tie Modeling. A typical Bow Tie model is for FPSO configuration is provided in FIG. 3. The diagram includes four columns labeled Hazards, Threats, Barriers/Controls and Release. A bowtie model can be expressed mathematically in the form:

$$( \begin{matrix}{λ}_{11} & {λ}_{12} & … & {λ}_{1 n} \\ {λ}_{21} & {λ}_{22} & … & {λ}_{2 n} \\ {λ}_{31} & {λ}_{32} & … & {λ}_{3 n} \\ {λ}_{41} & {λ}_{42} & … & {λ}_{4 n} \\ {λ}_{51} & {λ}_{52} & … & {λ}_{5 n} \\ {λ}_{n 1} & {λ}_{n 2} & … & {λ}_{nn}\end{matrix} ) ( \begin{matrix}{ω}_{11} & {ω}_{12} & {ω}_{13} & {ω}_{14} \\ {ω}_{21} & {ω}_{22} & {ω}_{32} & {ω}_{42} \\ {ω}_{31} & {ω}_{23} & {ω}_{33} & {ω}_{43} \\ … & … & … & … \\ … & … & … & … \\ {ω}_{n 1} & {ω}_{n 2} & {ω}_{n 3} & {ω}_{n m}\end{matrix} ) = ( \begin{matrix}{λ}_{1 m} \\ {λ}_{2 m} \\ {λ}_{3 m} \\ … \\ … \\ {λ}_{n m}\end{matrix} ) \\ ( \begin{matrix}In {λ}_{11} & In {λ}_{12} & … & In {λ}_{1 n} \\ In {λ}_{21} & In {λ}_{22} & … & In {λ}_{2 n} \\ In {λ}_{31} & In {λ}_{32} & … & In {λ}_{3 n} \\ In {λ}_{41} & In {λ}_{42} & … & In {λ}_{4 n} \\ In {λ}_{51} & In {λ}_{52} & … & In {λ}_{5 n} \\ In {λ}_{n 1} & In {λ}_{n 2} & … & In {λ}_{n m}\end{matrix} ) ( \begin{matrix}{ω}_{11} & {ω}_{12} & {ω}_{13} & {ω}_{14} \\ {ω}_{21} & {ω}_{22} & {ω}_{32} & {ω}_{42} \\ {ω}_{31} & {ω}_{23} & {ω}_{33} & {ω}_{43} \\ … & … & … & … \\ … & … & … & … \\ {ω}_{n 1} & {ω}_{n 2} & {ω}_{n 3} & {ω}_{n m}\end{matrix} ) = ( \begin{matrix}In {λ}_{1 m} \\ In {λ}_{2 m} \\ In {λ}_{3 m} \\ … \\ … \\ In {λ}_{n m}\end{matrix} ) \qquad ( 51 )$$

Equation 19 and 20 is a Matrix Model used to describe the Hazard Systems incorporating the weight index that methods safety levels in Bow Tie of FPSO systems.
The risk of containment loss of an FPSO system is provided by equation:

$${r}_{p} = 1 - {\prod }_{i = 1}^{n} {( 1 - {r}_{m i} )}^{{ϖ}_{i}} \qquad ( 52 )$$

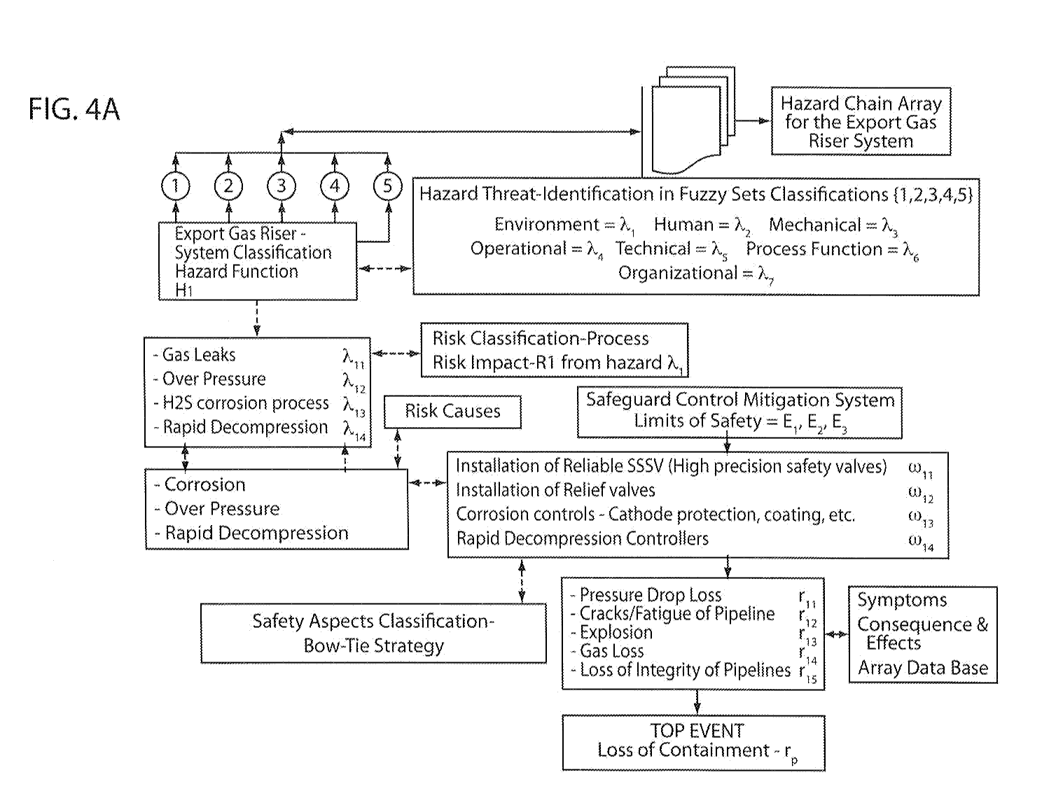

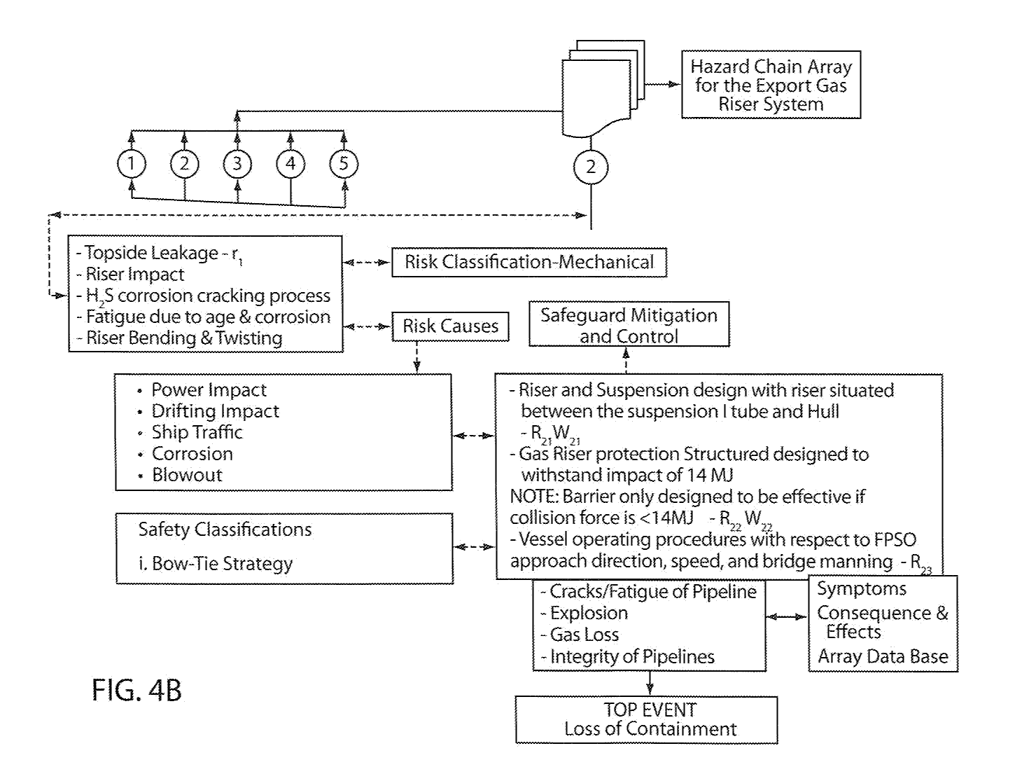

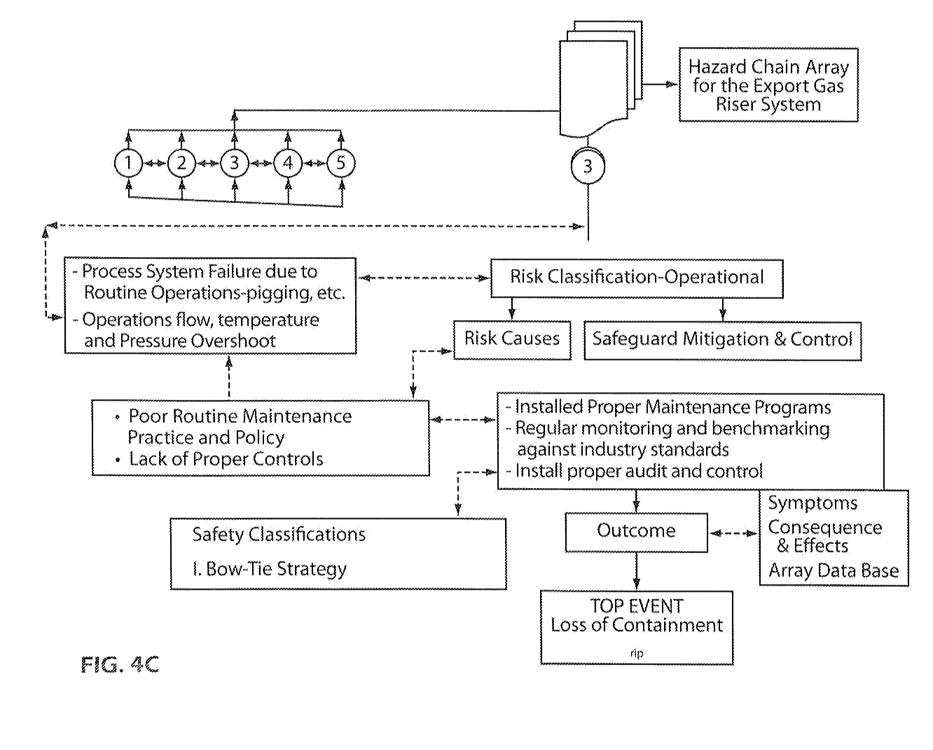

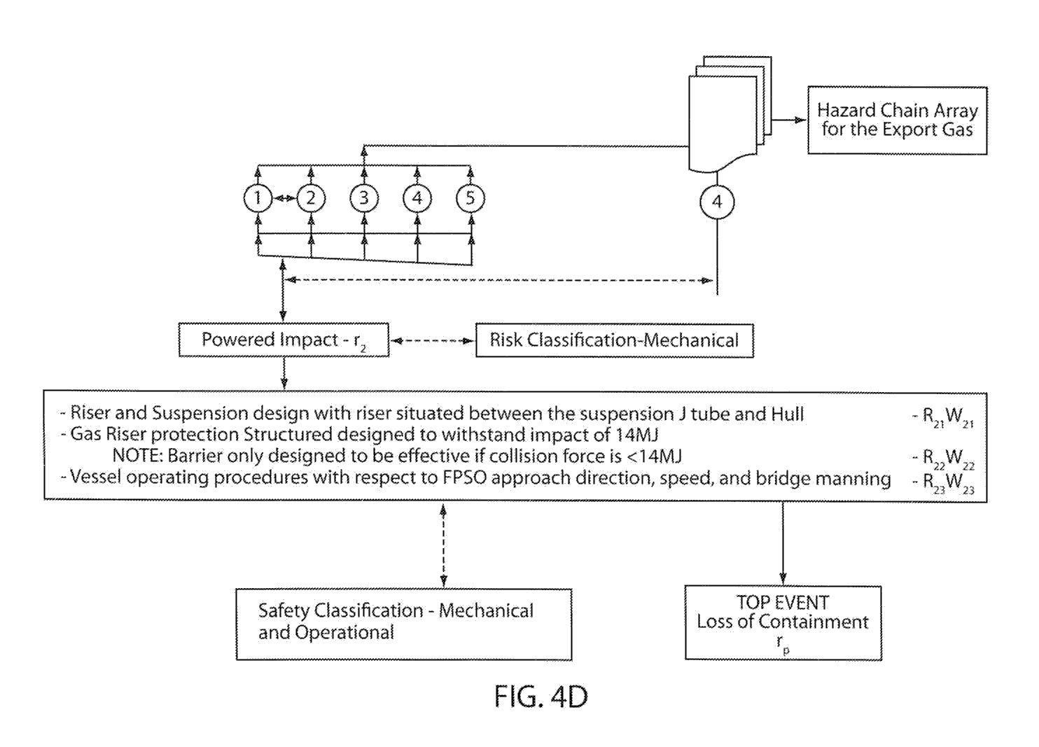

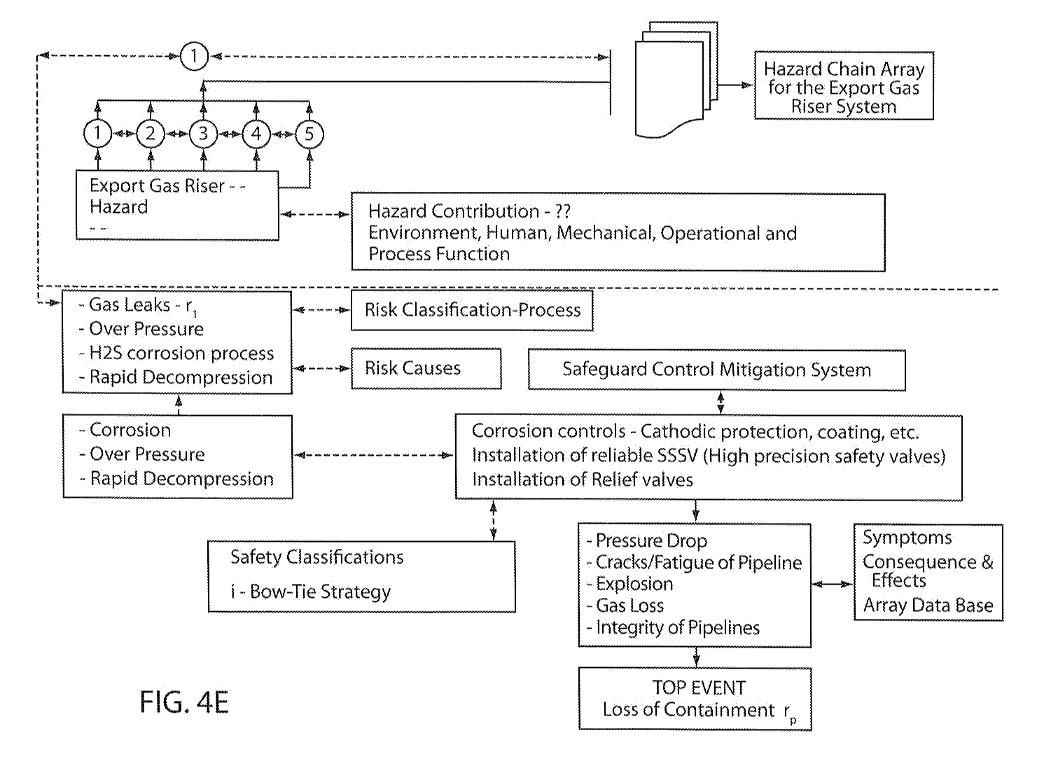

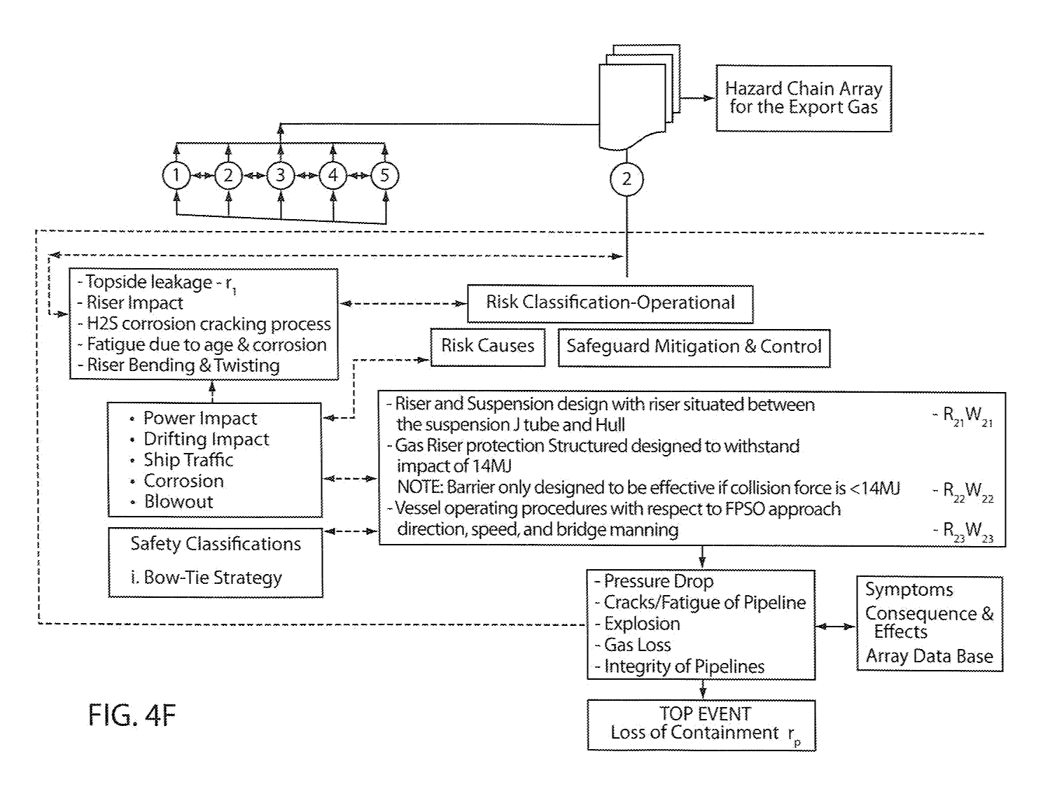

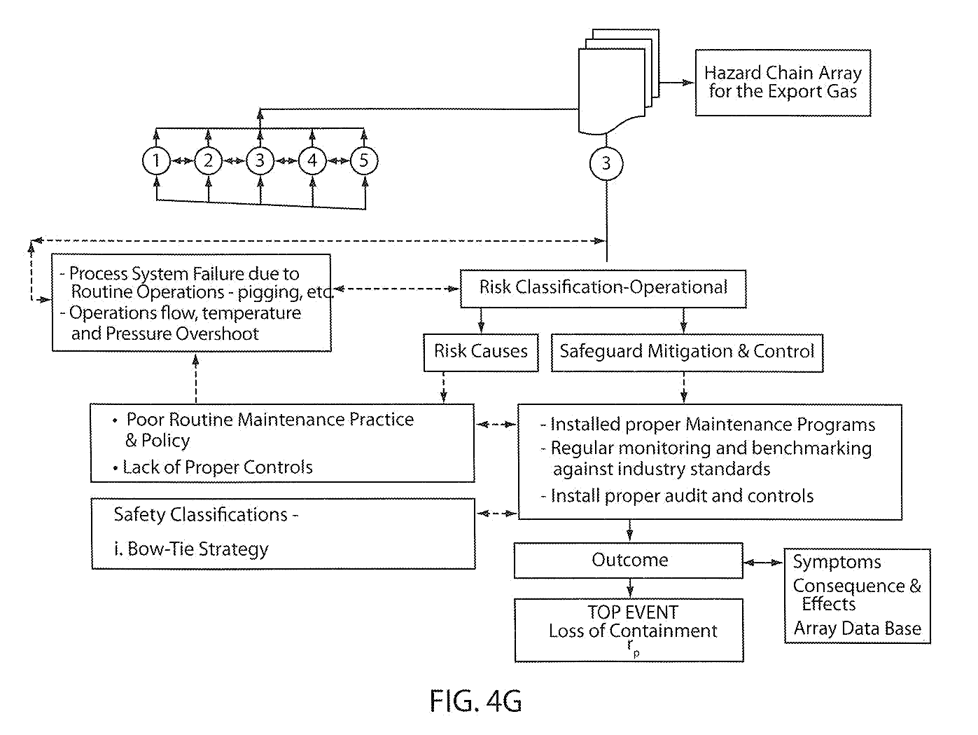

FIGS. 4A-4D shows an Application of Model to FPSO Export-Gas Riser System.

Application of Method to FPSO Safety Case Studies.

A safety case quantified into the neural safe network model for FPSO systems is presented: In respect, a major accident is defined as:
a fire, explosion or the release of a dangerous substance involving death or serious injury to persons;
any event involving major damage to the structure or plant of the installation or any loss in stability;
the collision of helicopter with the installation;
the failure of life support systems;
any other event arising from a work activity involving;
death or serious personal injury to two or persons;

Safety Objectives

Safety objectives must include personnel protection on FPSO and platform from major accident were described in detail. They are summarized as:
To provide measures for the safe and effective evacuation, escape and rescue of personnel from the FPSO/platform to a place of safety.
To provide measures (emergency systems) to control and mitigate potential major accidents.
To ensure that the emergency systems provided can survive a major accident and continue operating to a sufficient level of operability for the duration required to carry out its function.

These objectives were supplemented by specific system goals for the key elements of the overall evacuation, escape and rescue system including the TR and each emergency system. Each of specific system goals were to be met as far as reasonably practicable.

Impairment Criteria. Generic impairment criteria were applied to determine the effect of a hazard on personnel. They included:
Loss of structural support
Thermal radiation levels (kW/m2)
Overpressure (bar) smoke concentration (% by volume)
Gas and toxic fumes (ppm)
Inside temperature boundaries
Loss of command support
Loss of communications
Loss of emergency power
control system failure

The risk contributor to potential loss of life on FPSO has been provided for typical case as follows (total 100%):

| | |
|---|---|
| TR Impairment | 59% |
| Process/deck piping pool fire | 13% |
| non-field vessel collision | 7% |
| mooring line failure | 6% |
| offloading vessel collision | 4% |
| cargo tank fire/explosion | 3% |
| others | 8% |

The risk contributor to potential loss of life on platform was as follows (total 100%):

| | |
|---|---|
| pool fires (all areas) | 53% |
| non-field vessel collisions | 34% |
| FPSO collision | 6% |
| Riser-sealine fires | 5% |
| others | 2% |

ALARP is demonstrated where it can be shown that there are no additional measures that can reasonably be implemented in order to reduce the risks any further.

This leads to the risk contributor to potential loss of life on Platform on FPSO.

Typical Data
Process Worker on FPSO: 5.76×10⁻⁴ fatalities per year.
Ship crew worker on FPSO: 4.19×10⁻⁴ fatalities per year.
Accommodation Worker on FPSO: 3.70×10⁻⁴ fatalities per year
Process worker on platform (overnight on FPSO): 4.58×10⁻⁴ fatalities per year.

Workforce Safety Case Handbook applied to the FPSO Management requires asking the following questions:
What is a Safety Case?
What is HSE management?
What is a hazard?
How hazards are identified?
What are the effects?
How are you protected?
How are you affected?
What is risk?
How are hazards controlled?
How much are you at risk?
What does this mean?
What can you do?

The data information is decision variables inputted into the neural network system forming an important component of a Decision Support Expert System

Risk Methods Employed including a Weighted Risk Systems by this Present Invention
Weighted Task analysis
Weighted Action Error Mode analysis
Weighted Fault Tree analysis
Weighted Event Tree analysis
Weighted Risk Influencing Factor analysis
Weighted Risk Analysis

The Safety Aspects Considered for FPSO
Off-loading arrangements
Shuttle tanker when in off-loading mode
Supply vessels during transfer for cargo between vessels

Major Accidents Considered
Technical and/or operational failure
Human and organizational errors
Man/machine interface
Availability and effectiveness of operational procedures, and
other factors which directly affect a person's performance (stress, system understanding, tiredness, etc.).

Method of Operational Safety
Human and Organizational Factors (HOF) corresponds to what is often termed ‘Human Factors’. The general model for presenting what is included in HOF is based on general industry practices, and includes the following elements:
People
Equipment (e.g. hardware)
Management systems
Culture and environment

The principle of the model is shown in FIG. 2, where the interactions between the elements of the model are shown as intersections between the different elements. Equipment, people and management systems are shown as elements within the framework created by culture and environment. Examples of management systems include:
Procedures
Communication
Training
Management of change
Risk assessment

There are at least three aspects of risk assessments application in the design phase that have probably contributed to why QRA studies do not thoroughly address the operational safety aspects: Quantitative risk assessments infrequently focus on accident causation, predominantly they are focused on accident consequences (event trees/escalation analysis). The assessments usually focus on technical systems (not operational systems). Accordingly risk management in design phases does not normally require assessment of human reliability, due to lack of relevant information or experience at an early design stage. It is usually considered sufficient at an early design stage to establish frequencies of initiating events based on accident statistics, without considering the potential causes leading to the initial events. A comparison between what the typical QRA studies have identified as possible accident causes and what was identified in the detailed HOF based analysis demonstrated that several failure scenarios had not been identified through the QRA. Some of these failures may occur in normal operations, whereas others may be associated with response to external threats or abnormal conditions. Experience from the FPSO operation in the North Sea has demonstrated that human and procedural aspects of safety are very important. Several of the impacts by shuttle tankers mentioned above have been associated with inadequate operational control, (human errors) often in association with initiating events of a technical nature. The approach taken to control operational risk aspects is based on the use of procedures, the operators' own knowledge and experience, and technical redundancy, alarms and operational limitations. When collecting information for one particular case it was clearly demonstrated that the following situation had occurred:

The designers (supplier's personnel) intended the operation of the system to be one way.

The procedures had been written by the operating company for a somewhat different operation.

When talking to the personnel on the installation, it became clear that they preferred to operate the system in an even further modified way.

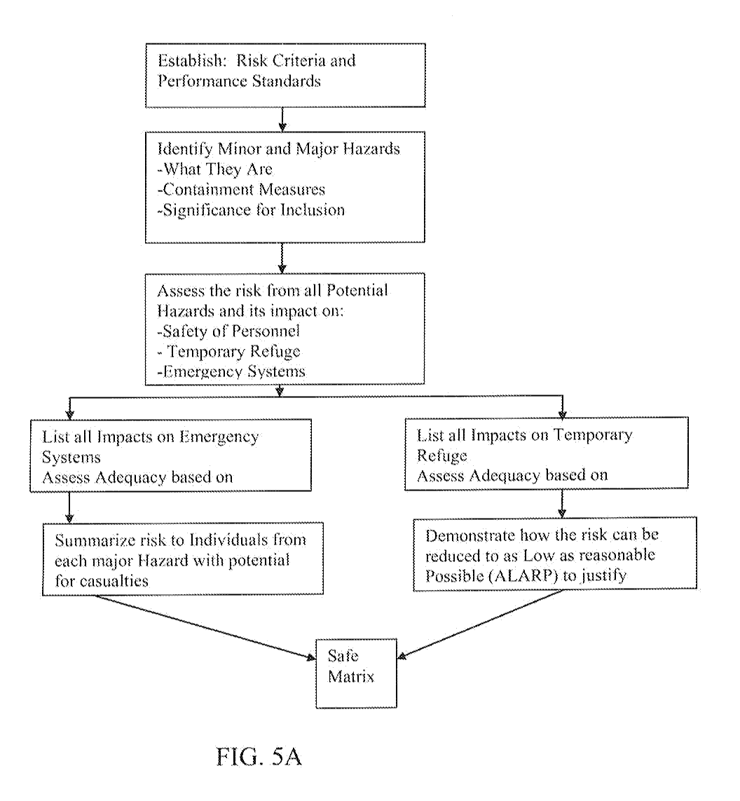

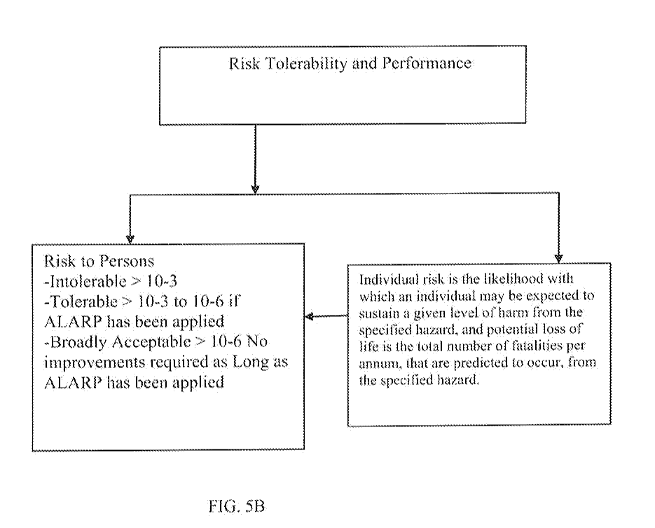

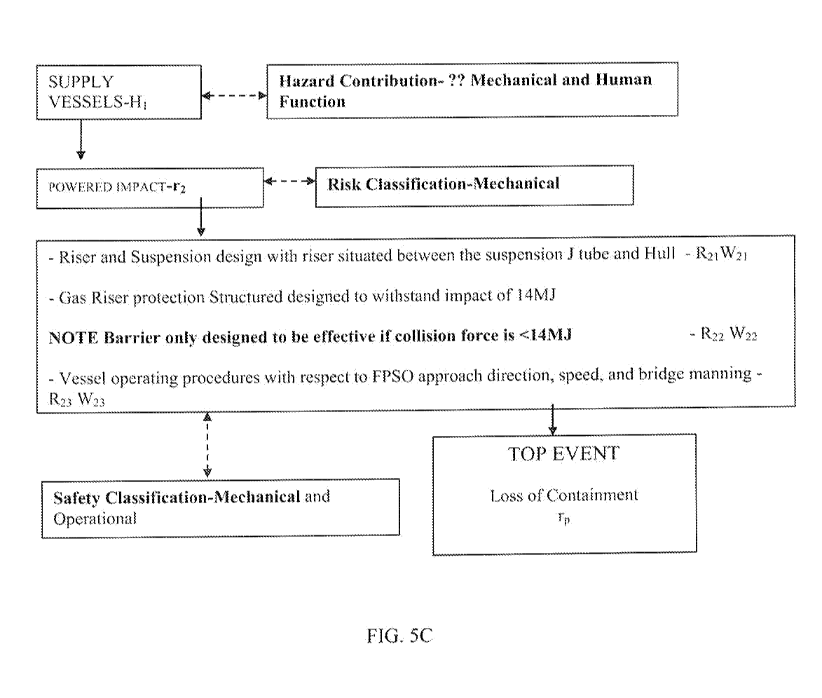

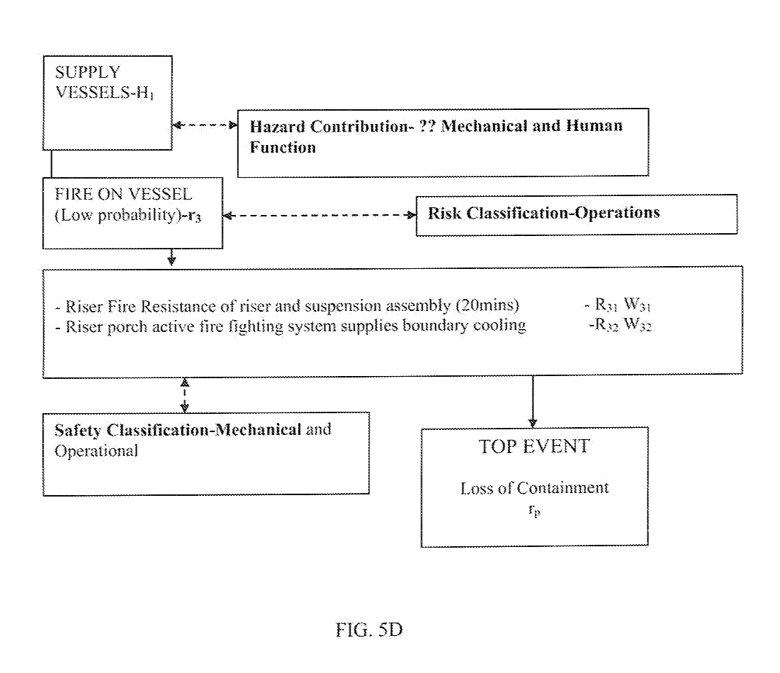

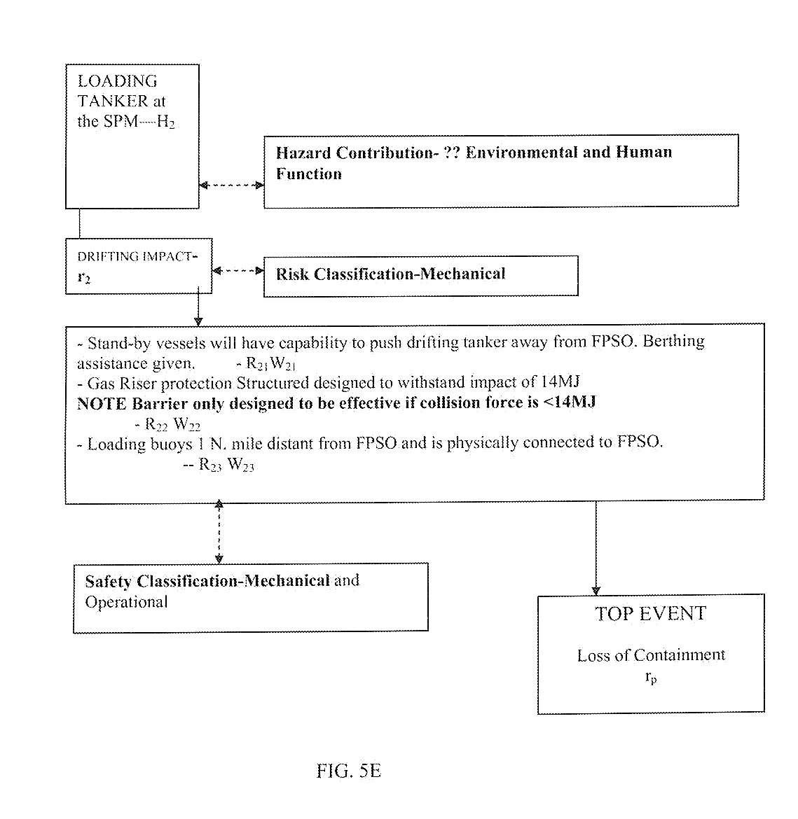

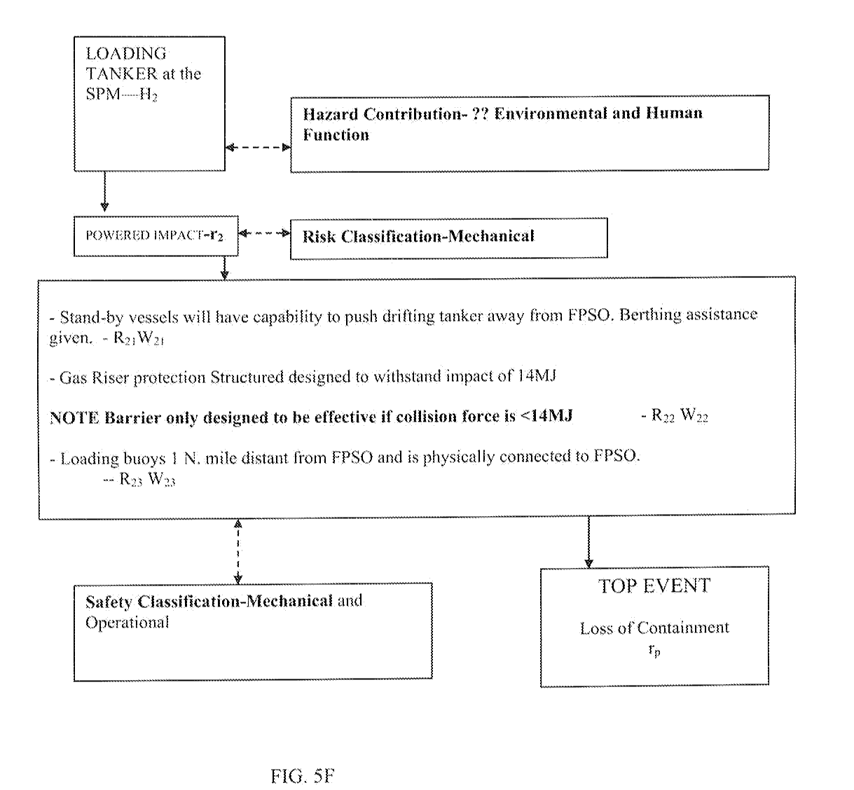

The procedures had not been modified in order to reflect the preferred way of operating the system. It was realized that even though the operational manner followed was the easiest in a day to day operation, it could be more susceptible to human error. Another observation that has been made in the project is that procedures sometimes are relatively functional, without detailed and specific steps to be carried out. This gives quite considerable freedom for the operational staffs, which on the one hand may give flexibility for optimization, but on the other hand also allow unwanted practices to be established. There is considerable variation in this regard; indicating that more detailed procedures may be prepared for some vessels. This is an advantage, from the point of view of preventing unwanted behavior and error-prone operation. FIGS. 5A and 5B are flowcharts illustrating Establishing Risk Criteria and Risk Tolerance and Performance, respectively.

Some of the important safety design measures include:

1. Jacketed, passive fire protection applied to riser end connectors and FPU boarding emergency shutdown (ESD) valves to limit the potential for riser-fire escalation in the turret.
2. An upgraded cargo-tank vents system to limit the potential for explosive and toxic gas atmospheres on the process and main deck levels.
3. Upgraded fire suppression for machinery spaces, from CO2 to a breathable, non-ozone depleting extinguishing agent, to protect personnel from potential asphyxiation.
4. Installation of shuttle-tanker position alarms to alert operators of potential drive-off incidents.
5. Upgraded load-shedding and power-management systems to improve the reliability of thrusters.
6. Installation of subsea pipeline shielding and trenching of the gas-injection riser and flow line to limit the potential for dropped object damage or snagging.

Risk analysis showed that the process risk scenario with the highest contribution to potential loss of life (PLL) rates, along with potential impacts to the temporary refuge and evacuation by lifeboat, is turret-connector deck fires and explosions. FPU turret-connector deck is an open design, but the equipment density is high. The deck contains 18 riser end connections and ESD valves along with production, test, gas lift, and gas-injection manifold piping and valves, all located in close proximity to one another. Jet-fire flame-length calculations indicated that impingement on adjacent equipment is nearly certain in all fire size cases considered, and as such, the potential for escalation is significant. Leak-duration calculations showed that even with successful isolation and blow down of the system, leaks with potential to impact adjacent equipment would last on the order of 20 minutes, which is long enough for a fire to escalate. In cases when blow down was assumed to fail, the leak duration was found to be on the order of 60 minutes. To effectively reduce the possibility of escalation while maintaining the capability to inspect and maintain the riser end fittings and ESD valves, jacketed, passive fire protection (rated for 60 minutes of exposure to jet fire) was installed. The required offshore manning levels based upon analysis of work activities and a review of similar activities aimed at achieving availability

Decision Support Expert System for Deepwater FPSO Assets and Processes

The decision support expert system by this present invention use some neural network system methods that incorporates artificial intelligence elements to capture the intrinsic behaviour of complex risk and failure data systems using weight functions and fuzzy hazard array sets of random risk classifications. The random classification of risk events cuts (human, process, mechanical, electrical, operational, environment) of the composite complex risk system architecture is discussed. The simulation program leverage on the use of a computer software program (Risk manager-Processors) to construct a weighted risk based-hazard data training system for a typical FPSO-Riser System allows the user a flexible graphical computer programme to conduct data training of the different complex failure consequence events, fault tree risk architectures providing accurate risk management decisions for its users. The source program used generated weight array structures and the fuzzy set arrays of risk classifications based on some structured software program to accept inputs of the hazard shape function, safety risk ratings, MTBF (Mean time before failure) generated using boundary conditions of time t min (initial time)-tmax (Time at repair) to provide some useful decision outputs. The fitted weighted hazard rate parameters of actual risk observations are matched with randomly skewed hazard surrogates generated by Monte Carlo simulation of the true parameters using a weight structure that represents intrinsic risk and safety ratings. The surrogate data was useful for the determination of hazard, risk and weight functions for conducting risk and reliability studies of the process systems. The decision support expert systems employs hof bifurcating stability criterion to determine safe territories where risk systems many not have considerable impact on the outcome of the reliability of the multifunctional process systems. This is retroactively a position in a risk state where a shift in the safety matrix produces not significant change of eigenvalues or eigenvectors above the threshold of one. This model was used to study risk events of a bowtie system of some pipeline riser-flow loop assets belonging to multinational oil and gas companies and to provide useful decision outcomes to potential users.

This Present Invention introduces a new method in risk hazard data assessment, the hazard-risk chain array matrix superstructure. This new model incorporates, fault tree minimal cuts, the bow tie accident pathway, failure mode effects and causes, hazard identification and assessment and consequence outcome to create a flowchart describing the accident pathway from Hazard to Top Event Outcome. Hazard rate data is trained in a Hazard Chain Array structure using fuzzy set-random based Monte Carlo simulation program to determine their composite hazard rates and the corresponding weights functions. These fuzzy hazards rates are adequate when historical failure data are not available. The results of computer software simulation of a typical FPSO-Riser system are presented.

Computer Simulation Algorithm for training and generating surrogates Hazard and Risk Data Systems.

A method has been developed that allows a computer simulation to generate intrinsic risk and safety data system. The steps and model are discussed and presented in the following Steps. Also see the flow chart diagrams of FIGS. 5A and 5B.

### Step 1: Identify the Top Event-Risk of Loss of Containment, Production Loss etc. . . .

Call it the Universal Risk Set: ∪_{R PROCESS}

Step 1.1: Define the possible risk systems define into six major classifications
Human Risk Systems
Mechanical Risk Systems
Electrical Risk Systems
Process Risk Systems
Operational Risk Systems
Environmental Risk Systems

Definitions:

i. Human Risk Systems are those components of risk that are the direct or indirect input of human error, such as design, operational oversight, improper training or sabotage
i. Mechanical Risk Systems are those associated with the mechanical aspects of the process systems such as fatigue, corrosion, stress, twisting, mechanical and structural related failures, leaks etc.
iii. Process Risk Systems are those risk systems that has to do with the process, for example oil and gas transported through sub sea pipelines would have hydrates, wax, scale, sand production risk, for a reaction system for example, we can have catalyst poisoning, explosions for run away reactions etc. . . .
iv. Operation risk systems are those risk systems that are dependent on the routine operations of the process that are not generated by the process such as pigging cleaning operations, operating temperature and pressure design set point changes
v. Electrical risk are those risk associated with computer control equipments, controllers and electrical and electronic control devices, a pump might fail to work because there is something wrong with the switch. Since most process are monitored and control electronically because of modern technology, the risk component is considered.
vi. Environmental risk systems are risk associated with the environment a process systems is located and not generated by process or by routine operations such as under water currents, tornadoes, terrorist attack, flooding.

Step 1.2: Each of this risk classification is derived using a Fault Tree Architecture that defines each of Six Risk Classifications as a Top Event of Minimal Cuts or Events; depending on the process considered. It is assumed the Six Classification of risk as presented step 1.1 presents the intermediary minimal cut or events for the Universal Set Risk Outcome Universal Risk Set: ∪_{R} to occur. The fault tree for each classification is represented by the detailed failure events and risk structures as define by their respective fault tree top event

### The Possible Fault Tree SUBSETS CUTS are

### I. Human Risk-Loss of Process System Integrity due to Human Risk SUBSET CONTAINED in a UNIVERSAL SET

∪ₕᵤₘₐₙε∪_{RPROCESS SYSTEM} (53)

2. Process Risk-Loss of Process System Integrity due the combination of risk derived from the process operations, e.g. hydrate formation, wax, catalyst poisoning

∪_{process}ε∪_{RPROCESS SYSTEM} (54)

3. Mechanical Risk-Loss of Process System Integrity due to the combination of mechanical failures such as, fatigue, unusual stress loads, corrosion (stress corrosion, cracking), leaks, equipment failure, twisting, bending, erosion abrasion. The element sets combining the risk events in parallel or series is thus

∪_{mechanical}ε∪_{RPROCESS SYSTEM} (55)

4. Electrical Risk-Loss of Process Integrity due to a combination of electrical failures such as computer offsets, switches fail to work, loss in power due to battery failure, electronic devices of controllers that are used to make control or measurements, such as RTU (Relay terminal Unit), Communication Transmitters . . . , Electronic devices such as computers, batteries, electrical equipments. The element in the universal set is thus defined as

∪_{electrical}ε∪_{RPROCESS SYSTEM} (56)

5. Operational Risk-Loss of Process Integrity due to operational upheavals such as operational temperature, flow and pressure deviations (From Hazard Analysis), routine cleaning and inspection operations programs (pigging) etc. The element in a universal set is thus

∪ₒₚₑᵣₜᵢₒₙₐₗε∪_{RPROCESS SYSTEM} (57)

6. Environment Risk-Loss of Process Integrity resulting from compromise from the internal and external environment of the system such as whether, ocean currents, terrorist threat, passing ship traffic resulting in loss of integrity of process containment in a typical FPSO systems and since generate a sequence of other risk events that may have mechanical, human or process consequence we define thus environment risk as an element based on other risk systems

∪ₑₙᵥᵢᵣₒₙₘₑₙₜ [symbol] _{Σ(human,mechanical,process etc)}ε∪_{RPROCESS SYSTEM} (58)

6. Hence the general risk system sets is define as

Σᵢ( ω̅ᵢ∪ᵢ)⊂∪_{RPROCESS SYSTEM} (59)

where i can represent, human, environment, process, mechanical, operational, environment risk classifications, and ω̅ᵢ takes only values of {0,1} only, 0 when the risk component is not important and 1, when it is important for example if process and human risk are the only important risk contributions to considered for system that could loss of containment, equation (60) is reduced to

(∪_{process}+∪ₕᵤₘₐₙ)⊂∪_{RPROCES SYSTEM} (60)

Step 2: Define a fuzzy set classification using the consequence outcome linguistic sets. Five hazard classifications are defined for failure rate in both numerical and linguistic fuzzy sets;
Very likely [1-10]/hr assigned a value fuzzy set value 4,
Likely, [0.01-1]/hr assigned a value fuzzy set value 3,
Unlikely [0.0001-0.01]/hr assigned a value fuzzy set value 2
Very unlikely [0.000001-0.0001]/hr assigned a value fuzzy set value 1,
Remote [0.00000001-0.000001]/hr assigned a value fuzzy set value 0

Step 3:

Match a Risk Systems under consideration with the Fuzzy Set Classification-The User using our developed computer program codes identifies possible risk component in the systems and assign a fuzzy classification. Fuzzy classifications are useful when data is uncertain or insufficient. Where hazard data are available, the user should just input data directly:
For example, assuming three Possible Risk Systems Classifications are identified to compromise a system, e.g.:
i. Human Risk Likely to occur has a numerical value within a range of [0.01 to 1];
ii. Process Risk Unlikely to occur has a numerical value within range of [0.0001 to 0.01]; and
iii. Environmental Risk, which has remote chance of occurring, has a numerical value within the range of [1×10⁻⁰⁶ to 1×10⁻⁰⁸].

Step 4:

Using the Possible Risk Systems Classifications comprise a data generating model for computing hazard rates based on a user's empirical Linguistics Fuzzy Classification of the risk systems and the Monte-Carlo Simulation. Classical Monte Carlo Simulations require the number of realizations to be drawn randomly. The steps using Monte Carlo Simulations to determine the hazard function are drawn randomly using a structured random program or, more conveniently, through use of an Excel spreadsheet by invoking the object RAND [ ]. See also FIG. 1B.

Step 5:

Skewed Results of Monte Carlo Simulation to 25%, 50%, and 75%, wherein 50% represents the mean distribution over a uniformly distributed average. By skewing we are basically designing all possible values of the hazard function skewed to 25%, skewed to 50%, and skewed to 75%, since not all hazard data from randomizing the component risk problems are equally distributed over an average simulated mean. Thus, the existing data and information is used to create a representative frequency distribution for the input and output of random data set statistical classifications.

Step 6:

Define a weight function characteristic of each risk system component: Since the hazard skewed values are known from step 5, the MTBF can be computed and included in the model used to compute the weight function. The weight structure for each risk system component for a given hazard constant is deduced from the Weibull Distribution Model (5). This originated in fatigue studies, and it is of practical significance, as it was derived empirically. It has several features, which makes it attractive to practicing reliability engineers and which accounts for its very wide use. These features are: (i) Flexibility—It can deal with increasing, constant, and reducing hazard; (ii) mathematical simplicity and amenability to graphical analysis; and (iii) it is empirically proven to fit most lifetime data better than most reliability methods.
1. Using the Weibull Model, we can infer the weight distribution function from the failure function using the Weibull correlation shown by equation:

$$F ( t ) = 1 - {e}^{- {( \frac{t}{η} )}^{β}} \qquad ( 61 )$$

The Weibull Reliability is shown as follows:

$$R ( t ) = {e}^{- {( \frac{t}{η} )}^{β}} \qquad ( 61 )$$

The present invention introduces the concept of weight; thus, Equation 1 can be redefined as follows:

F(t)=1−e^{-ωλt} (63)

Comparing equation 11 to equation 10, the weight function is derived as follows:

$${ω}_{i} ( t ) = ( 1 - {SRF}_{i} ) {( \frac{t}{{η}_{i}} )}^{{β}_{i} - 1}$$

Step 6.0

Step 6.1: Computing the hazard function from step 5 for the particular risk classification defined by the fuzzy sets

Step 6.2: Finding the MTBF using the following formula model 4-6:

$$λ = ( \frac{1}{η} ) \qquad ( 64 )$$

$$η = \frac{1}{λ} = MTBF ( Mean Time Before Failure ) \\ by definition η is same as the MTBF \qquad ( 65 )$$

Step 6.3: Deducing the weight functions as shown in the following equation:

$$w = {( \frac{t}{η} )}^{β - 1} \qquad ( 66 )$$

Step 6.4: Including the safety rating, Ki, and the contribution of associated interacting risk events contribution αᵢ, equation 6 is recodified into equation 7 as follows:

$${ω}_{i} ( t ) = ( 1 - {\sum }_{1}^{n} {α}_{i} {K}_{i} ) {( \frac{t}{{η}_{i}} )}^{{β}_{i} - 1} \qquad ( 67 )$$

β is the shape of the hazard rate function, η is the maximum time in which the system has a 0.677 probability of failure (the characteristic life). Weighting function is determined from the user's experience with the system. Analytical treatment as provided in equation 16 must require empirical data that enables us evaluate β, η Ki and αᵢ.

As an alternative, an empirical approach which linearizes failure (hazard rate) data and uses regression analysis to evaluate the weight functions for series and parallel systems is possible using the following relationship: If the hazard rates function for the individual component hazard system and the combine hazard rate structures are computed failures from monitoring by the operators of the process system.

The hazard rate is defined in terms of the weight; thus, for n associated hazard function, the resultant hazard observed for the systems comprised by n-risk hazard systems in series is thus for series hazard systems:

$${λ}_{rS} ( t ) = {\prod }_{i}^{n} {λ}_{i}^{{ϖ}_{i}} \qquad ( 68 )$$

To find the linear function equation (7) by using a natural logarithm gives the linear function of equation (6)

Inλ_{rS}(t)=ω₁Inλ₁+ω₂Inλ₂+ . . . +ωₙInλₙ (69)

Equation 69 is a linear function expressed in terms of the variables of the form ŷₛ= m̅\hat{x}ₛ+c for a series system in which independent and dependent variables are their natural logarithm.

y_{rS}(t)=ω₁xₛ₁+ω₂xₛ₂+ . . . +ωₙxₛₙ (70)

For n-interacting hazards, the predicted hazard rate for component r, which is in parallel with other hazard rates of other components, is given by the sum of the hazard rate λᵢ multiplied by weight function ω̅ᵢ, for i . . . n, interacting hazards: -PARALLEL HAZARD SYSTEMS

$${λ}_{rP} ( t ) = {\sum }_{i = 0}^{n} {ϖ}_{i} {λ}_{i} \qquad ( 71 )$$

Equation 71 is a linear function expressed in terms of the variables of the linear form ŷₚ= m̅\hat{x}ₚ+c for parallel system

yᵣₚ(t)=ω₁xₚ₁+ω₂xₚ₂+ . . . +ωₙxₚₙ (72)

Step 6.7: The instantaneous weight is define in terms of the safety-risk factor for each component SRFi, a hazard shape function βᵢ, the mean time before failures, MTBFi, and operation time, t, of the process system. [See equation (16).]

$${ω}_{i} ( t ) = ( 1 - {SRF}_{i} ) {( \frac{t}{{MTBF}_{i}} )}^{{β}_{i} - 1} \qquad ( 73 )$$

Where the SRFi takes a value between 0 and 0.1, which is dependent on the reliability rating of the safety devices, as well as the associated interacting risk systems comprising the process system risk-reliability super structure, Bi, the shape function, takes a value of from 1 to 3 in increments of 0.1 or 0.2

Step 7: Develop an array table of all possible weight values of Bi and SRFi derived per time that takes values from tmin to a tmax, in which tmin and tmax are defined by the user for the differently skewed hazard functions. In our case, we have take tmin to represent the initial time, which is zero, and tmax to represent the time which the system's components need for repairs.

Step 8: Computing an average weight over time derived by integrating instantaneous weights over time:

$${ω}_{{avg}_{i}} = \frac{( 1 - {SRF}_{i} ) ( \frac{η}{{β}_{i}} ) ( {( \frac{{t}_{m ax}}{η} )}^{{β}_{i}} - {( \frac{{t}_{m i n}}{η} )}^{{β}_{i}} )}{( {t}_{m ax} - {t}_{ m i n} )} \qquad ( 74 )$$

Step 8: Evaluating the risk and reliability potential using the model below:

Weighted Exponential Distribution:

F(t)=1−e^{-ωλt} (75)

$$Risk Potential = \frac{Risk of System Component}{Reliability of Safety Systems} \qquad ( 76 )$$

For series systems: Risk hazards on system components that are operating in series, reliability of the safety component systems in series:

Risk potential is given for series systems as:

$$Risk Potential = \frac{1 - {\prod }_{i = 1}^{n} ( 1 - {r}_{i} )}{{\prod }_{i = 1}^{n} ( {R}_{si} )} \qquad ( 77 )$$

For parallel systems: Risk of system components is in parallel, reliability of safety systems is in parallel:

$$Risk Potential = \frac{{\prod }_{i = 1}^{n} {r}_{i}}{1 - {\prod }_{i = 1}^{n} ( 1 - {R}_{si} )} \qquad ( 78 )$$

The risk potential gives a measure of the true risk inherent in a system or subsystem:

$$\begin{matrix}Safety Potential = \frac{1}{Risk Potentaial} \\ = \frac{Reliability of Safety Systems}{Risk to Safety System}\end{matrix} \qquad ( 79 )$$

The safety potential gives a measure of the true reliability of the safety system designed to protect the component systems under hazard threat.

Step 8.1: The following distribution is used to define failure methods of different risk systems:

Step 8.1.1: The weighted exponential distribution function has been derived previously from the Weibull Model. Please refer to step 6. The failure function is expressed as follows:

F(t)=1−e^{-ωλt} (80)

Step 8.1.2: The weighted homogeneous Poisson process (HPP)(14)

1. When failures occur at random, but at a constant underlying failure rate which implies that the failures are the result of a given interval of failure times t, that are exponentially distributed (and the number of failures in specified time intervals have a Poisson distribution), the failure function is represented as a weighted failure function if weights, as defined by this paper, relating to safety ratings and complexity of interacting risk events:

$$f ( n ) = \frac{{( {ω}_{avg} λ t )}^{n} exp ( - {ω}_{avg} λ t )}{n !} n = 0 , 1 , 2 … \qquad ( 81 )$$

where t is the time and λ is the constant failure or arrival rate. The cumulative failure distribution function is expressed as:

$$F = {\sum }_{i = 0}^{n} \frac{{( {ω}_{avg} λ t )}^{i} exp ( - {ω}_{avg} λ t )}{i !} \qquad ( 82 )$$

1. Standby redundancy of a flow line-riser system is one useful application of this HPP reliability distribution function. This type of redundancy represents a situation in which one unit is operating and n units act as standbys. The standby redundancy is shown in FIG. 2. Unlike a parallel network in which all units in the configuration are active, the standby units are not active. The system reliability of the (n+1) units in which one unit is operating and n units are on standby until the operating unit fails is expressed as shown in Equation 83:

$${R}_{st} ( t ) = {\sum }_{i = 0}^{n} \frac{{( {ω}_{avg} λ t )}^{i} {e}^{- λ {ω}_{vg} t}}{i !} \qquad ( 83 )$$

The above equation is true if the following are true: (i) The switching arrangement is perfect; (ii) the units are identical; (iii) the unit failure rates are constant; (iv) the standby units are as good as new (See FIG. 1A); and (v) the unit failures are statistically independent. Introducing weight functions to the HPP distribution model represents a new paradigm in reliability and risk analysis that incorporates the safety systems reliability and the true intrinsic impact of other interacting complex risk systems.

Step 8.2.4: The Weighted Binomial Distribution

1. The system reliability for k out of n number of independent and identical units for a constant failure rate assumes a binomial distribution. The modified model incorporating weights for reliability becomes:

$${R}_{k / n} ( t ) = {\sum }_{i = k}^{n} ( \begin{matrix}n \\ i\end{matrix} ) {( {e}^{- ω λ t} )}^{i} {( 1 - {e}^{- λ ω t} )}^{n - i} \qquad ( 84 )$$

Hazard-Risk Chain-Safe Guard Matrix (Superstructure) of Typical Process FPSO-Riser System

In this invention, a new method of risk, reliability, and safety control strategy is proposed. It is the hazard-failure mode and effect-outcome risk chain safeguard superstructure (HFM-ORC) systems reported as improvements over the bow tie strategy used to analyze accident pathways. Normally, a bow tie diagram has been well discussed in literature (15, 16, 17). The improved model of the present invention adds to this superstructure describing the flow path-from hazard to top event outcome of the process systems under a safeguard control system. The application model for a typical risk system of a typical to FPSO-export riser is now reported as shown in FIGS. 4E-4G which illustrates Hazard Failure Mode and Effect Outcome Risk Chain Safeguard System (HFM-EOR-CSS) Risk Manager.

The new modifications to the bow tie set forth in the present invention should be referred to as the hazard-failure mode and effect-outcome risk chain safeguard system. This superstructure describes the flow path-from hazard to top event outcome of the process system under a safeguard control system under the accident pathway. The application model for a typical risk system of a typical FPSO-export riser is shown in FIG. 5C.

The HM-EOR-CSS risk manager is an improvement over the bow tie system, and it arranges a hazard array chain identifying all the components of hazard in the array. From the array chain, the individual risks (in this case, process, operational, mechanical etc.) are identified specifically and analyzed. In this way, the specific risk classification considered from the hazard array chain is identified by Nos. 1, 2, 3, 4, and 5. The risk causes and mitigation/safety/controls are identified; the outcome of the safety/barrier controls would result in a hazard/risk outcome which would lead to effects that may lead to loss in containment. In this way, the interrelationship between hazard, hazard components, risk, causes, and safety/controls/barriers, as well as the effects, outcomes and eventual loss, are then identified. In summary, the numerical determination of the risk or reliability potential based on the new algorithm is achieved in the following steps.

Step 0: Identify the Hazard Function-Hi

Step 1: Define the risk and safety system components generated by the hazard function, e.g., drifting impact risk:

rᵢ=1−exp(−ωᵢλᵢt) (84)

drifting impact safeguards reliability

Rᵢ=exp(− ω̅ᵢλᵢt) (85)

for safeguards in parallel-total safeguard of system above

$${R}_{p} = 1 - ( 1 - {R}_{1} ) ( 1 - {R}_{2} ) … ( 1 - {R}_{n} ) = 1 - {\prod }_{i = 1}^{n} ( 1 - {R}_{i} ) \qquad ( 86 )$$

for risk and safeguard in series-total risk and safeguard reliability

rₚ=1−(1−r₁)(1−r₂) . . . (1−rₙ) (87)

Step 2: Find the fuzzy set classifications.
R₁W₁—Very likely to fail by our fuzzy classification of 3
(min-max hazard rate 0.1-1/hr)
R₂W₂—likely to fail by our fuzzy classification of 2
(min-max hazard rate 0.001-0.1/hr)
R₃W₃—Very unlikely to fail by our fuzzy classification of 2
(min-max hazard rate 0.0001-0.001/hr)
R₄ W₄-likely to fail by our fuzzy classification of 4
(min-max hazard rate 0.000001-0.0001/hr)
R₅W₅-Remote chance of failure by our fuzzy classification of 5
(min-max hazard rate 0.00000001-0.000001/hr)

Step 3: For the fuzzy set-randomize using Monte Carlo Simulation to compute the appropriate hazard rate average for each set starting using 5000 to 1 million bins.

Step 4: The appropriate bin is chosen iteratively inasmuch as the average and standard deviation do not change when computed using the Excel spreadsheet and invoking a repetition using the “F9” key.

Step 5: Where hazard rate data is provided, we compute using a random variable Monte Carlo Simulation suitable best matches expressing the probability distribution of the hazard rates in z-probability (either the Normal or Poisson distribution is used). In our case, we have used the average randomized variable, since data were not available for the hazard rate.

Step 6: Compute the risk of top event loss of containment using the formula below:

Step 7: Compute the weights using the relationship, where the weight functions is represented as equation 88:

$$w = {( \frac{t}{η} )}^{β - 1} \qquad ( 88 )$$

β is the shape of the hazard rate function, η is the maximum time in which the system has a 2/3 probability of failure (the characteristic life). Modifying Equation 13 requires the use of a hazard safety factor, Ki, that measures the relative impact of environmental stress and safety ratings; hence, Equation 13 can be reconfigured as the following equation:

$$w = ( 1 - {{\sum }_{1}}^{n} {α}_{i} {K}_{i} ) {( \frac{t}{η} )}^{β - 1} \qquad ( 89 )$$

where the weighting function, WI, can be defined as

W_{I}=Integral(ψ(γT)dt) (90)

Boundary Conditions

W_{I}=Integral(ψ(γT)dt)=1 (91)

W_{I}=Integral(ψ(γT)dt)=0 (92)

Weighting function is determined based upon the user's experience of the system.

Analytical treatment is subject to future study.

Alternatively, an empirical approach which linearizes the risk or reliability and objective function and uses regression analysis to evaluate the weight function based on the failure data or hazard rate.

Step 8: Compute the risk potential contribution of top event loss of containment:

$$Risk Potential = \frac{{\prod }_{i = 1}^{n} {r}_{i}^{wi}}{1 - {\prod }_{i = 1}^{n} {( 1 - {R}_{si} )}^{{w}_{Rsi}}} \qquad ( 93 )$$

Step 9: Compute the Safety Potential:

$$\begin{matrix}Safety Potential = \frac{1}{Risk Potential} \\ = \frac{Reliability of Safety Systems}{Risk to Process System}\end{matrix} \qquad ( 94 )$$

The safety potential is a measure of the true reliability of safety system designed to protect the component systems under hazard threat as shown in FIG. 5D.

Step 0: Identify the hazard function, Hi, as shown in FIGS. 5E and 5F.

Risk and Safety Management Tools for Deepwater FPSOS Bow-Tie Systems.

The present invention provides simulation tools for implementing safety management programs for complex bow tie risk systems relating to an FPSO operating in a deep water environment. The bow tie systems represent diagrammatic architecture that connects threats to controls in place to safeguard the release of containments and recovery programs and systems. In the present invention, the bow tie systems are modified to incorporate a fuzzy class belief weighted index to numerically quantify in metrics threats to a vessel and safety programs in place.

The typical linguistic variables used to describe FR, CS, and FCP of a particular element may be defined and characterized as follows: FR describes failure rate frequencies in a certain period, which represents the number of failures anticipated during a design life span of a particular system or item. To estimate FR, one may choose to use such linguistic terms as very low (VL), low (Lo), reasonably low (RLo), average (A), reasonably frequent (RF), frequent (F), and highly frequent (HF). This fuzzy class can be assigned a numerical constant as follows:

| | | | Fuzzy Numeric |
|---|---|---|---|
| Fuzzy Class | | | (on a scale of 1-10) |
| Very Low (Negligible) | (VL) | F_{FR}(1) | 0 |
| Low | (Lo) | F_{FR}(2) | 1 |
| Reasonably Low | (RLo) | F_{FR}(3) | 3 |
| Average | (A) | F_{FR}(4) | 5 |
| Reasonably Frequent | (RF) | F_{FR}(5) | 7 |
| Highly Frequent | (HF) | F_{FR}(6) | 9 |
| Too Frequent (Worst Case) | (TF) | F_{FR}(7) | 10 |

CS expresses a numerical value of possible consequences ranked according to the severity of failure effects. The linguistic terms are: negligible (N), marginal (Ma), moderate (Mo), critical (Cr), and catastrophic (Ca). The linguistic terms describing these consequences can be assigned the following fuzzy numeric constants:

| Constant | | |
|---|---|---|
| Fuzzy Class | | Fuzzy Numeric Constant |
| Zero-Fatality (Negligible) | F_{CS} (1) | 0 |
| Minor (Marginal) | F_{CS} (2) | 1 |
| Major (Moderate) | F_{CS} (3) | 2-10 |
| Severe (Critical) | F_{CS} (4) | 11-50 |
| Fatality (Minor Catastrophic) | F_{CS} (5) | 51-100 |
| Disaster (Catastrophic) | F_{CS} (6) | 100+ |

FCP defines the probability that consequences will occur given the occurrence of the event. For FCP, one may choose to use such linguistic terms as Remote to Occur, Very Unlikely (U), Unlikely (RU), Likely (L), Very Likely (HL), and Definite (D).

FCP has fuzzy classes F {1, 2, 3, 4, 5} defined by numerical value assigned as follows:

| Fuzzy Class Numeric | Fuzzy Class |
|---|---|
| Definite to [>10]/yr | F_{CP} (0) |
| Very likely [>1-10]/yr assigned a value fuzzy set value | F_{CP} (1) |
| Likely, [0.01-1]/yr assigned a value fuzzy set value | F_{CP} (2) |
| Unlikely [0.0001-0.01]/yr assigned a value fuzzy set value | F_{CP} (3) |
| Very unlikely [0.000001-0.0001]/yr assigned a value fuzzy | F_{CP} (4) |
| set value | |
| Remote [0.00000001-0.000001]/yr assigned a value fuzzy | F_{CP} (5) |
| set value | |

Hazards in each fuzzy class are computed randomly using Monte Carlo Simulation trained conveniently by Excel spreadsheet by invoking the object RAND [ ]. See also FIG. 1B.

Constructing Bow Tie Diagrams for Accident Pathways in FPSOS Systems.

The present invention introduces the method of fuzzy class weighted index belief concepts to designing bow tie systems to provide a numerical measure of the level of threats and reliability of controls to safeguard containment release. This is important because deriving quantification parameters using qualitative tools of risk threats and safety reliabilities influences how bow ties leading to accidents are numerically quantified. The hazard rates are derived from fuzzy weight belief classes. The weights index incorporates the safety fraction and the hazard shape index to construct the safety barriers and control levels relevant to its performance.

Application of Bow Tie Methods to Typical FPSO Systems.

The methods described in the previous section were applied to an FPSO-based production development comprising a wellhead platform and an FPSO. Oil is transferred from the platform to the FPSO via a subsea pipeline. The platform is located about 1 km from the southbound shipping lane, approximately 6.5 km east of the coast in 57 m of water. The platform consists of a four-leg jacket supporting a two-level deck for wellhead and production test equipment. It operates as an unmanned platform. All power is supplied by subsea cables from the FPSO. The FPSO is a dedicated tanker which is planned to locate in the field for at least 10 years. The vessel is a steam turbine tanker and is classed with DNV as a floating production and storage unit. The FPSO is permanently moored approximately 800 m southwest of the wellhead platform, and processing and storage of the crude oil is conducted onboard. Treated oil is stored in the tanker prior to sale via export tankers. Typical current production is about 13,000 BOPD of 23 API oil, and the gas-to-oil ratio is low, averaging about a GOR of 6. Associated gas is cold vented from the deck processing equipment. Particular safety concerns become evident once an FPSO had been selected as the development option. These are the large stored inventory of crude oil, the deck process equipment, marine and production system interfaces, platform manning, proximity to the southbound shipping lane, cargo offloading, personnel transfers between the FPSO and the platform, safety standby vessel support, and the presence of mixed marine and production crews of different cultures.

The major hazards identified and input into the decision support expert systems are:

(1) a fire, explosion or the release of a dangerous substance involving death or serious injury to persons (λₘ₁=fₘ₁);
(2) any event involving major damage to the structure or plant of the installation or any loss in stability (λ_{m2=f}ₘ₂);
(3) the collision of helicopter with the installation (λ_{m3=f}ₘ₃);
(4) the failure of life support systems (λₘ₄=fₘ₄);
(5) any other event arising from a work activity involving (λₘ₅=fₘ₅) death or serious personal injury to two or more persons (λₘ₆=fₘ₆).

An important component of the bow tie system consists of mitigation and control (he safety aspects). The present invention teaches that these objectives should be captured in a weight matrix associated with each risk or hazard variable. The objectives, which must include personnel protection on the FPSO and platform safety from major accidents, are:

(1) To provide measures for the safe and effective evacuation, escape, and rescue of personnel from the FPSO/platform to a place of safety;
(2) to provide measures (emergency systems) to control and mitigate potential major accidents.
(3) to ensure that the emergency systems provided can survive a major accident and continue operating at a sufficient level of operability for the duration required to carry out its function.

These present invention teaches that these objectives are supplemented by specific system belief variables for each key element of the overall evacuation, escape, and rescue system, including the TR and each emergency system. Each of the specific system goals are to be met as far as reasonably practicable. Generic impairment criteria were applied to determine the effect of a hazard on personnel. The hazards included: (1) Loss of structural support; (2) thermal radiation levels (kW/m2); (3) overpressure (bar); (4) smoke concentration (% by volume); (5) tas and toxic fumes (ppm); (6) inside temperature boundaries; (7) loss of command support; (8) loss of communications; (9) loss of emergency power; and (10) control system failure. The risk contributor to potential loss of life on the FPSO were analyzed as follows (total 100%): (1) TR Impairment 59%; (2) process/deck piping pool fire 13%; (3) non-field vessel collision 7%; (4) mooring line failure 6%; (5) offloading vessel collision 4%; (6) cargo tank fire-explosion 3%; and (7) others 8%. The risk contributor to potential loss of life on the platform was as follows (total 100%): (1) pool fires (all areas) 53%; (2) non-field vessel collisions 34%; (3) FPSO collision 6%; (4) riser-sealine fires 5%; and (5) others 2%. ALARP (as low as reasonably possible) was demonstrated by showing that no additional measures can reasonably be implemented in order to reduce the risks any further. Typical data for failure consequence probability for different human crew optimized in a random variable mesh are:
Process worker on FPSO: 5.76×10⁻⁴ fatalities per year
Ship crew worker on FPSO: 4.19×10⁻⁴ fatalities per year
Accommodation worker on FPSO: 3.70×10⁻⁴ fatalities per year
Process worker on platform (overnight on FPSO): 4.58×10⁻⁴ fatalities per year.

The major accidents considered that could lead to loss in containment fall into two classes:

1. Technical and/or operational failure; and
2. Human and organizational errors: a. Man/machine interface, b. Availability and effectiveness of operational, c. Procedures and other factors which directly affect a person's performance (e.g., stress, system understanding, tiredness, etc.).

Technical and operational failures are by products from designs, age, operations, process, and environmental failure factors. Human and Organizational Factors (HOF) correspond to what are often termed “human factors.” The general model for presenting what is included in HOF is based on general industry practices, includes the following elements: People, Equipment (e.g. hardware), Management systems, Culture and environment. Equipment, people and management systems are shown as elements within the framework created by culture and environment. Examples of management systems include Procedures, Communication, Training, Management of change, Risk assessment. Repair or the Safety Measures Considered for FPSO, Off-loading arrangements, Shuttle tanker when in off-loading mode, Supply vessels during transfer for cargo between vessels. This data is presented in the following Table 1.

TABLE 1

| | | | | | Simulated |
|---|---|---|---|---|---|
| | | FPSO Based Production Facility | | | Analysis |
| | Typical Data | | | Process | Deriving the |
| | Process | Ship Crew | Accommodation | Worker (PF) on | Hazard Shape |
| Analysis | Worker (FP) | Worker (FP) | Worker (FP) | Platform | Index |
| Hazard Rate | 5.76E−04 | 4.19E−04 | 3.70E−04 | 4.58E−04 | Hazard Shape |
| | | | | | Index |
| Safety: Fuzzy | 12.90% | 36.70% | 44.10% | 30.80% | 1.6 |
| Class 3 | | | | | |
| Safety: Fuzzy | 61.30% | 71.86% | 75.16% | 69.24% | 0.6 |
| Class 4 | | | | | |

Bowtie System for FPSO/Offshore Platform

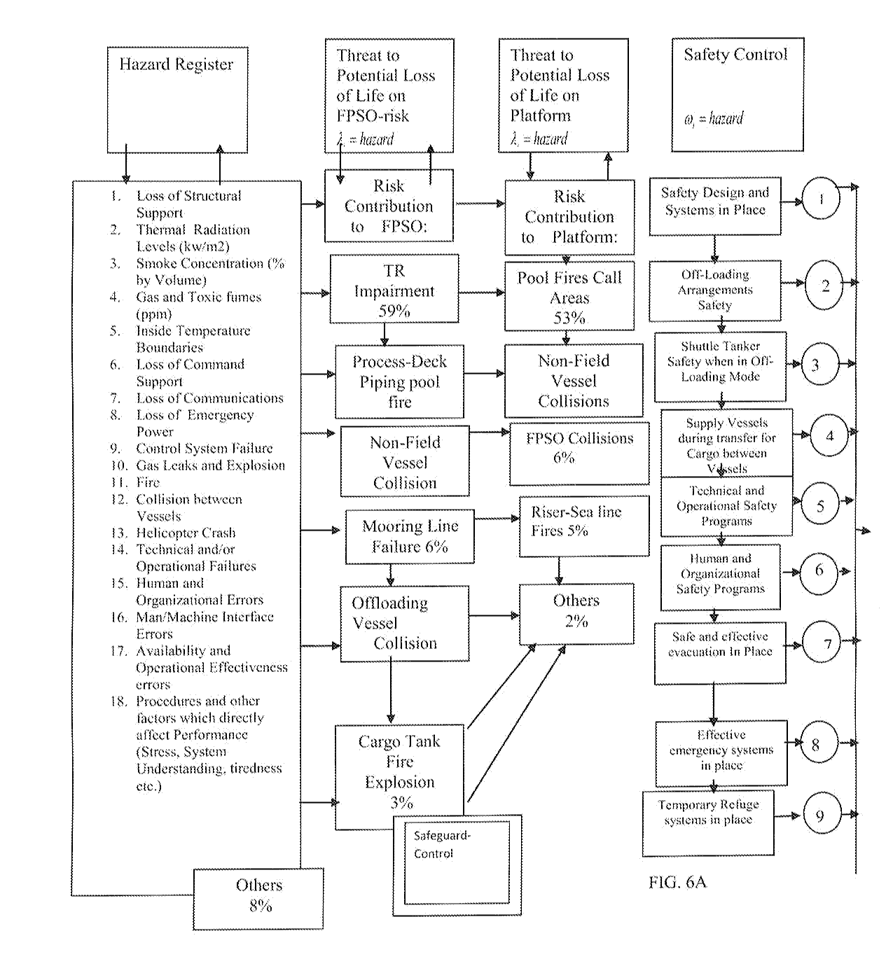

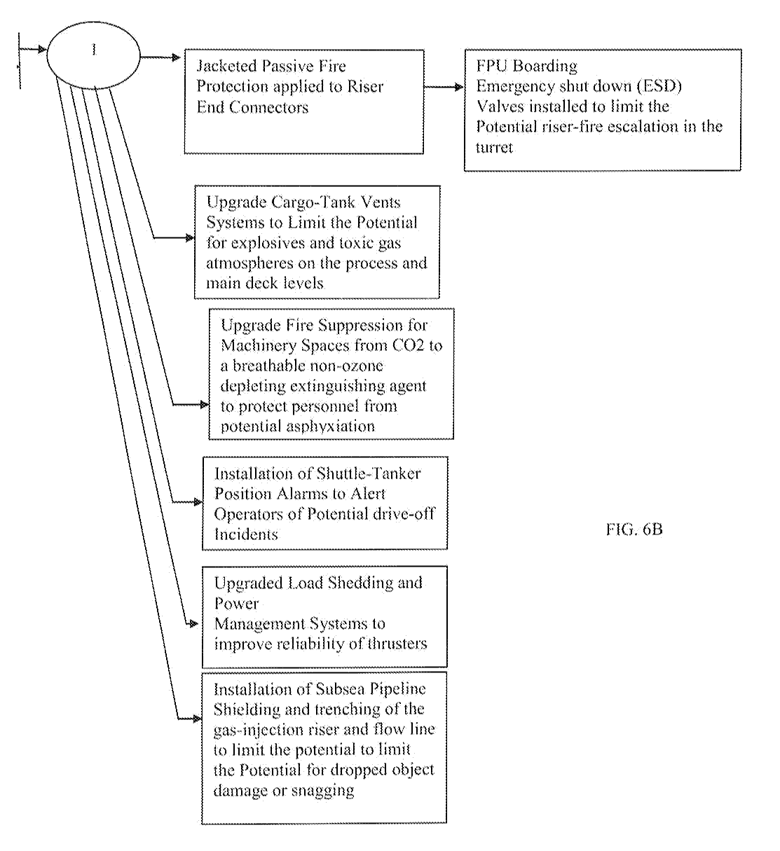

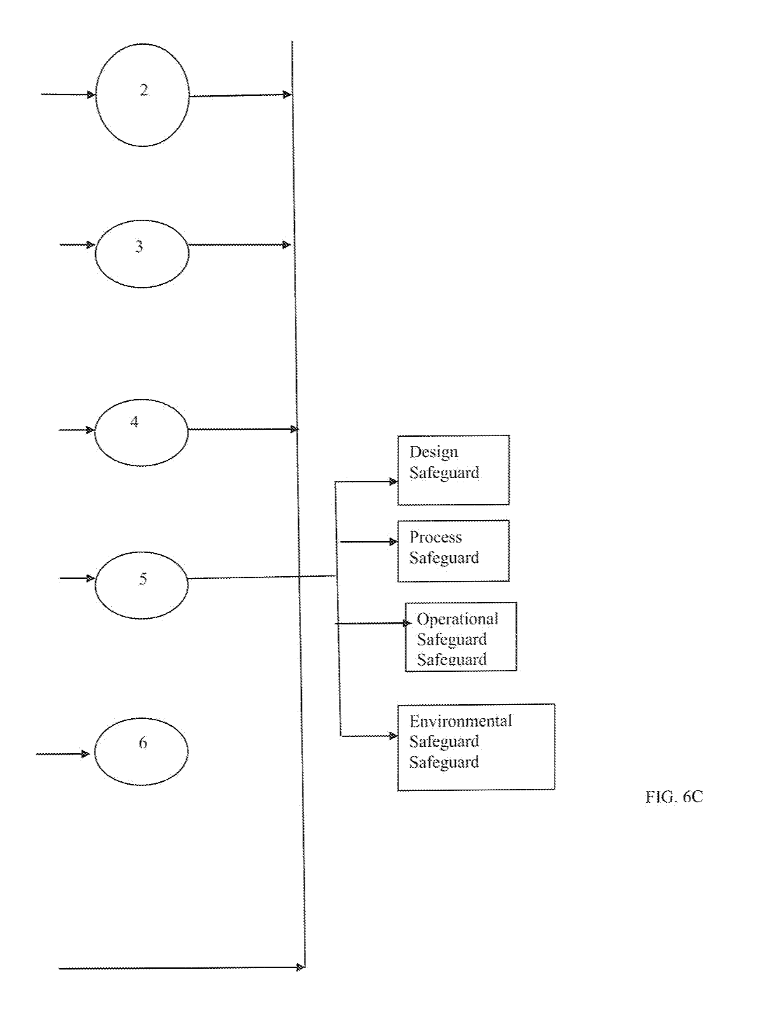

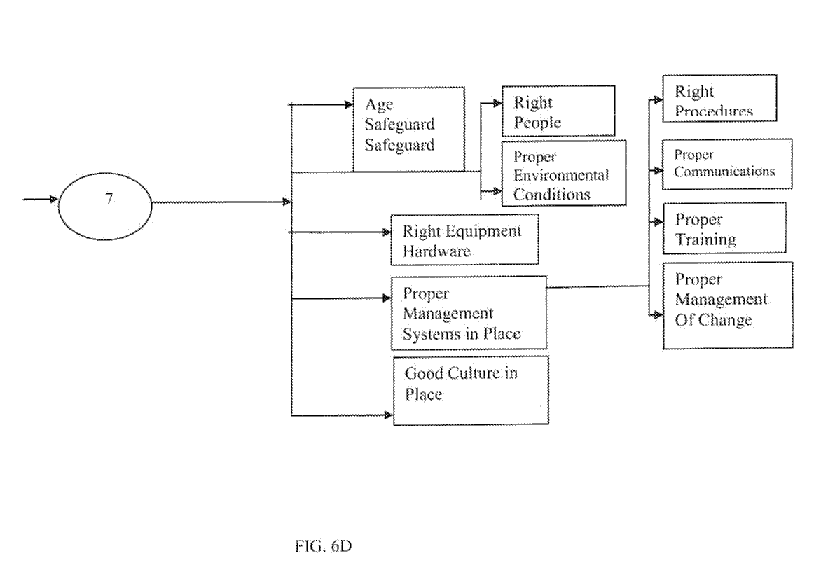

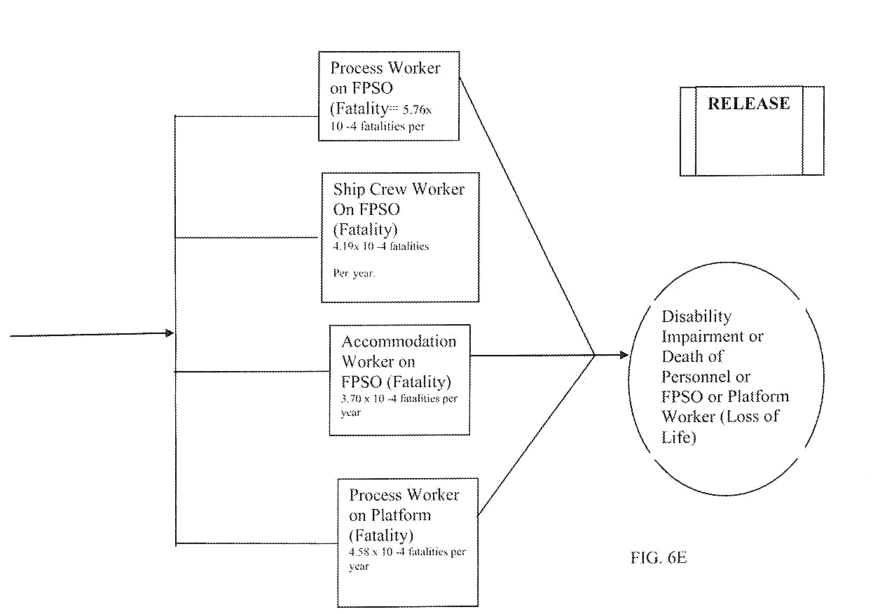

The Bowtie design for the FPSO described above has been provided by these present inventions including all potential Hazards in the flowchart presented as FIGS. 6A to 6E. See also FIG. 3.

Bow Tie for FPSO systems

The threat and control Barriers in Place to prevent loss in containment is modeled as a matrix equation presented below: The Hazards Bowtie Matrix Parallel Systems

$$( \begin{matrix}{λ}_{11} & {λ}_{12} & … & {λ}_{1 n} \\ {λ}_{21} & {λ}_{22} & … & {λ}_{2 n} \\ {λ}_{31} & {λ}_{32} & … & {λ}_{3 n} \\ {λ}_{41} & {λ}_{42} & … & {λ}_{4 n} \\ {λ}_{51} & {λ}_{52} & … & {λ}_{5 n} \\ {λ}_{n 1} & {λ}_{n 2} & … & {λ}_{nn}\end{matrix} ) ( \begin{matrix}{ω}_{11} & {ω}_{12} & {ω}_{13} & {ω}_{14} \\ {ω}_{21} & {ω}_{22} & {ω}_{32} & {ω}_{42} \\ {ω}_{31} & {ω}_{23} & {ω}_{33} & {ω}_{43} \\ … & … & … & … \\ … & … & … & … \\ {ω}_{n 1} & {ω}_{n 2} & {ω}_{n 3} & {ω}_{n m}\end{matrix} ) = ( \begin{matrix}{λ}_{1 m} \\ {λ}_{2 m} \\ {λ}_{3 m} \\ … \\ … \\ {λ}_{n m}\end{matrix} ) \qquad ( a )$$

The goal is the find the weights once the fuzzy class to which each component items system of the threats belong. The hazards rate that is observed using the weights index to judge the performance and the Barriers-controls used as safe guards to those threats is deduced if the inverse of equation 9 is derived. This is shown as in equation 10.

$$( \begin{matrix}{ω}_{11} & {ω}_{12} & {ω}_{13} & {ω}_{14} \\ {ω}_{21} & {ω}_{22} & {ω}_{32} & {ω}_{42} \\ {ω}_{31} & {ω}_{223} & {ω}_{33} & {ω}_{43} \\ … & … & … & … \\ … & … & … & … \\ {ω}_{n 1} & {ω}_{n 2} & {ω}_{n 3} & {ω}_{n m}\end{matrix} ) = {( \begin{matrix}{λ}_{11} & {λ}_{12} & … & {λ}_{1 n} \\ {λ}_{21} & {λ}_{22} & … & {λ}_{2 n} \\ {λ}_{31} & {λ}_{32} & … & {λ}_{3 n} \\ {λ}_{41} & {λ}_{42} & … & {λ}_{4 n} \\ {λ}_{51} & {λ}_{52} & … & {λ}_{5 n} \\ {λ}_{n 1} & {λ}_{n 2} & … & {λ}_{nn}\end{matrix} )}^{- 1} ( \begin{matrix}{λ}_{1 m} \\ {λ}_{2 m} \\ {λ}_{3 m} \\ … \\ … \\ {λ}_{n m}\end{matrix} ) \qquad ( b )$$

Hazards in series are systems are connected such that failure of one of the component in the system means failure of the overall systems. The BowTie matrix has been represented in equation (11) and the computation of hazard systems which are in series results in weighs index associated with each of the components. The weight index can derived from equation (13)

$$( \begin{matrix}In {λ}_{11} & In {λ}_{12} & … & In {λ}_{1 n} \\ In {λ}_{21} & In {λ}_{22} & … & In {λ}_{2 n} \\ In {λ}_{31} & In {λ}_{32} & … & In {λ}_{3 n} \\ In {λ}_{41} & In {λ}_{42} & … & In {λ}_{4 n} \\ In {λ}_{51} & In {λ}_{52} & … & In {λ}_{5 n} \\ In {λ}_{n 1} & In {λ}_{n 2} & … & In {λ}_{nn}\end{matrix} ) ( \begin{matrix}{\overline{ω}}_{s 11} & {\overline{ω}}_{s 12} & {\overline{ω}}_{s 13} & {\overline{ω}}_{s 14} \\ {\overline{ω}}_{s 21} & {\overline{ω}}_{s 22} & {\overline{ω}}_{s 23} & {\overline{ω}}_{s 24} \\ {\overline{ω}}_{s 31} & {\overline{ω}}_{s 32} & {\overline{ω}}_{s 33} & {\overline{ω}}_{s 34} \\ … & … & … & … \\ … & … & … & … \\ {\overline{ω}}_{sn 1} & {\overline{ω}}_{sn 2} & {\overline{ω}}_{sn 3} & {\overline{ω}}_{snm}\end{matrix} ) = ( \begin{matrix}In {λ}_{s 1 m} \\ In {λ}_{s 2 m} \\ In {λ}_{s 3 m} \\ … \\ … \\ In {λ}_{snm}\end{matrix} ) \qquad ( c )$$

$$( \begin{matrix}{\overline{ω}}_{p 11} & {\overline{ω}}_{p 12} & {\overline{ω}}_{p 13} & {\overline{ω}}_{p 14} \\ {\overline{ω}}_{p 21} & {\overline{ω}}_{p 22} & {\overline{ω}}_{p 23} & {\overline{ω}}_{p 24} \\ {\overline{ω}}_{p 31} & {\overline{ω}}_{p 32} & {\overline{ω}}_{p 33} & {\overline{ω}}_{p 34} \\ … & … & … & … \\ … & … & … & … \\ {\overline{ω}}_{pn 1} & {\overline{ω}}_{pn 2} & {\overline{ω}}_{pn 3} & {\overline{ω}}_{pnm}\end{matrix} ) = {( \begin{matrix}In {λ}_{11} & In {λ}_{12} & … & In {λ}_{1 n} \\ In {λ}_{21} & In λ & … & In {λ}_{2 n} \\ In {λ}_{31} & In {λ}_{32} & … & In {λ}_{3 n} \\ In {λ}_{41} & In {λ}_{42} & … & In {λ}_{4 n} \\ In {λ}_{51} & In {λ}_{52} & … & In {λ}_{5 n} \\ In {λ}_{n 1} & In {λ}_{n 2} & … & In {λ}_{nn}\end{matrix} )}^{- 1} ( \begin{matrix}In {λ}_{p 1 m} \\ In {λ}_{p 2 m} \\ In {λ}_{p 3 m} \\ … \\ … \\ In {λ}_{pnm}\end{matrix} ) \qquad ( d )$$

The recovery repair rate after loss in containment is derived as a matrix equation. The Recovery Bowtie Matrix for in Parallel is given by:

$$( \begin{matrix}{μ}_{11} & {μ}_{12} & … & {μ}_{1 n} \\ {μ}_{21} & {μ}_{22} & … & {μ}_{2 n} \\ {μ}_{31} & {μ}_{32} & … & {μ}_{3 n} \\ {μ}_{41} & {μ}_{42} & … & {μ}_{4 n} \\ {μ}_{51} & {μ}_{52} & … & {μ}_{5 n} \\ {μ}_{n 1} & {μ}_{n 2} & … & {μ}_{nn}\end{matrix} ) ( \begin{matrix}{\overline{ω}}_{11} & {\overline{ω}}_{12} & {\overline{ω}}_{13} & {\overline{ω}}_{14} \\ {\overline{ω}}_{21} & {\overline{ω}}_{22} & {\overline{ω}}_{32} & {\overline{ω}}_{42} \\ {\overline{ω}}_{31} & {\overline{ω}}_{23} & {\overline{ω}}_{33} & {\overline{ω}}_{43} \\ … & … & … & … \\ … & … & … & … \\ {\overline{ω}}_{n 1} & {\overline{ω}}_{n 2} & {\overline{ω}}_{n3} & {\overline{ω}}_{n m}\end{matrix} ) = ( \begin{matrix}{μ}_{1 m} \\ {μ}_{2 m} \\ {μ}_{3 m} \\ … \\ … \\ {μ}_{n m}\end{matrix} ) \qquad ( e )$$

Hence once the repair rates of the outcome is known, and the particular fuzzy hazard classification is known, we can evaluate the performance of the repair systems by deriving the weights associated with each fuzzy repair rates for the various hazard components by computing the inverse of equation

$$( \begin{matrix}{\overline{ω}}_{11} & {\overline{ω}}_{12} & {\overline{ω}}_{13} & {\overline{ω}}_{14} \\ {\overline{ω}}_{21} & {\overline{ω}}_{22} & {\overline{ω}}_{32} & {\overline{ω}}_{42} \\ {\overline{ω}}_{31} & {\overline{ω}}_{23} & {\overline{ω}}_{33} & {\overline{ω}}_{43} \\ … & … & … & … \\ … & … & … & … \\ {\overline{ω}}_{n 1} & {\overline{ω}}_{n 2} & {\overline{ω}}_{n3} & {\overline{ω}}_{n m}\end{matrix} ) = {( \begin{matrix}{μ}_{11} & {μ}_{12} & … & {μ}_{1 n} \\ {μ}_{21} & {μ}_{22} & … & {μ}_{2 n} \\ {μ}_{31} & {μ}_{32} & … & {μ}_{3 n} \\ {μ}_{41} & {μ}_{42} & … & {μ}_{4 n} \\ {μ}_{51} & {μ}_{52} & … & {μ}_{5 n} \\ {μ}_{n 1} & {μ}_{n 2} & … & {μ}_{nn}\end{matrix} )}^{- 1} ( \begin{matrix}{μ}_{1 m} \\ {μ}_{2 m} \\ {μ}_{3 m} \\ … \\ … \\ {μ}_{n m}\end{matrix} ) \qquad ( f )$$

14. The Recovery Repair Bowtie Matrix for Series Systems is given as equation 17

$$( \begin{matrix}In {μ}_{11} & In {μ}_{12} & … & In {μ}_{1 n} \\ In {μ}_{21} & In {μ}_{22} & … & In {μ}_{2 n} \\ In {μ}_{31} & In {μ}_{32} & … & In {μ}_{3 n} \\ In {μ}_{41} & In {μ}_{42} & … & In {μ}_{4 n} \\ In {μ}_{51} & In {μ}_{52} & … & In {μ}_{5 n} \\ In {μ}_{n 1} & In {μ}_{n 2} & … & In {μ}_{nn}\end{matrix} ) ( \begin{matrix}{\overline{ω}}_{11} & {\overline{ω}}_{12} & {\overline{ω}}_{13} & {\overline{ω}}_{14} \\ {\overline{ω}}_{21} & {\overline{ω}}_{22} & {\overline{ω}}_{32} & {\overline{ω}}_{42} \\ {\overline{ω}}_{31} & {\overline{ω}}_{23} & {\overline{ω}}_{33} & {\overline{ω}}_{43} \\ … & … & … & … \\ … & … & … & … \\ {\overline{ω}}_{n 1} & {\overline{ω}}_{n 2} & {\overline{ω}}_{n 3} & {\overline{ω}}_{n m}\end{matrix} ) = ( \begin{matrix}In {μ}_{1 m} \\ In {μ}_{2 m} \\ In {μ}_{3 m} \\ … \\ … \\ In {μ}_{n m}\end{matrix} ) \qquad ( g )$$

Simulation Results by this present Invention

Hazard Weights Data for FPSO Bow Tie System

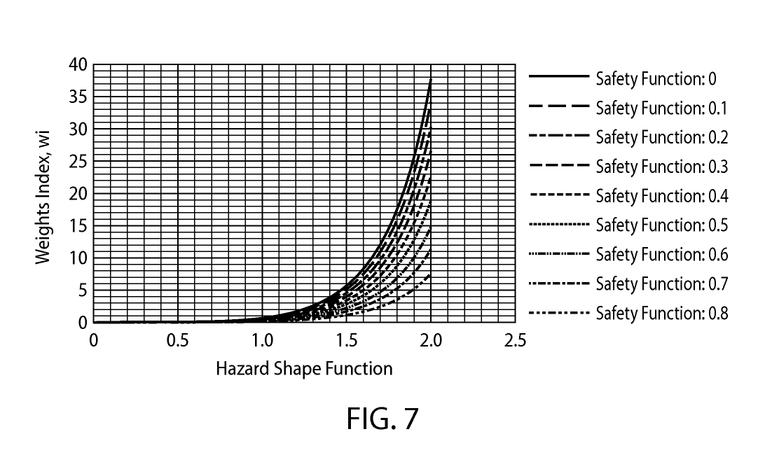

FIG. 7 shows the weight index for different class of safety fraction for fuzzy class 1 (very likely to occur). The weight index for all Safety Index increases exponentially as the Hazard shape index increases from 0 to 2.0, where safety fraction 0 or 0% shows highest increase than a safety fraction of 0.8; 80% showing least increase.

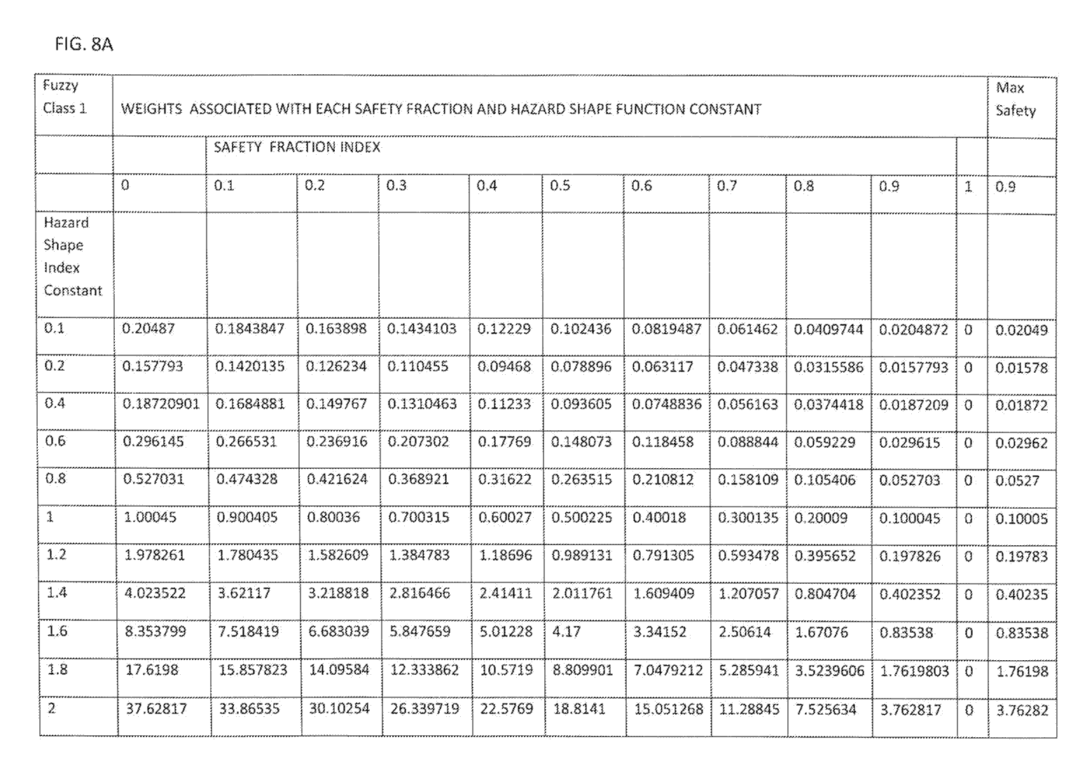

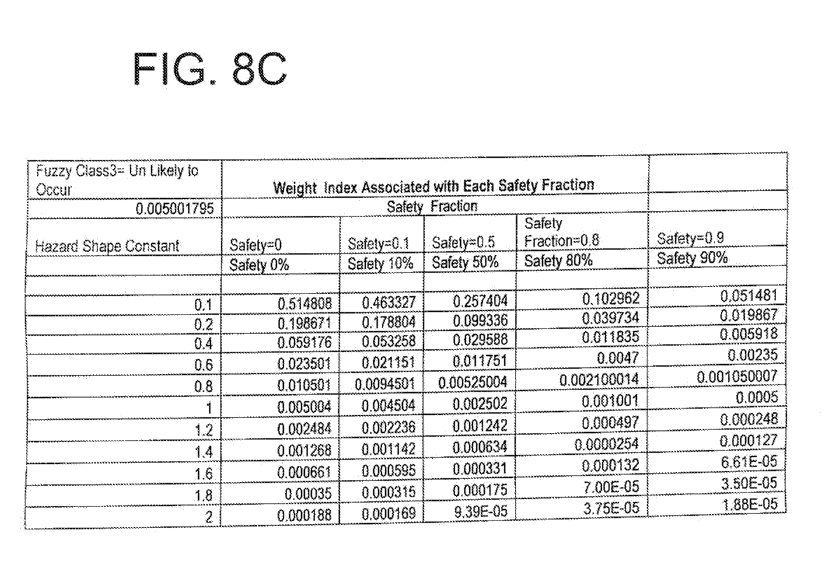

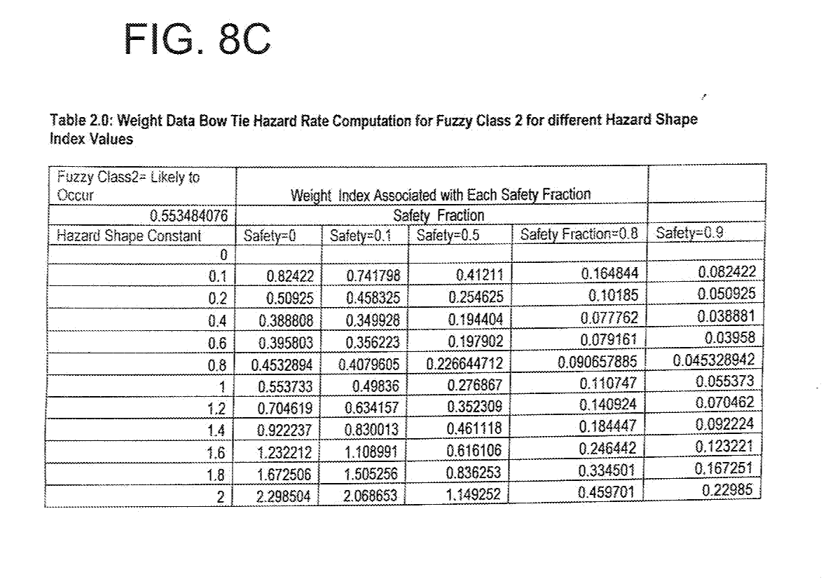

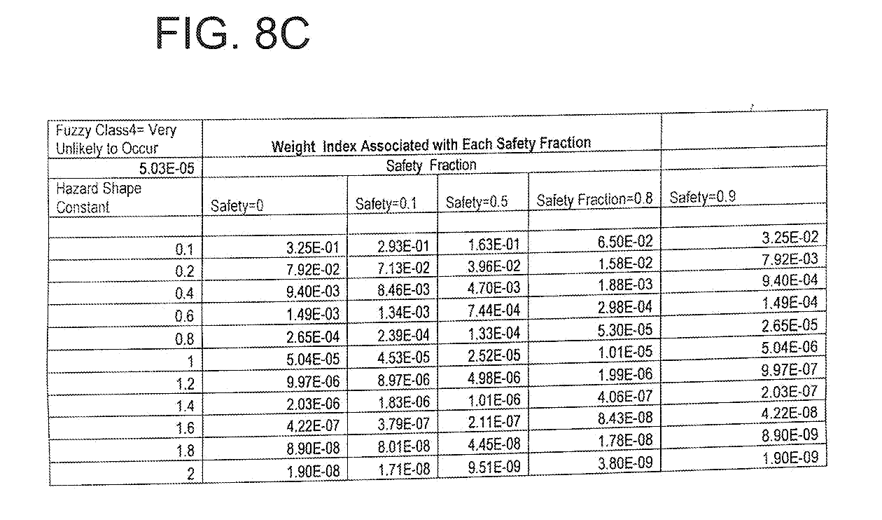

The Generic weight data for Bow Tie System is presented in FIG. 8A as Table 1.0. The data connects hazard shape constants and its safety fraction to generate the weights associated with each safety fraction and hazard shape function constants. The weight index data simulated is utilized to generate hazard rate data for Fuzzy Class 1, Fuzzy Class 2, Fuzzy Class 3 and Fuzzy Class 4 which is presented in FIG. 8A (Table 1), FIG. 8B (Table 2.0), FIG. 8C (Table 3.0) and FIG. 8D (Table 4.0). The generic weigh data used for calibration studies is matched with the hazard shape index and its corresponding safety fraction. From the tabulated numeric values, it is clear that, the Hazard rate decreases with increasing Safety fraction Index and Hazard shape function Index.

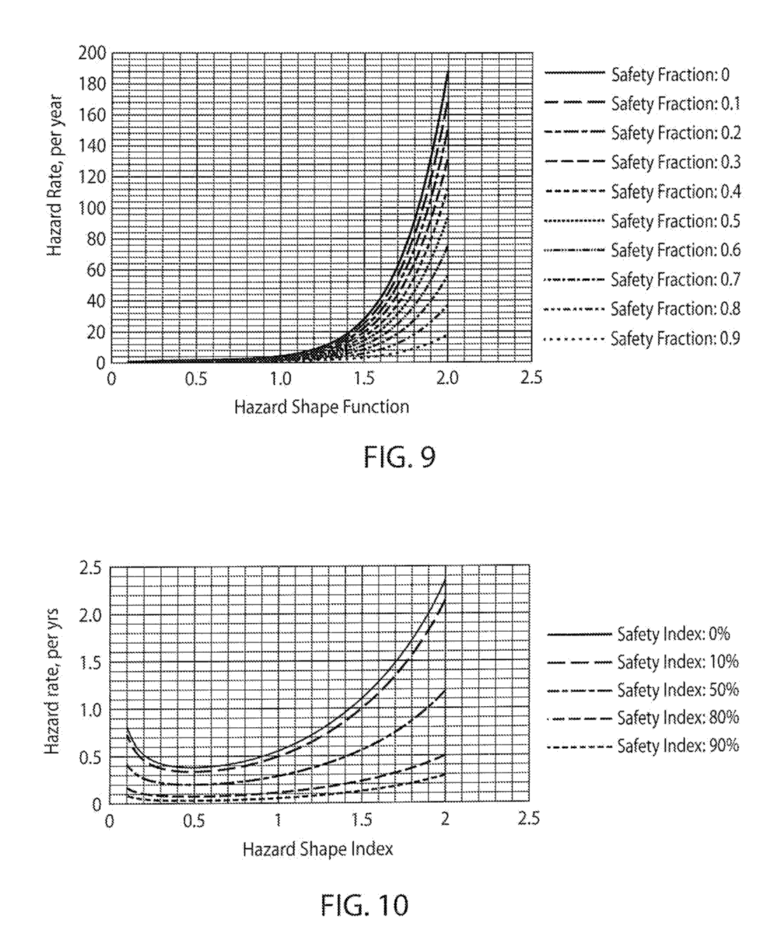

Plots of Hazard Rate with Shape Functions for different Fuzzy Class and Safety Fraction Index for the Bow Tie Case is shown in FIGS. 9 and 10.

Predictive Methods for Complex Risk and Safety Bow Tie-Systems

This present invention employs a method that uses weighted fuzzy class belief index to construct numerical metrics of complex risk and hazard data to hierarchically evaluate and predict the level of threat and safety of FPSOs Bow Tie systems has been developed. The process hazards events of the FPSOs systems listed in a hazard register is tagged to indicate definite fuzzy hazard class, hazard shape and safety index all incorporated in a weight index variable ω_{i,j,k} to provide a numerical measure of the hazard and safety status of the process component systems under threat of failure. The transient state behaviour of the risk and safety systems of the process system is modeled using the markov chain process. The methods was applied to analyze the threat and safety levels of a typical FPSO operating in the Deep Offshore Waters simulated as on real-time basis using the number index in the weight variable as a number level to show the level of graduation of safety level from 0% to 100% and the hazard shape index from 0 to 3.0 in steps of 0.1, and the Fuzzy class 1 (very likely to fail) to Fuzzy Class 4 (remote to fail) in constants of 10n where n could be any number from 1 to −8 depending on the fuzzy class. The results of computer simulation demonstrates that generic weight simulation data used for calibration studies matches the hazard shape index and its corresponding safety fraction of the selected risk components studied. From numerical studies the Hazard rate decreases with increasing Safety and Hazard shape function Index. The reversal of Hazard rate profile trends as the fuzzy hazard class graduates from Fuzzy Class 1 (Very Likely to Fail) to Fuzzy Class 4 (Remote to Fail) showing smaller beliefs index in the Hazard rate as time progress. FPSO HSE (Health, Safety and Environment) operators now have a tool to analyzed complex hazard events without any limitation of any accident data available, which is useful to construct numerical measures of risk and safety levels on real-time basis. Also the safety operators can now use numerical data based on the weight index-fuzzy class belief index to qualify different risk systems and predict future hazard rate trends, and what safety measures need to be upgraded to ensure containment.

The Risk and Safety Potential is computed thus:

$$Risk Potential = \frac{Risk}{Reliability of Safety Systems} \qquad ( 95 )$$

The Risk Potential gives a measure of the True Risk inherent in a System or Sub System

$$Safety Potential = \frac{1}{Risk Potential} = \frac{Reliability of Safety Systems}{Risk to Safety System} \qquad ( 96 )$$

The Safety Potential gives a measure of the Safety of a given System

Maximum Risk of a System based on New Technique

The maximum risk can be evaluated from the linear programming model. The maximum risk for a system that follows series configuration is given by

$$ln ( 1 - r ) = ln ( {\prod }_{i} {( 1 - {r}_{i} )}^{wi} ) = {w}_{1} ln {r}_{1} + {w}_{2} ln {r}_{2} + … + {w}_{n} ln {r}_{n} \qquad ( 97 )$$

Subject to the constraint equation

0≦rᵢ≦1 for i=1, 2, . . . n (98)

Equation 10 subject to equation 11 is our model for predicting a Series System, which is solved by finding the linear programming model that multiplies the respective weights to the Natural Logarithm of the respective risk events.

However the Maximum Risk model for a System operating in parallel is given below

$$\begin{matrix}Max ln r = {ω}_{1} ln {r}_{1} + {ω}_{2} ln {r}_{2} + … + ω rn ln {r}_{n} & ( 99 ) \\ 0 \leq {r}_{i} \leq 1 for i = 1 , 2 , … n & ( 100 ) \\ 0 < {\prod }_{i}^{n} {r}_{i} \leq 1 for i = 1 , 2 , … n & ( 101 )\end{matrix}$$

The Maximum Reliability of the Safety Systems can be evaluated using the model

$$\begin{matrix}Max ln r = ω R 1 ln R 1 + ω R 2 ln R 2 + … + ω Rn ln Rn & ( 101 ) \\ 0 \leq {R}_{i} \leq 1 for i = 1 , 2 , … n & ( 102 ) \\ 0 < {\prod }_{i}^{n} {R}_{i} \leq 1 for i = 1 , 2 , … n & ( 103 )\end{matrix}$$

For a parallel and series system, the maximum risk objective function can be translated thus

$$r = {\prod }_{i = 1}^{k} {r}_{i}^{ω i} + {\sum }_{i = k}^{n} {ω}_{i} {r}_{i} \qquad ( 104 )$$

We can solve the above couple system by analyzing the series and parallel systems separately. The linearized risk system for parallel couple.

$${Inr}_{p} = {\sum }_{i = 1}^{k} {ω}_{i} {Inr}_{i} \qquad ( 105 )$$

Total linearized risk objective function for the series-parallel couple system

$${r}_{T} = {\sum }_{i = 1}^{k} {ω}_{i} {Inr}_{i} + {\sum }_{i = k}^{n} {ω}_{i} {r}_{i} \qquad ( 106 )$$

This is subject to the constraint equation

$$\begin{matrix}0 \leq {r}_{i} \leq 1 & i = L … k AND i = k , … n \\ 0 \leq {\prod }_{i = 1}^{k} {ω}_{i} {r}_{i} \leq 1 & i = 1 , … k \\ 0 \leq {\sum }_{i = k}^{i = n} {ω}_{i} {r}_{i} \leq 1 & I = k , … n\end{matrix} \qquad ( 107 )$$

### 1. Limits of Safety

In order to find the Limits of Safety in a process system, we now apply the hof Stability Criteria that results in a Matrix Equation as follows

ζi+1j=HΩij, wherein

$$Ω ij = [ \begin{matrix}{ξ}_{ij} \\ {η}_{ij} \\ {γ}_{ij}\end{matrix} ]$$

$$ζ i + 1 j = [ \begin{matrix}ξ i + 1 j \\ η i + 1 j \\ γ i + 1 j\end{matrix} ]$$

ζi+1j is Risk Matrix Vector at particular time i and position j and Ωij, is the Risk Matrix Vector at an advanced time i+1, H=J is the Safety Deviation or Matrix of Safety and J is the Safety Deviation of Safety from a stable point as follows:

$$J = \frac{\partial ( {F}_{1} {F}_{2} {F}_{3} {F}_{4} {F}_{5} )}{\partial ( r , R , ω , λ , S )} \qquad ( 108 )$$

F1 is the Function associated with risk of the Process System, F2 is the Function associated with Reliability of the Safety System, F3 is the Function associated with weights that each Process System carried in a given environment at a given time, F4 is the Function associated with hazard rate of the process system, F5 is the Function associated with Safety of the Process System.

$$J = [ \begin{matrix}\frac{\partial {F}_{1 j}}{\partial {r}_{ij}} & \frac{\partial {F}_{1 j}}{\partial {R}_{ij}} & \frac{\partial {F}_{1 j}}{\partial {ω}_{ij}} & \frac{\partial {F}_{1 j}}{\partial {λ}_{ij}} & \frac{\partial {F}_{1 j}}{\partial {S}_{ij}} \\ \frac{\partial {F}_{2 j}}{\partial {r}_{ij}} & \frac{\partial {F}_{2 j}}{\partial {R}_{ij}} & \frac{\partial {F}_{2 j}}{\partial {ω}_{ij}} & \frac{\partial {F}_{2 j}}{\partial {λ}_{ij}} & \frac{\partial {F}_{2 j}}{\partial {S}_{ij}} \\ \frac{\partial {F}_{3 j}}{\partial {r}_{ij}} & \frac{\partial {F}_{3 j}}{\partial {R}_{ij}} & \frac{\partial {F}_{3 j}}{\partial {ω}_{ij}} & \frac{\partial {F}_{3 j}}{\partial {λ}_{ij}} & \frac{\partial {F}_{3 j}}{\partial {S}_{ij}} \\ \frac{\partial {F}_{4 j}}{\partial {r}_{ij}} & \frac{\partial {F}_{4 j}}{\partial {R}_{ij}} & \frac{\partial {F}_{4 j}}{\partial {ω}_{ij}} & \frac{\partial {F}_{4 j}}{\partial {λ}_{ij}} & \frac{\partial {F}_{4 j}}{\partial {S}_{ij}} \\ \frac{\partial {F}_{5 j}}{\partial {r}_{ij}} & \frac{\partial {F}_{5 j}}{\partial {R}_{ij}} & \frac{\partial {F}_{5 j}}{\partial {ω}_{ij}} & \frac{\partial {F}_{5 j}}{\partial {λ}_{ij}} & \frac{\partial {F}_{5 j}}{\partial {S}_{ij}}\end{matrix} ] \qquad ( 109 )$$

i=time element j=component under consideration working as a network to other components.

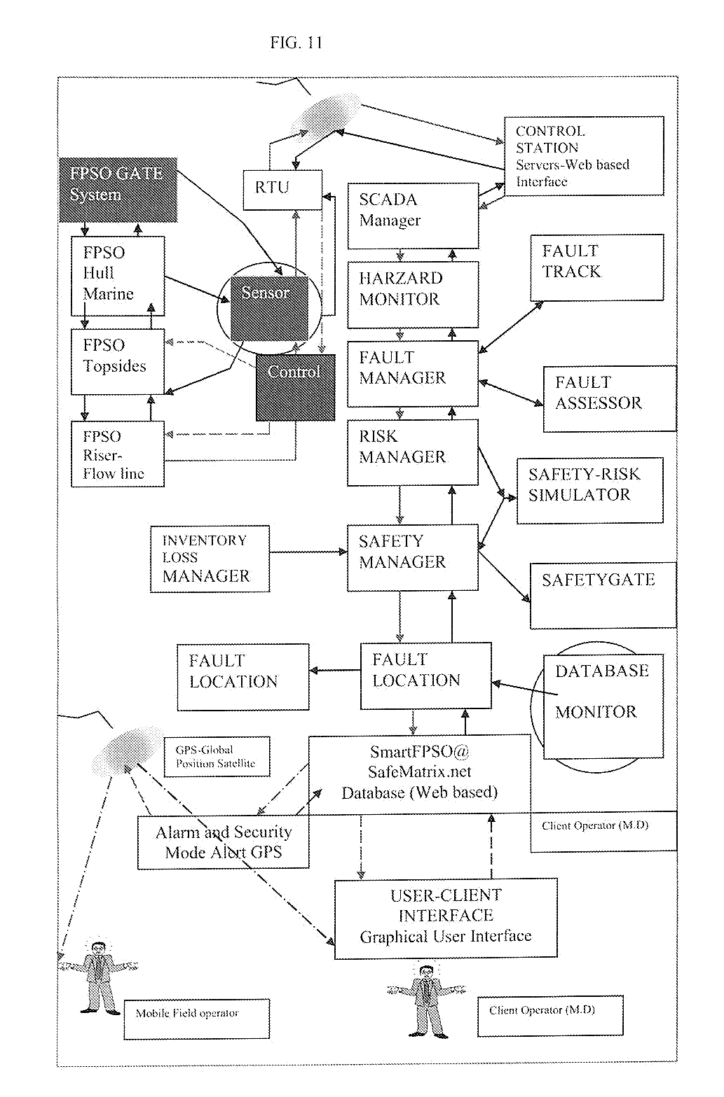

is the safety matrix function which is tells operators the Limits of Safety, such that If J=1 in absolute terms the Safety status is stable or good, if J<−1, the safety status is unstable and a Fault may exist in the System and an Unsafe position results, if J>1, the safety function becomes over stable, which indicates the systems functioning above normal or over design for safety. These criteria can be an important tool for Safety operators to mark the limit of design or operation. Any factor that tends to push safety function above or below absolute 1 should be minimized. This method for determining safety is not available in previous method for safety analysis. And FPSO System Design Safety Analysis is shown in FIG. 11 and described below.

The following requirements include at a minimum a description of every input (stimulus) into the system, every output (response) from the system and all internal processes performed by the system in response to an input or in support of an output. This form of analysis is necessary to help the developers get a clearer picture of the overall system and the interconnecting subsystems.

For designers: To design a good system to satisfy the requirements.

For testers: To test the system treasure the system satisfy those require.

Inputs into the Neural Network-Decision Support system;

Flow/Systems Parameters

Systems Parameters
Assets
Resources
Processes

Process variables

Pressure

Velocity

Temperature

All possible risk events

All possible safety systems installed per risks event

Hazard rate of each risk events

Weights of different risk events

Design Parameters
Structural Strength
Material

System specifications relating to Gas Export Process System comprise the input of raw materials, processing the raw materials into a value added product, and outputting the added value product.

3.1.1 SCADA Manager

Description: The SCADA Manager is the interface to the SCADA software and there are quite a number of them in the market. What the SCADA manager does is to present an interface to the SCADA software so that they can communicate with the FAULT FINDER software. The SCADA Manager would be abstracted SCADA interfaces which provide different implementations of those for different providers, so that the whole system would not depend on a particular provider, just an interface.

3.1.2 Hazard Monitor

Description: This is a real time database and associated program codes that are connected to the SCADA manager takes input data from the SCADA system and puts into its own database format fit for use by SAFETY_RISK simulator. It not only takes the information from SCADA but tracks/manages the data.

The Hazard monitor database system is connected to the sensors FAULT TRACK MODULES via the SCADA manager (abstracted software) and also to the SAFETY_RISK SIMULATOR, which does risk and safety analysis of the Gas Export Process System.

The hazard MONITOR and SAFETY_RISK SIMULATOR is linked to the SAFETY MANAGER which solves the risk and safety matrix1, stability profitability2, statistical matrix3 which evaluate the safety potential of the PROCESS_SYSTEM. See FIG. 3.1

Input: Outputs from the SCADA software; measured HAZARD rate, pressure, velocity, density of fluid FLOW from all the node segments.

Output-refined plurality of data put on different ports mainly a database.

3.1.3 Threshold Simulator

Description:

The threshold simulator subsystem is connected to the database subsystem, the HAZARD monitor subsystem, and the computational subsystem (Safety Track, Risk Simulator) allows for the tracking, regulation and correction of all error modes in the system. Typical errors are those from the instrument sensors, logical and computational errors.

Process: Data and capture, analysis and correction.

Inputs: *Instrument Errors (From Sensors).
*Computational Errors (From Safety track)
*Logical Errors (From Computational Subsystem)

Outputs: Unifying Codes for error tracking and Correction. Errors associated with each processing task for each of the code coverage tasks to eliminate errors introduced.

3.1.4 Process Gate Simulator

Description/Process Function: See FIG. 3.2 (Attachment Figures)

PROCESS Gate Simulator provides for the pictorial representation or graphical display of the PROCESS system. The PROCESS gate simulator also provides a design flow chart of the PROCESS network system showing all manifold points, Process System type, distance, diameter and specifications, sensors and value locations.

Inputs:

The basic inputs are the (i) PROCESS (Process System, Topsides, Storage) dimensions (ii) Elevation (iii) Design pressure (iv) Information on nodes, fluid properties (?), etc and basically all inputs required displaying PROCESS system structure.

Outputs:

Outputs are (i) graphical/Pictorial representation of the PROCESS network structure in visual format showing node distances value locations, manifold, sensors, RTUs, network configuration.(ii) Risk Status, Risk from what (System under scrutiny) risks to what, risk of what (measures of harm that we wish to assess), so what (decisions need to be taken) (iii) In the event of a fault, simulate commodity loss from the export Process System, pictorially displaying amount of fluid spilled, economic and risk analysis.

Safety Gate (Simulator)

Description/Functions:

The safety gate simulator does a preliminary assessment of inventory loss, the risk to the immediate environment, safety assessment, which sends this information to the inventory loss manager that does inventory loss assessment and control. The SAFETY gate simulator interfaces directly with the module of FAULT Track that determines if there's a fault or no fault. The SAFETY gate simulator has a real time database that would store all of this information and tells about the environmental consequences, risk.

Inputs:

The input to the SAFETY gate is the output from Fault Track computational subsystem that determines the event of a fault condition.

Outputs:

Fault condition status, volume of spill, time of spill, cause of spill, rendering of spill situation, accidents inventory and database of fault information.

3.1.6Fault Track Simulator

Description/Function:

The fault track simulator subsystem is the heart of the Safety software system and it is the core computational subsystem which solves the flow matrix, stability matrix (where the eigenvalues of the stability function is evaluated), the probability and statistical matrix, which evaluates the certainty of a fault in the Process System.

The fault track simulator does all these computation to determine the probability or certainty of a fault or no fault and determines the location of the fault all base on new methods for flow in Process Systems.

N.B. Refer to algorithm (and flow chart) for analysis of single and complex Process System network system (APPENDIX C) for fault detection included with this SRS.

The fault track works with various inputs from the RISK SIMULATOR, hazard MONITOR and THRESHOLD SIMULATOR to compute the Eigen values for velocity distance, time for various fault factors and does a pattern match to determine the event of a fault or no fault and the size and location of a fault.

Inputs: Inputs to fault Track simulator are the outputs from Flow Monitor, Flow Simulator and the Threshold Simulator which are basically pressure and velocity from different nodes, analyses Process System network segments and error correction values respectively.

Outputs: Typical outputs are fault status (Fault or No fault), fault location, fault size, number of faults, time of fault, etc.

3.1.7Performance and Reliability Decision Subcomponent

This subcomponent of the FAULT TRACK consists of program codes for checking the certainty of faults in a Process System through probability and optimization matrix methods wherein the code coverage database comprises of matrix array of trials for each test case in the said identified set of test cases and a column for each of the tasks. The decision variables we generated through a series of program codes to decide on the possibility/certainty of faults in the Process System, inventory loss, and risk assessment, failure and decision modes. Pls. refer to probability and decision algorithms.

3.1.8 Inventory Loss Manager (Release of Contaminant)

Description/Function:

The basic function of the inventory loss manager is to allow the software system analyze the inventory loss from the Process System and to determine the risk discharge of the fluid commodity in the Process System to the adjourning surrounding. This also does inventory loss analysis and control.

Compares the difference between the inlet and outlet measurements. The inventory loss manager may be regarded as a subcomponent of the spill gate simulator.

Inputs:

Inputs to the inventory loss manager are sensor measurements at the inlet and outlet of different Process System segments: This is taken from the RISKMATRIX Monitor real time database.

Outputs:

The outputs would be difference in measurements in form of fault deviations and analysis of discharge to the surroundings if there's any.

3.1.9 Output and Location Mode Simulator

Description/Function:

Basic function of the location mode simulator is to track and locate all faults along the Process System, stores in a database subsystem and formats the output in the event of a fault in a format for host devices like the PDA, phone, fax, email. What it does is to identify the software subsystem for which the persistent code coverage data should be collected; turning the program source code statements into a plurality of coverage tasks and incorporating the said output in a format fit for the output devices and the database.

Inputs:

Inputs to the location mode simulator are the output of the location detector from FAULT TRACK SIMULATOR.

Outputs:

Distance of fault, pinpoint location of fault, nearest shutdown value, etc. in form of alarm codes, warnings to the output devices like a mobile phone, PDA, fax machine, email.

Alarm and Security Mode Subsystem

Description/Function:

The alarm and security mode subsystem would typically consist of a portion of control code and an alarming device for the client site. The control code would typically a couple (variety) of test cases for different scenarios stored in it's database and when there's a deviation from the norm, an alarm mode code is activated which triggers the audible alarm and writes the scenarios into the master database subsystem.

Inputs:

1. Text cases from the output and location mode simulator.

Outputs:

1. Audible alarm warning, events logs, written to the master database.

3.1.11 Database Management Subsystem

Description/Function:

The database management system is the master database and it is associated codes that houses all the data collected, analyzed, and computed. This database would cut across all the subsystems of the software system that base to do with data collection and computation. The database should have quick query capabilities and should be rugged (among other required features of a real time system database management system). There would be two database systems one is the real time database and the other the historical database for long term retrieval.

Inputs:

Inputs to the Database include but not limited to (i) code coverage database software interfaced with the SCADA manager software (abstracted, SCADA software interface) linked with the RTUs and sensor devices (ii) code coverage data collected from the inventory loss simulator (iii) Output data from the fault TRACK simulator (velocity, pressure, density, location of spill, distance) (iv) Data from the flow monitor (v) data from the flow simulator (v) data from SAFETYGATE simulator (vi) outputs from the location mode simulator (etc).

Outputs:

Measured data from SCADA system and sensors (V,P,λ,T,)
Inventory of fluid data.
Process System data: Process System dimensions, elevation design pressure.
Fluid properties: Design, Viscosity, Kinematic Viscosity, water cut, Gas oil ratio, Heat Transfer coefficient, composition (natural gas), Thermal conductivity.
Spill data.
Time of spill, cause of spill, duration, and commodity loss.
Fault data.
No of faults, Time, location.
Accident history.

Functional Requirements of Software.

User Interface Requirements.

In our design of the user interfaces and accompanying requirements, the understanding of the users' context is necessary in order to translate the user requirements into a user interface specification. The context considered included the characteristics of the users and tasks.

The look and feel of the user interface shall be consistent with corporate branding standard and colours.

The Safety software system shall have standard windows functions and drop down menu items.

The Safety interface shall have at the bottom of the screen the user who logged on to the system, the fault status, date and time.

The user interface shall be based on a single or multiple windows with dialogue boxes being used to display error or help messages.

The system shall use colors to make the interface attractive and easy to use. However it will be important to avoid colors that contrast poorly, when there may be glare on the screen from sunlight.

The system shall provide the user the ability to press a help key to provide context based help in different situations the help window will displayed alongside the main window showing so that users can continue work or apply help as they work.

The error messages shall be concise, polite and informative. They will be tested on intended users before implementation.

All inputs shall receive visual and auditory feedback.

Clear graphical plots of faults and safety analysis shall be provided, with the option to be printed to an output device like a printer.

The Safety software system shall have a web interface accessible from any browser with appropriate security features and permissions.

The user interfaces shall be capable of displaying a plurality of information on the Process System flow system. This display would stimulate the flow of fluid through the Process System and the node segment showing requisite connected devices and status of fluid, fault, no fault or surge, and then predict level of hazards which determines the safety status

There shall be a database menu with features for querying the master database for requisite information and archives.

The user interface shall be capable of displaying the Process System network system in visual format showing nodes, distance, valves, sensors, controllers, RTUs, and network configuration.

The user interface displaying the Process System system, upon clicking on element shall display properties of that element with all relevant details.

The Safety software system shall have a PDA or phone interface for limited query functionality and events display status messages.

The Safety shall be capable of delivering all system responses within 5 seconds or at less on recommended system hardware.

The Safety software system shall have a safety profile window displaying safety profile analysis

The Safety software shall have an alarm and event log window.

Along with all the above display, the following functions display shall be required. (i) Overview Display (ii) Data I/O displays (iii) Fault detection and location status display (iv) Process System product properties display (iv) hazard rate and safety status vi) risk events

The following shall also be captured in the user interface; Station schematics, geographical displays, communications summary, line fill displays, fault detection displays, hydraulic gradient displays.

Hardware Interface Requirement

In this section we specify the logical characteristics of each interface between the software product and the hardware components of the system. This covers such matters as what devices are to be supported how they are to be supported and protocols.

The basic hardware components of the system that the software would interface with is the Intel x86 compatible CPU and instruction set because of it's wide spread support.

The software systems would interface with the field instruments like the RTU, PLC. System software shall interface with a digital card with appropriate operating system drivers.

This card shall have the function of sending out audible alarms in the control room in the events of a fault condition.

Software System Requirements

The Safety software system shall take input data from a SCADA software system via the appropriate SCADA MANAGER/INTERFACE′ subsystem software/codes.

The SCADA manager subsystem shall be a subsystem or subcomponent of the FAULTFINDER SOFTWARE SYSTEM and shall be abstracted interfaces (Application Programming Interface) that connects with the SCADA system software.

The basic function of the SCADA manager subsystem shall be able to translate the data provided by the SCADA software

The SCADA manager subsystem shall not be limited to one type of SCADA software, PLC, RTUs or Telemetry system and shall interface with most supported SCADA software system with minimum integration issues.

The SCADA manager shall be capable of data validation because in the real world the data collected by the instrumentation system is rarely perfect.

There shall be a hazardMONITOR2 Software subsystem, which consist of a sub database storing all data from the SCADA interface and one or more source programs, which identify the interface from which the data is to be collected, formatting the data and putting it into plurality of code statements.

The hazard MONITOR shall continually keep tract of data on (i) Fault (ii) Pressure surges (@ different node segments), flow velocity, density temperature, and viscosity of the fluid in the Process System.

The software system shall have an online learning capability as PROCESS_Safety Software always changes and instrument drift could occur over a long time period.

There shall be a SAFETY_RISK SIMULATOR3 software subsystem that would be interfaced with the hazard MONITOR and ‘PROCESS GATE4 software subsystem.

The RISK_SAFETY SIMULATOR subsystem shall take inputs from the hazard MONITOR database and perform dynamic hazard analysis of the Gas Export Process System system to determine hazard Rates from operation fluctuation as pressure, and flow velocity.

The RISK_SAFETY SIMULATOR subsystem shall be capable of performing safety analysis on the PROCESS under monitoring.

The RISK_SAFETY SIMULATOR subsystem shall interface directly with the PROCESS GATE subsystem to produce visual displays of the PROCESS Gas Export Process System structure and thus give a complete picture under the conditions.

The outputs from the RISK_SAFETY SIMULATOR shall be profiles of SAFETY and RISK POTENTIAL for each PROCESS SYSTEM and time grid.

There shall be a THRESHOLD SIMULATOR 4 subsystem that would interface with the SCADA software through SCADAMANAGER subsystem and the FLOW DATABASE subsystem.

The threshold SIMULATOR shall perform error analysis and correction and provide correction values of instrument error or drift, computational errors and logical errors to the SAFE MATRIX_PROCESS GER System for proper/actual computation.

The threshold SIMULATOR shall input instrument error or drift from the measured values and provide for correction for these results for RISK_SAFETY to utilize.

The THRESHOLD SIMULATOR shall track and regulate computational errors from the main computational subsystem, RISK_SAFETY system Module and provide for error correction.

The Threshold SIMULATOR shall track and normalize errors from the real time database (hazard MONITOR database) and provide for error correction.

The Threshold SIMULATOR shall generate unifying codes for tracking errors associated with each processing task for each of the code coverage tasks to eliminate the errors introduced.

There shall be a PROCESS GATE system which provides Schematic View of the PROCESS network system in real time and does a preliminary simulation based on new methods developed for such system.

The PROCESS GATE simulator shall provide for the pictorial representation or the graphical display of the PROCESS System network using a form collect data like dimensions, elevation and design pressure. Others are the location of nodes or names representing them, distance between them, values (types and features), sensors, RTUs and the network configuration.

Alternatively there shall also be a Process System configuration wizard, which poses queries and dialogue boxes to completely configure the Process System network system.

The PROCESSGATE SIMULATOR shall provide the PROCESS design Flow Chart and analysis, which is the preliminary stage for computation.

FAULTTRACK (COMPUTATIONAL SUBSYSTEM)

There shall be a FAULTTRACK or COMPUTATIONAL subsystem which is the heart of the FAULTFINDER software, with interfacing inputs from the FLOWMONITOR, FLOWSIMULATOR AND THRESHOLD subsystems responsible for computation and all the algorithms for detecting faults and fault location.

The FAULTTRACK subsystem shall analyze the flow behaviors for steady or unsteady state using the simulation flow chart provided below and decide on the numerical techniques to use.

See FIG. 11 EK.

The FAULTTARCK subsystem shall use the modified Euler method application to model flow for steady state to evaluate V, P, and mass rate.

The FAULTTRACK subsystem shall use the Explicit/Implicit difference method to model flow for unsteady state to evaluate velocity, pressure, mass rate for each space node J and time grid K.

The FAULTTRACK subsystem shall use the Process System Network Analysis algorithm and flowchart below to analyze the complex Process System network to produce the pressure drop and fault profile. (This provides the design for the Process System network system for fault flow analysis).

See FIG. 11EK.

The FAULTTRACK subsystem shall generate a matrix equation relating pressure heads at each node and flow distribution in each Process System node segment.

The FAULTTRACK subsystem shall use the markov chain algorithm configured to handle transient state cause by faulting Process System to analyze each network. This is after the Process System is decomposed into a mesh of networks and analyzed using nodal analysis and Kirchoff's laws.

The FAULTTRACK subsystem shall use the algorithm and flowchart in Appendix D for the analysis of complex Process System network system for actual fault detection.

See FIG. 11EK.

The FAULTTRACK subsystem shall incorporate deterministic criteria based on the theory of LIAPUNOV stability: A system based on LIAPUNOV stability criteria to construct a Stability Matrix Array.

The stability matrix array shall be created or developed for measured (and corrected) values of pressure and velocity for each Process System section.

The eigenvalues of the characteristic deviation matrix shall be and if it is less than −1 for all process times a fault is indicated. If it is +1 a surge is indicated out if it is the normal region of 1 it is a normal condition.

The performance, reliability and decision subsystem within the FAULTTRACK subsystem shall comprise of program codes for checking the certainly of faults in a Process System through profitability and optimization matrix system methods wherein the code coverage database comprises a matrix array of trials fro each test case identified and compared with the present condition. The decision variables are activated/generated through a series of program code to decide on the possibility of faults, inventory loss, and risk assessment, failure and decision modes.

The fault location shall be determined once the DATA particular to the fault characteristics is evaluated. This is calculated by the product of the wave velocity and the instantaneous time for fault detection.

The instantaneous fault time variation shall be determined by deviation in time that has elapsed between the last measurements that indicated no fault to the next measurement that indicated a fault.

Upon evaluation and the determination of fault status, if the Eigen value is less than −1, the system activity monitor shall activate the fault alarm system and printout location of fault. If eigen values are greater than 1 the system activity monitor shall indicate a surge.

Inventory loss shall be evaluated by the difference in input flow and output flow corrected for thresholds. This also represents the size of the fault.

The FAULTFINDER software shall be capable of determining failure modes by studying and comparing fluid dynamic. Failure mode of the type: Corrosion, blowout, sabotage, and accidents.

FAULTFINDER simulator shall solve the flow matrix, stability matrix (where the eigenvalues of the stability function evaluated), the probability and statistical matrix which determine the location of faults in the Process Systems location simulator determines the location of faults in the Process System.

There shall be a software subsystem called SAFETYGATE simulator which shall be responsible for the preliminary safety accidents and assessment of inventory loss.

The SAFETY GATE simulator shall have a real time database (or DATASTORE) that store the following data flows;
Preliminary assessment of inventory loss.
Determine the volume of spill and assess the impact on the environment.
Safety and reliability threshold values.
Time and duration of spill.
Visual rendering of spill situation.
Failure made type, corrosion, blowouts, sabotage.

The SAFETYGATE simulator shall interface or take input from the FAULTTRACKER module and the inventory loss manager subsystem.

The SAFETY GATE simulator shall contain a database of all types of fluid carried by Process Systems, their characteristics, fluid properties, for assessment in the event of a spill.

The SAFETYGATE simulator shall send fault and risk information to the inventory loss manager that dues inventory loss assessment and control. Which determines the magnitude of the fault and accidents?

The SAFETYGATE simulator shall have the ability of transmitting contents of its real time database into a visual simulation of flow, fault and failure condition using high resolution graphics to illustrate.

The Inventory Loss Manager shall be a subcomponent of the SAFETYGATE simulator which takes data measurements from input and output and evaluates the difference in the fault measurements to determine the magnitude of a fault.

The outputs from the Inventory Loss Manager which are the difference in fault measurements inform loss of fluid shall form portion of the inputs to the SAFETYGATE simulator.

There shall be an output and location mode subsystem whose basis function is to trace and locate all faults in the Process System network system.

The output and location mode subsystem shall store all data in the main database subsystem.

The output and location mode subsystem shall format output signals (fault status, fault size, fault location) in a format fit for the different types of hosts (PDA, Phone, Fax, email).

The output and location mode subsystem shall identify the software subsystem for which the persistent code coverage data should be collected; dividing the program source code statements into a plurality of coverage tasks and incorporating the said outputs in the a format fit for the output devices and the database.

The inputs to the “output and location” subsystem shall be the output from the FAULTTRACK simulator.

Typical output from the “output n location mode” subsystem shall be (i) distance of fault (ii) Pinpoint location of fault (iii) Nearest shutdown valve (iv) Initiate Full Bore Rupture

There shall be an ALARM subsystem which is a portion of the content code which would typically be a variety of test cases for different scenarios stored in the master database and when there's a deviation from the norm, an alarm mode code is activated which triggers the audible alarm and writes the scenarios into the master database system.

There shall be a MASTER DATABASE subsystem which is the master database of the Safety software system that stores all the data from the SCADA, analyzed and computed data.

The database subsystem shall interface with and collect data from the following subsystems; the hazard MONITOR database, the FAULTTRACK, computational subsystem, the SAFETYGATE subsystem database (including the inventory loss manager) data from the hazard SIMULATOR and the outputs from the Location Mode simulator.

The Database shall be a relational database management system capable of a advanced search, querying and data retrieval capabilities and arching of data for a period of 1 year (12 months).

The database shall be referred to as the historical database management system and shall interface with real-time database.

The master(or historical) database shall be capable of producing the following results upon query, dynamic data retrieval;

(i) Measured and corrected data from SCADA system (hazard, velocity, pressure, Temperature, Density, flow rate)
(ii) Fluid properties; Density, viscosity, kinematics viscosity, water cut, gas-oil ratio, Heat transfer coefficient composition, thermal conductivity;
(iv) Fault data: Time of fault, cause of spill (corrosion, accidents, blowout, subsystem inventory loss, number of faults, and location of fault.

Others

The software shall be capable of learning about the pipe network and tuning the parameters in order to achieve reliable and sensitive fault defection. This could also be done to make up for instrument drift.

Tuning Parameters

Filter length and threshold values for data validation.

Fault sizes to be detected and the corresponding variance values.

Conditions for detecting Process System transients automatically in setting the operating mode to “steady state”, “medium transient” and ‘large transient”.

The FAULTFINDER software shall have the ability to recognize and display the following type of data faults.

Out of range data

Excessively noisy data

Outliers (sudden increase in the rate of change)

Frozen data (no change at all for a certain time period)

Inconsistent data (One measurement is within a different window from the others)

The software system shall implement batch tracking (discriminating between the different contents of the Process System) by using the average density of the fluid.

The software shall provide the operator, at each scan with an automatic serial number, a log of the times of departure and estimated arrival, estimation of the crude volume delivered, Calculation of the average density estimation of the batch velocity and the current batch position within the Process System.

All the above information (batch tracking) shall be displayed on the Process System mimic window using a set of color displays and a table displaying the numerical values.

There shall be hardcopy and logging facilities provided for batch tracking. On the interface there would be a command button to “PRINT BATCH SCHEDULE’.

FAULTFINDER shall have the ability to store all information gathered and processed in a historical database.

FAULTFINDER shall have present the data in form of an Executive Summary which would be available both online and offline (using the event log file)

Faultfinder shall include the data in the executive summary

Operational status (steady state, small, large transient)

Data faults (stopped, run forward, run reverse)

Alarm status (fault warnings, fault alarms)

Estimated Process System Resistance

Average flow difference after the pressure correction.

A Full Bore Rupture (FBR) shall be initiated automatically after the period of time (say 30 secs) as elapsed for a manual instruction by requisite person.

There shall be a server end and a client end of the Faultfinder Software. The server end would be the back-end software installed on a high performance application server interfacing with the SCADA software and the Database system.

The client end shall be made up of three types of interfaces;

Console Interface or a direct administrative interface installed on a workstation computer. It may be remotely connected to the server

Web or internet Interface which facilitate connection to the server through the Internet. This interface further specifies other security features like encryption algorithms, encrypted passwords, Secure Sockets Layer 7.

PDA or phone interface in XML or J2ME for reporting, querying and limited interface features.

There shall be a facility for the software to send an email or fax message to the user in the event of a fault condition or if any if configured to provide the information at different intervals.

There shall be an algorithm for providing expert information, opinion, advice in the event of certain conditions, consisting of displaying useful information to the client. Identifying alternative paths of control, servicing requests for client interfaces, and cross-referencing user information.

The Faultfinder software shall use network protocols and installed in a LAN where different users with the requite authorization code and access tokens provided according privileges required access the server. System administrators, developers, training control management, etc.

The different classes shall be given different access tokens and rights within the software.

The most privileged user or the administrator shall have super user equivalence on the system and total system rights. He shall have the ability to do the following among others.

Setup different users and passwords on the system with the requisite limited access.

Configure the system for different performance scenarios.

Configure security and access feature for different users.

Perform administrative functions on the system including shutdown, backup and recovery, setup database features.

Schedule maintenance on the system.

The Faultfinder software shall be CONFIGURED according to the number of client access licenses purchased by Faultfinder. For example 2 client access licenses allow a maximum of 2 users to access the system at a time. For 48 Client access license a maximum of 48 users can access the system simultaneously.

There shall be a Test and Training environment that allows the generation of a series of Fault “test patterns” and simulation of the field instruments and SCADA system data.

There shall be a subsystem component software called FAULTSWITCH which is an automated, flow state dependent switching and resetting procedure (program codes) for pumps, PCVs and block valves loading to improvements with pumps settings and threshold settings, flow path changes, start up and shut down procedures.

Performance Requirements

High instrument accuracy

Good repeatability of measurement results

Resolution determines the minimum change an instrument can sense. Also determines the minimum fault detectable by any system based on field measurements.

If the resolution of flow and pressure meters is 0.1% for e.g. It's impossible to use the meters to reflect to fault smaller than 0.1%

Instrument repeatability is critical in determining fault detection reliability, if it's in region to detect a fault of a magnitude equal to or smaller than instrument repeatability, then false alarms will be generated.

The software system shall support 48 simultaneous users on the software providing each with the maximum processing capability without any reduction in system performance.

The Faultfinder software shall be capable of displaying and transmitting graphics, text and related information to different users.

The Faultfinder Software shall be capable of detecting and locating a fault in less than 60 seconds overall time.

Any interface between the user and the automated system shall have a maximum response time of 2 seconds.

The Faultfinder software shall poll the SCADA software every two seconds to get new data.

All measured data shall be accurate to 2 decimal places.

The response of the system shall be fast enough to avoid interrupting the users' flow of thought.

Response to queries shall take no longer than 7 seconds to load on to the screen after the user submits the query.

The system shall display confirmation messages to users within 4 seconds after the user submits information to the system.

The fault detection software shall be capable of detecting fault size of 1% in an average detection of 60 seconds; bigger faults (50%) shall be detected in about 20 seconds.

Logical Database Requirements

The following are the various functions that generate data within the system.

Process Monitor database (real time) functionsρ, m, P, T, V.

Fault Track Computations KL, Fault Location, Fault Size,

Threshold Values stored in the database

Spill gate Historical data

Fault Simulator Process System data, dimensions

The software shall have the ability to maneuver through historical, current and projected data thus giving the user the power to foresee the problems that might occur in future.

Information changes through time shall have the ability to be accesses, reviewed, and distributed.

Design Constraints

Design network architecture to ISO OSI 7 Layer architecture

Software quality must meet SEI CMM Level 5 standards

The software shall conform to statutory and legislative requirements

Software System Attributes

3.7.1 Reliability

The software product shall be able to transmit fault location, size and proposed action within 60 seconds of computation.

The software shall monitor the Process System network in real time passing useful information to the users within 120 seconds of the occurrence of a fault and automatically shutting the valves within the next 60 seconds if it receives no other commands.

Availability

The product shall available 24 hrs per day 365 days per year.

The products shall achieve 99% uptime and availability under all operating conditions.

The product shall have the ability of the stopping and restarting a process or service without rebooting the whole system and put it offline.

Robustness

The software shall have the ability to continue to work if the Process System experiences operational changes e.g. throughput changes, pigging.

The software shall continue to operate in an offline mode even after loosing link to the SCADA system.

The software shall continue to operate and detect faults after instrument errors have been detected.

Security

Only the system administrator shall have overall access to the system.

When accessing the data over the web, there shall be an encryption algorithm or through VPN there shall be secure sockets layer 7

There shall be access tokens for the different classes of users giving rights to view, modify, and configure settings according to permissions on the access tokens.

All the passwords for access sent over the web, or through the network shall be encrypted and authenticated before authorization is given.

Users shall be required to log into the system for all system operations with the event log showing all the users online.

Only users who have been authorized to access the software over the web or PDA shall be allowed to do so.

Maintainability

The software shall be able to be maintained by its end users fully trained for the purpose.

There shall be enough documentation for system administrators to be able to use the product.

Every registered user shall have access tour help site via the Internet.

Human Errors in Implementing Safety Programs.

This INVENTION teaches on new methods for human errors in complex risk analysis for implementing safety management programs of FPSO (Floating Production Storage and Offloading) systems. The method combines neural networks and weight fuzzy hazard data array sets generated from Monte-Carlo Simulations to provide minimum safety designs for hazards, risk, availability, reliability and consequences constrain within a Bow-Tie systems Tableau. Floating installations in general and FPSO systems in particular, combine traditional process technology with marine systems, and are thus quite dependent on operational safety control. A Bow Tie system design incorporating hazard register, causes, threat, safeguards, release or loss in containment, mitigation-recovery and consequence should provide the risk solution to the problem. The paper briefly reviews the safety characteristics and records for FPSOs, focusing on operational safety aspects. The main benefit of the paper is that it introduces numerical quantification using fuzzy reasoning and modified weights index for safety modeling that relies on data based on qualitative descriptions of the risk and safety aspects. Our methods use neural programming and fuzzy based statistical modeling to provide a risk and safety simulation sequence in virtual database architecture. The simulation results were studied and qualified for typical FPSO systems, where weights were assigned to different risk systems. Risk

Step 2.1 Human Hazard

Human Risk Systems are those components of risk that are the direct or indirect input of human error, such as design, operational oversight, improper training or sabotage:
Human Operator acting wrongly.
Fail to apply the Correct Procedures.
Indulgence and Negligence.
Human errors are of Seven Types.
Design Errors.
Operators Error.
Fabrication Error.
Maintenance Error.
Inspection Error.
Contributory Error.
Handling Error.

Causes of Human Error are:

### 1. Poor Training or Skill

2. Poorly documented or Lack of Documented and Updated Operational Procedures

### 3. Environmental Factors and Occupational Safety

### 4. Poor Incentives by Management

### 5. Negligence and Organizational Attitudes

Several Hazard Data of Human Errors can be generated

### Empirically Based Data Banks

### Field Based Data Banks

Statistically Generated Data Banks from Methods

A model for Human Reliability is presented below:

$$P ( \frac{{E}_{2}}{{E}_{1}} ) = e ( t ) δ t \qquad ( 110 )$$

$$P ( \frac{{E}_{2}}{{E}_{1}} ) is the probability of occurrence of human Error \qquad ( 111 )$$

e(t) is the human error rate at time t; this is analogous to the hazard rate λ(t) in the classical reliability theory

E1=An errorless performance event of duration t

E2=An event that the human error will occur in time interval (t,t+δt)

A general expression of human error can thus be derived

$$\begin{matrix}\frac{d {R}_{h}}{d t} = - e ( t ) {R}_{h} ( t ) & ( 112 ) \\ {R}_{h} ( t ) = exp ( - {\int }_{0}^{t} e ( t ) d t ) & ( 113 )\end{matrix}$$

The Following Terms apply to human reliability modeling
Mean Time to Human Initiated Failure (MTHIF) analogous to MTTF (Mean Time to Failure) in classical Reliability Modeling
Mean Time to First Human Error (MTFHR)
Mean Time between Human Errors (MTBHE)

The following data are required in human reliability modeling

Times to First Miss Error
Times to False Alarm Error

Combined Miss and False Alarm Error

The Weibull, gamma and Log-Normal Density functions Emerged as Representative Probability Function. However a modified risk equation is introduced that incorporates weights into human reliability modeling that represents the critical safety elements that may prevent human failure. Weights have been previously described in the Abhulimen publication.

$$\begin{matrix}{R}_{h} ( t ) = exp ( - {\int }_{0}^{t} ω ( t ) e ( t ) d t ) & ( 114 ) \\ {ω}_{i} ( t ) = ( 1 - {SRF}_{i} ) {( \frac{t}{{η}_{i}} )}^{{β}_{i} - 1} \\ Where \text{:} & ( 115 )\end{matrix}$$

The weight index value can be computed from the user's experience of the system. This must require empirical data that allows the evaluation of β, η, Ki and αᵢ over time. An empirical approach which linearizes failure (hazard rate) model and use regression analysis in determining the weight variables specific to the system using adequate historical failure data may be explored. However historical data are not always available especially for new process system design. It is therefore important to develop risk methods especially for new designs and operations in particular environment based on failure data and risk methods that uses weight index that skews Monte Carlo failure data generated randomly to their actual values.

The Human Error Prediction Methods has the following Elements

List the main System Failure Events

List and analyzed human related functions

Obtain estimates for human error rates

Evaluate Human Error Effects on System Failure Events

Update Recommendation on the Human Hazard Chain Systems and Compute new Failure Rates.

Success for human Reliability Analysis or Failure of each critical human action or associated event is assigned a conditional probability

$$f ( F \vert {d}_{1} , {d}_{2} , {d}_{3} … {d}_{n} ) = \frac{f ( {d}_{1} \vert F ) , f ( {d}_{2} \vert F ) … f ( {d}_{n} \vert F ) , f ( F )}{f ( {d}_{1} , {d}_{2} … {d}_{n} )} \qquad ( 116 )$$

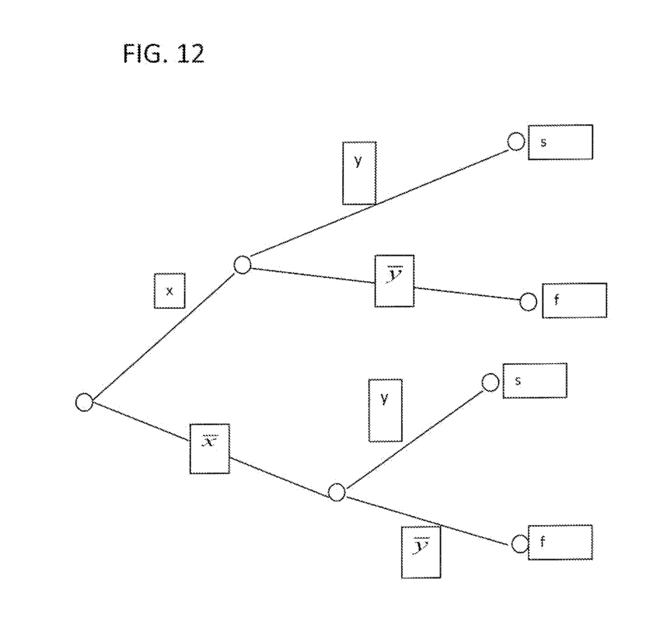

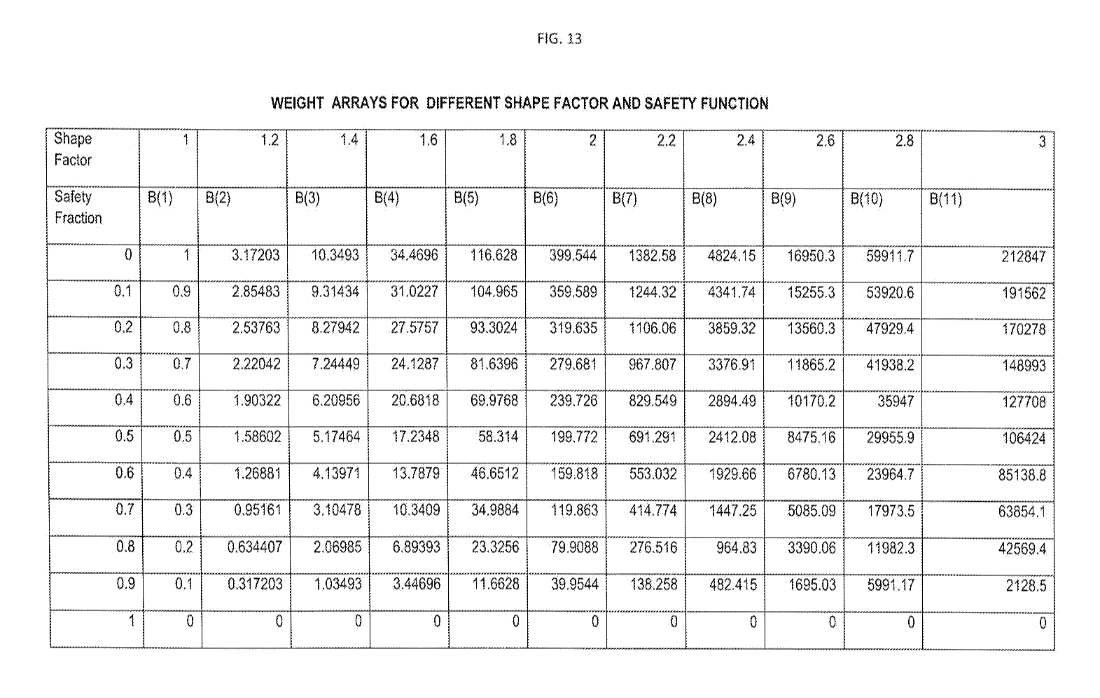

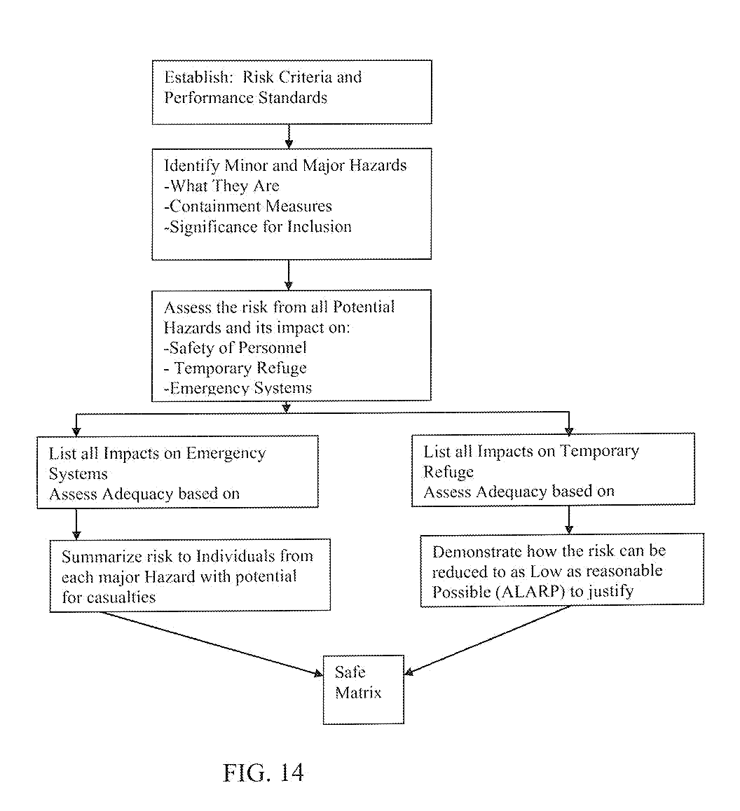

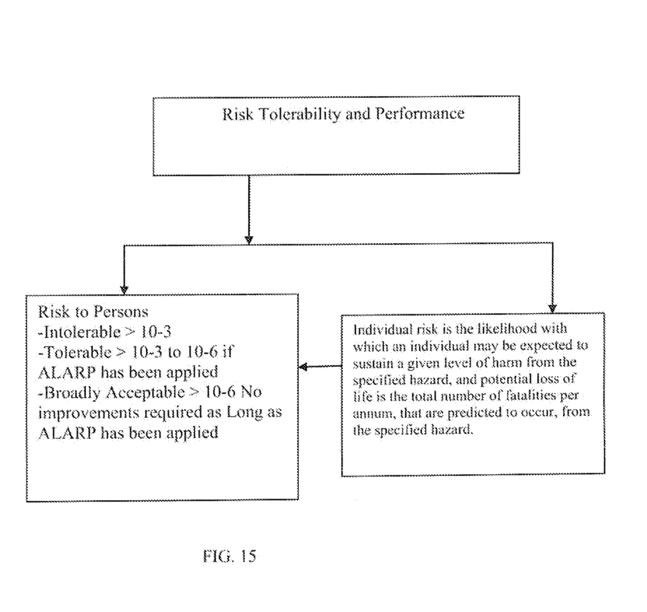

The outcome of each event is represented by the branching limbs of a probability tree as shown in FIG. 12. The total probability for success is obtained by summing up the associated probabilities with the end point of the success path through the probability diagram. The probability captures the human neural network chain combining effects of time stress hazards, emotional stress hazards, interaction stress hazards, interaction effects, organizational and management factors and equipment failures. This data is presented below in Table 2 and in FIG. 13. See also FIGS. 14 and 15.

TABLE 2

| | Monte Carlo Simulation Run | | | |
|---|---|---|---|---|
| Fuzzy Class 0 | Fuzzy Class 1 | Fuzzy Class 2 | Fuzzy Class 3 | Fuzzy Class 4 |
| 5.015083536 | 0.553484076 | 0.005001795 | 5.03453E−05 | 4.98778E−07 |
| 5.0210793 | 0.55819086 | 0.005119803 | 4.95231E−05 | 5.0594E−07 |
| 5.1070244 | 0.571746946 | 0.005072496 | 4.92122E−05 | 5.026E−07 |
| 4.91708601 | 0.573379876 | 0.004860656 | 5.12732E−05 | 4.98788E−07 |
| 5.0393886 | 0.545151794 | 0.005050006 | 5.121E−05 | 5.02835E−07 |
| 4.9054201 | 0.551882114 | 0.00490009 | 5.01262E−05 | 4.86999E−07 |
| 4.9784898 | 0.554206458 | 0.004902356 | 5.08155E−05 | 5.1988E−07 |
| 5.0576222 | 0.5591632 | 0.005023855 | 4.84144E−05 | 5.03338E−07 |
| 5.0113767 | 0.545269751 | 0.004992223 | 5.2992E−05 | 4.86682E−07 |
| 4.9814163 | 0.532836585 | 0.004917225 | 5.06388E−05 | 4.99318E−07 |
| 4.9784545 | 0.545304031 | 0.005027569 | 5.08686E−05 | 4.84552E−07 |
| 5.16856099 | 0.551193224 | 0.005153466 | 4.87244E−05 | 4.95624E−07 |

Some of the important safety design measures include:

Jacketed, passive fire protection applied to riser end connectors and FPU boarding emergency shutdown (ESD) valves to limit the potential for riser-fire escalation in the turret.

An upgraded cargo-tank vents system to limit the potential for explosive and toxic gas atmospheres on the process and main deck levels.

Upgraded fire suppression for machinery spaces, from CO2 to a breathable, non-ozone depleting extinguishing agent, to protect personnel from potential asphyxiation.

Installation of shuttle-tanker position alarms to alert operators of potential drive-off incidents.

Upgraded load-shedding and power-management systems to improve the reliability of thrusters.

Installation of subsea pipeline shielding and trenching of the gas-injection riser and flow line to limit the potential for dropped object damage or snagging.

Risk analysis showed that the process risk scenario with the highest contribution to potential loss of life (PLL) rates, along with potential impacts to the temporary refuge and evacuation by lifeboat, is turret-connector deck fires and explosions. FPU turret-connector deck is an open design, but the equipment density is high. The deck contains 18 riser end connections and ESD valves along with production, test, gas lift, and gas-injection manifold piping and valves, all located in close proximity to one another. Jet-fire flame-length calculations indicated that impingement on adjacent equipment is nearly certain in all fire size cases considered, and as such, the potential for escalation is significant. Leak-duration calculations showed that even with successful isolation and blow down of the system, leaks with potential to impact adjacent equipment would last on the order of 20 minutes, which is long enough for a fire to escalate. In cases when blow down was assumed to fail, the leak duration was found to be on the order of 60 minutes. To effectively reduce the possibility of escalation while maintaining the capability to inspect and maintain the riser end fittings and ESD valves, jacketed, passive fire protection (rated for 60 minutes of exposure to jet fire) was installed. The required offshore manning levels based upon analysis of work activities and a review of similar activities aimed at achieving availability

Marine hazards are diverse in nature; and can be defined as any potential accident on an offshore installation connected with its interface with the marine environment.

They include:

Loss of position keeping (e.g. mooring, dynamic positioning, rig move)

Loss of structural integrity (e.g. hull, ballast tank, support structure failure)

Loss of stability (e.g. ballast system failure, cargo loads)

Loss of marine/utility systems (e.g. propulsion, power generation, hydraulics)

Collision (e.g. shuttle tanker, support vessel, passing vessel)

3.0 Defining Limits of Safety

The vector field F(x) of the whole phase portrait for all individual functions f(x) at the designated nodes is described by the matrix. In difference form, the concept has evolved into th model as presented in equation 15

$$\begin{matrix}{Φ}_{1 i + 1} = {F}_{1} [ {Φ}_{1 i} , {Φ}_{2 i} … {Φ}_{ni} ] & ( 117 ) \\ {Φ}_{2 i + 1} = {F}_{2} [ {Φ}_{1 i} , {Φ}_{2 i} … {Φ}_{ni} ] & ( 118 ) \\ {Φ}_{ni + 1} = {F}_{n} [ {Φ}_{1 i} , {Φ}_{2 i} … {Φ}_{ni} ] & ( 119 )\end{matrix}$$

The Liapunov Stability Criterion can further allow the definition of a Safe Matrix model presented in equation

$$\begin{matrix}[ \begin{matrix}{ξ}_{1 i + 1} \\ {ξ}_{2 i + 1} \\ ⋮ \\ ⋮ \\ {ξ}_{ni + 1}\end{matrix} ] = J [ \begin{matrix}{ξ}_{1 i} \\ {ξ}_{2 i} \\ ⋮ \\ ⋮ \\ {ξ}_{ni}\end{matrix} ] \\ Where & ( 120 ) \\ J = ( \begin{matrix}{[ \frac{\partial {F}_{1}}{\partial {Φ}_{1}} ]}_{i} , & {[ \frac{\partial {F}_{1}}{\partial {Φ}_{2}} ]}_{i} & … & {[ \frac{\partial {F}_{1}}{\partial {Φ}_{n}} ]}_{i} \\ {[ \frac{\partial {F}_{2}}{\partial {Φ}_{1}} ]}_{i} , & {[ \frac{\partial {F}_{2}}{\partial {Φ}_{2}} ]}_{i} & … & {[ \frac{\partial {F}_{2}}{\partial {Φ}_{n}} ]}_{i} \\ … & … & … & … \\ {[ \frac{\partial {F}_{n}}{\partial {Φ}_{1}} ]}_{i} , & {[ \frac{\partial {F}_{n}}{\partial {Φ}_{2}} ]}_{i} & … & {[ \frac{\partial {F}_{n}}{\partial {Φ}_{n}} ]}_{i}\end{matrix} ) & ( 121 )\end{matrix}$$

Where the deviation of intrinsic property is given by

$$\begin{matrix}{ξ}_{ni} = {Φ}_{ni + 1} - {Φ}_{ni} \\ ζ i + 1 j = H Ω ij , wherein , & ( 122 ) \\ Ω ij = [ \begin{matrix}{ξ}_{ij} \\ {η}_{ij} \\ {γ}_{ij}\end{matrix} ] ζ i + 1 j = [ \begin{matrix}ξ i + 1 j \\ η i + 1 j \\ γ i + 1 j\end{matrix} ] & ( 123 )\end{matrix}$$

ζi+1j Risk Matrix Vector at particular time i and position j and Ωi j, is the Risk Matrix Vector at an advanced time i+1, H=J is the Safety Deviation or Matrix of Safety and J is the Safety Deviation of Safety from a stable point as follows:

$$J = \frac{\partial ( {F}_{1} {F}_{2} {F}_{3} {F}_{4} {F}_{5} )}{\partial ( r , R , A , λ , S )} \qquad ( 124 )$$

F1 is the Function associated with risk of the Process System, F2 is the Function associated with Reliability of the process under test, F3 is the Function associated with weights that each Process System carried in a given environment at a given time, F4 is the Function associated with hazard rate of the process system, F5 is the Function associated with Safety of the Process System.

$$J = [ \begin{matrix}\frac{\partial {F}_{1 j}}{\partial {r}_{ij}} & \frac{\partial {F}_{1 j}}{\partial {R}_{ij}} & \frac{\partial {F}_{1 j}}{\partial {A}_{ij}} & \frac{\partial {F}_{1 j}}{\partial {λ}_{ij}} & \frac{\partial {F}_{1 j}}{\partial {S}_{ij}} \\ \frac{\partial {F}_{2 j}}{\partial {r}_{ij}} & \frac{\partial {F}_{2 j}}{\partial {R}_{ij}} & \frac{\partial {F}_{2 j}}{\partial {A}_{ij}} & \frac{\partial {F}_{2 j}}{\partial {λ}_{ij}} & \frac{\partial {F}_{2 j}}{\partial {S}_{ij}} \\ \frac{\partial {F}_{3 j}}{\partial {r}_{ij}} & \frac{\partial {F}_{3 j}}{\partial {R}_{ij}} & \frac{\partial {F}_{3 j}}{\partial {A}_{ij}} & \frac{\partial {F}_{3 j}}{\partial {λ}_{ij}} & \frac{\partial {F}_{3 j}}{\partial {S}_{ij}} \\ \frac{\partial {F}_{4 j}}{\partial {r}_{ij}} & \frac{\partial {F}_{4 j}}{\partial {R}_{ij}} & \frac{\partial {F}_{4 j}}{\partial {A}_{ij}} & \frac{\partial {F}_{4 j}}{\partial {λ}_{ij}} & \frac{\partial {F}_{4 j}}{\partial {S}_{ij}} \\ \frac{\partial {F}_{5 j}}{\partial {r}_{ij}} & \frac{\partial {F}_{5 j}}{\partial {R}_{ij}} & \frac{\partial {F}_{5 j}}{\partial {A}_{ij}} & \frac{\partial {F}_{5 j}}{\partial {λ}_{ij}} & \frac{\partial {F}_{5 j}}{\partial {S}_{ij}}\end{matrix} ] \qquad ( 125 )$$

i=time element j=component under consideration working as a network to other components

Computing J is a complex interactive logical task, with understanding of the combined mathematics of finite difference scheme and analysis of the fuzzy logic sets. Also evaluating the differential Function F1, F2, F3, of J (Safety Deviation Matrix) requires an understanding of finite difference schemes and knowledge of inherent matrix analysis combined with a theory that establishes the basis of dependency and independency of functions with respect to independent variable set. J is the safety matrix function which is tells operators the Limits of Safety, such that if J is 1 in absolute terms, the safety system is optimal. This criterion can be an important benchmark for developing good safety management system. Any factor that tends to push safety function above or below absolute 1 should be minimized. This methods for determining safety is not available in previous method for safety analysis. The standard deviation of the eigenvalue above gives a numerical value of the threshold risk factor.

$$\begin{matrix}SD ( {λ}_{1 ij} ) = \sqrt{{\sum }_{i = 0}^{n} \frac{{( \vert {λ}_{1 ij} \vert - 1 )}^{2}}{( n - 1 )}} & ( 24 ) \\ SD ( {λ}_{2 ij} ) = \sqrt{{\sum }_{i = 0}^{n} \frac{{( \vert {λ}_{2 ij} \vert - 1 )}^{2}}{( n - 1 )}} & ( 25 ) \\ SD ( {λ}_{3 ij} ) = \sqrt{{\sum }_{i = 0}^{n} \frac{{( \vert {λ}_{3 ij} \vert - 1 )}^{2}}{( n - 1 )}} & ( 126 )\end{matrix}$$

wherein a standard deviation close to zero indicates a small leak, and as the standard deviation increases a larger leak is indicated, and wherein |λ₁ᵢⱼ|, |λ₂ᵢⱼ|, |λ₃ᵢⱼ| respectively represent an absolute eigenvalue of risk, reliability, weights, hazard rate and safety at a particular time and pipeline node point. The FPSO-Pipeline system under study exhibits several levels of failure or safety. The risk or safety systems are defined in terms of subsets X⁺, which contained a specific number of system states. The subset defines an event or particular mode of failure at various modes all suitable defining elements of X⁺. The probability of X+ is:

$${P}_{+} = {\sum }_{i ∈ {X}^{+}} {P}_{i} \qquad ( 127 )$$

Application of method to Operating FPSO-Flow line Riser Pipeline System

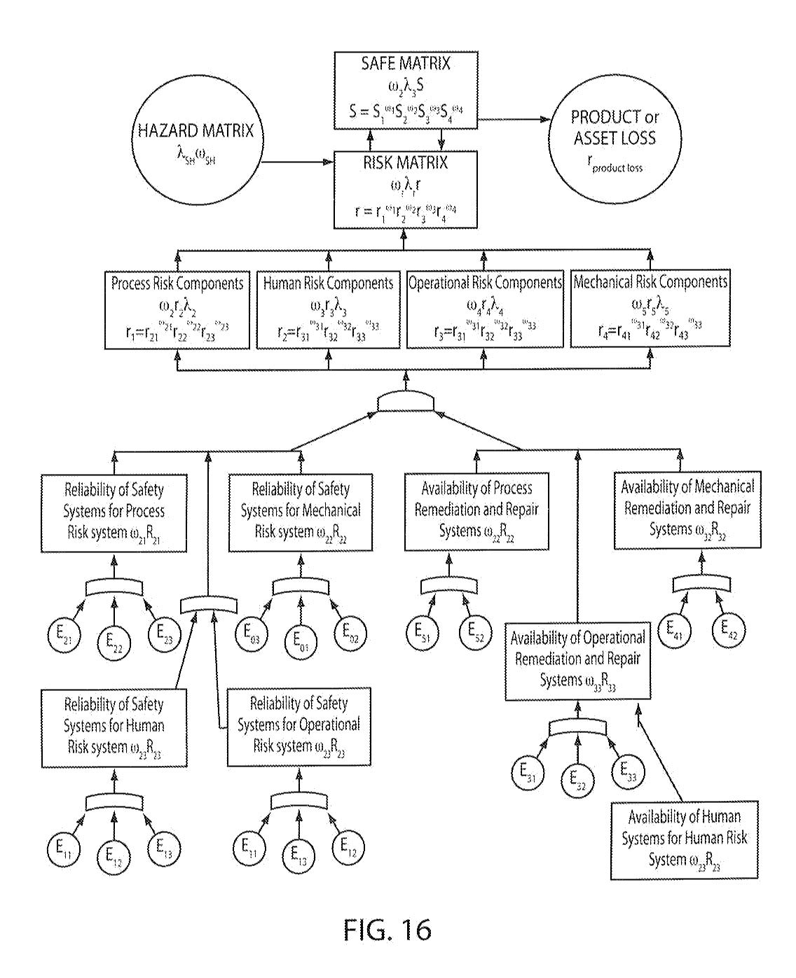

A typical application of our model to flow line riser system is proposed as shown in FIG. 16. Typically the main Production Flow lines transports fluids from producing wells to the FPSO. The maximum pressure for a typical FPSO facility is the closed in tubing head pressure in wells (approximately 5000 psi). The flow line transports produced fluids from the manifold to the FPSO- with an inlet separator pressure of 10 bars, downstream of the surface choke. Risers connect the flow lines to the FPSO system consisting of (1) The production jumpers from wells to manifold (2) The water injection jumpers from wells to manifold (3) The gas injection jumpers from wells to manifold (4) The main production flow lines (5) The main water injection flow lines (6) The main gas injection flow lines

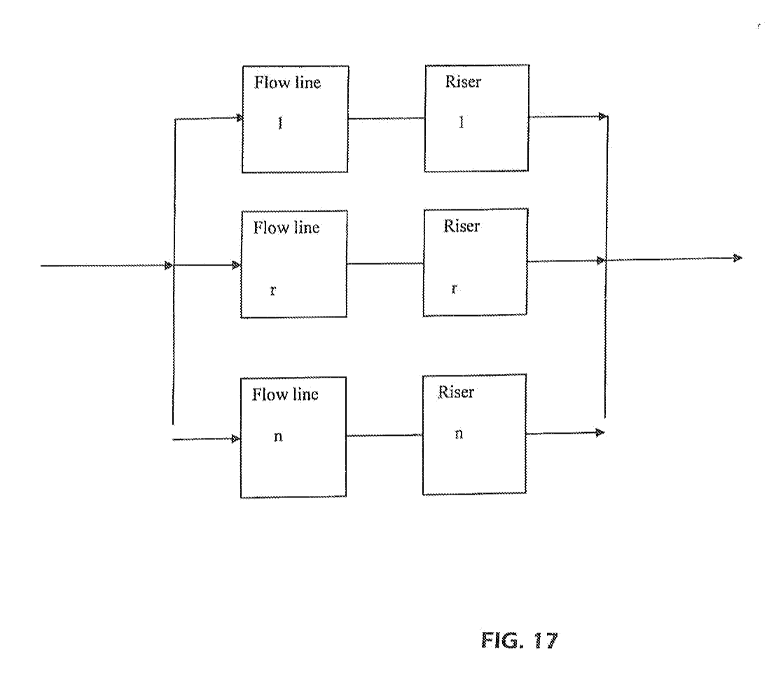

FIG. 17: A typical configuration of RBD (Reliability Block Diagram) of a Riser-Flow line system. The configuration has the flow line in series with riser line, and a flow line-riser system in parallel with the remaining (n-1) flow line-riser system.

Transition Probabilistic Analysis

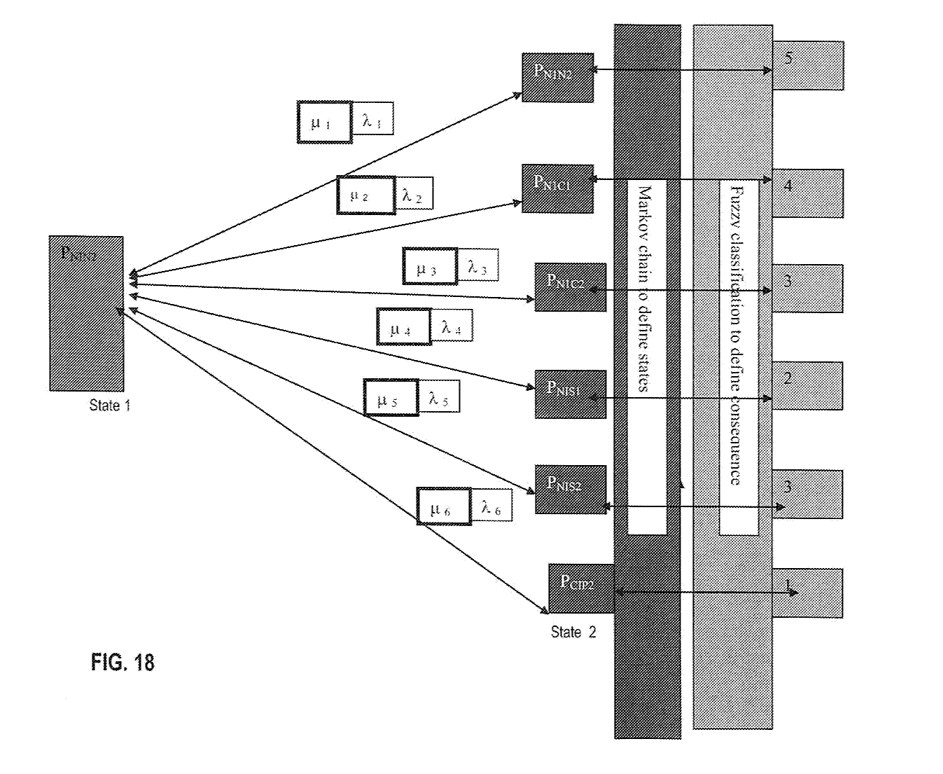

FIG. 18 shows a Transient diagram for FPSO—Riser-Flow line System.

The underlying assumptions used to evolve the transition tree are that the repaired system is as good as new and that failures are statistically independent. Also we further assume that the repair and failure rates are constant. The possible transition states for the above system are presented below:

Normal State

Failed state by common causes Type 1 (repairable)

Failed state when safety systems fail Type 2

Failed state due to catastrophic or undetected causes (irreparable)

Failed state due to inductive chain effect, i.e. failure in flow line leading to failure in riser

Let us take a hypothetical case where, there are no catastrophic, undetected, or inductive failures. The possible states for a flow line-riser configuration are: Let common causes C1, C2 be failure modes common to flow-line riser systems fall under process, mechanical, operational, human hazards. (e.g. mechanical and structural related failures, design flaws, leaks, corrosion, operational hazards, fire, human, operational-pigging lines, repairs flaws, flow lines and risers process failure, hydrates, underwater sea current, dynamic loading on risers, leakage spills, wax formation) in state 1 and state 2 respectively and P1,P2 failure results from faulty safety devices such as (safety valve malfunction, relief valve failures, safety devices controls and barriers fail) in state 1 and state 2 respectively, N1,N2, be normal unfailed mode in state 1 and state 2 respectively

The transition matrix for a single flow line-riser system is given by equation (28)

$$[ \begin{matrix}( s + {λ}_{1} + {λ}_{2} + … + {λ}_{6} ) & - {μ}_{2} & - {μ}_{3} & - {μ}_{4} & - {μ}_{5} & {μ}_{6} \\ - {λ}_{2} & ( s + {μ}_{2} ) & 0 & 0 & 0 & 0 \\ - {λ}_{3} & 0 & ( s + {μ}_{3} ) & 0 & 0 & 0 \\ - {λ}_{4} & 0 & 0 & ( s + {μ}_{4} ) & 0 & 0 \\ - {λ}_{5} & 0 & 0 & 0 & ( s + {μ}_{5} ) & 0 \\ - {λ}_{6} & 0 & 0 & 0 & 0 & ( s + μ6 )\end{matrix} ] \\ [ \begin{matrix}{P}_{N 1 N 2} \\ {P}_{N 1 C 1} \\ {P}_{N 1 C 2} \\ {P}_{N 1 S 1} \\ {P}_{N 1 S 2} \\ { }_{PN 1 P 1}\end{matrix} ] = [ \begin{matrix}1 \\ 0 \\ 0 \\ 0 \\ 0 \\ 0\end{matrix} ] \qquad ( 128 )$$

The solution to the above matrix system of equations is solved by Cramer's rule and the inverse transform is presented in equation (129)-(133)

$$\begin{matrix} {P}_{N 1 N 2} = \frac{{e}^{- {a}_{1} t}}{Δ} & ( 129 ) \\ {P}_{N 1 C 1} = \frac{( \frac{{λ}_{2}}{{a}_{1} - {μ}_{2}} ) ( {e}^{- {a}_{1} t} - {e}^{- {μ}_{2} t} )}{Δ} & ( 130 ) \\ {P}_{N 1 C 2} = \frac{( \frac{{λ}_{3}}{{a}_{1} - {μ}_{3}} ) ( {e}^{- {a}_{1} t} - {e}^{- {μ}_{3} t} )}{Δ} & ( 131 ) \\ {P}_{N 1 S 1} = \frac{( \frac{{λ}_{4}}{{a}_{1} - {μ}_{4}} ) ( {e}^{- {a}_{1} t} - {e}^{- {μ}_{4} t} )}{Δ} & ( 132 ) \\ {P}_{N 1 S 2} = \frac{( \frac{{λ}_{5}}{{a}_{1} - {μ}_{5}} ) ( {e}^{- {a}_{5} t} - {e}^{- {μ}_{5} t} )}{Δ} & ( 133 ) \\ {P}_{N 1 P 2} = \frac{( \frac{λ6}{{a}_{1} - {μ}_{6}} ) ( {e}^{- {a}_{6} t} - {e}^{- {μ}_{6} t} )}{Δ} & ( 134 ) \\ where Δ = ( 1 - ( \frac{{μ}_{2} {λ}_{2}}{( {a}_{1} - {μ}_{2} )} ( {e}^{- {a}_{1} t} - {e}^{- {μ}_{2} t} ) + ( \frac{{μ}_{3} {λ}_{3}}{{a}_{1} - {μ}_{3}} ) ( {e}^{- {a}_{1} t} - {e}^{- {μ}_{3} t} ) + ( \frac{{μ}_{4} {λ}_{4}}{{a}_{1} - {μ}_{4}} ) ( {e}^{- {a}_{1} t} - {e}^{- {μ}_{4} t} ) + ( \frac{{μ}_{5} {λ}_{5}}{{a}_{1} - {μ}_{5}} ) ( {e}^{- {a}_{1} t} - {e}^{- {μ}_{5} t} ) + ( \frac{{μ}_{6} {λ}_{6}}{{a}_{1} - {μ}_{6}} ) ( {e}^{- {a}_{1} t} - {e}^{- {μ}_{6} t} ) ) \\ \\ and & ( 135 ) \\ {a}_{1} = {λ}_{1} + {λ}_{2} + {λ}_{3} + {λ}_{4} + {λ}_{5} + {λ}_{6} & ( 136 )\end{matrix}$$

Using a weight superstructure model: Equation 12-is rewritten:

$$[ \begin{matrix}( s + {w}_{1} {λ}_{1} + {w}_{2} {λ}_{2} + … + {w}_{6} {λ}_{6} ) & - {w}_{2} {μ}_{2} & - {w}_{3} {μ}_{3} & - {w}_{4} {μ}_{4} & - {w}_{5} {μ}_{5} & - {w}_{6} {μ}_{6} \\ - {w}_{2} {λ}_{2} & ( s + {w}_{2} {μ}_{2} ) & 0 & 0 & 0 & 0 \\ - {w}_{3} {λ}_{3} & 0 & ( s + {w}_{3} {μ}_{3} ) & 0 & 0 & 0 \\ - {w}_{4} {λ}_{4} & 0 & 0 & ( s + {w}_{4} {μ}_{4} ) & 0 & 0 \\ - {w}_{5} {λ}_{5} & 0 & 0 & 0 & ( s + {w}_{5} {μ}_{5} ) & 0 \\ - {w}_{6} {λ}_{6} & 0 & 0 & 0 & 0 & ( s + {w}_{6} μ6 )\end{matrix} ] \\ [ \begin{matrix}{P}_{N 1 N 2} \\ {P}_{P 1 N 2} \\ {P}_{C 1 N 2} \\ {P}_{N 1 C 1} \\ {P}_{N 1 P 1} \\ {P}_{C 1 N 1}\end{matrix} ] [ \begin{matrix}1 \\ 0 \\ 0 \\ 0 \\ 0 \\ 0\end{matrix} ] \qquad ( 137 )$$

The solution to the above matrix system of equations is solved by Cramer's rule and the inverse transform is presented in equation (38)-(43)

$$\begin{matrix}{P}_{N 1 N 2} = \frac{{e}^{- {a}_{1} t}}{Δ} & ( 138 ) \\ {P}_{P 1 N 2} = \frac{( \frac{{λ}_{2}}{{a}_{1} - {μ}_{2}} ) ( {e}^{{a}_{1} t} - {e}^{- {μ}_{2} t} )}{Δ} & ( 139 ) \\ {P}_{C 1 N 2} = \frac{( \frac{{w}_{3} {λ}_{3}}{{a}_{1} - {w}_{3} {μ}_{3}} ) ( {e}^{- {a}_{1} t} - {e}^{- {w}_{3} {μ}_{3} t} )}{Δ} & ( 140 ) \\ {P}_{N 1 C 2} = ( \frac{{λ}_{4}}{{a}_{1} - {w}_{4} {μ}_{4}} ) ( {e}^{- {a}_{1} t} - {e}^{- {w}_{4} {μ}_{4} t} ) & ( 141 ) \\ {P}_{N1P 2} = \frac{( \frac{{λ}_{5}}{{a}_{1} - {w}_{5} {μ}_{5}} ) ( {e}^{- {a}_{5} t} - {e}^{- {w}_{5} {μ}_{5} t} )}{Δ} & ( 142 ) \\ {P}_{C 1 P 2} = \frac{( \frac{λ6}{{a}_{1} - {w}_{6} {μ}_{6}} ) ( {e}^{- {a}_{6} t} - {e}^{- {w}_{6} {μ}_{6} t} )}{Δ} & ( 143 ) \\ where Δ = ( 1 - ( \frac{{w}_{2} {μ}_{2} {λ}_{2}}{( {a}_{1} - {w}_{2} {μ}_{2} )} ( {e}^{- {a}_{1} t} - {e}^{- {w}_{2} {μ}_{2} t} ) + ( \frac{{w}_{3} {μ}_{3} {λ}_{3}}{{a}_{1} - {w}_{3} {μ}_{3}} ) ( {e}^{- {a}_{1} t} - {e}^{- {w}_{2} {μ}_{3} t} ) + ( \frac{{w}_{4} {μ}_{4} {λ}_{4}}{{a}_{1} - {w}_{4} {μ}_{4}} ) ( {e}^{- {a}_{1} t} - {e}^{- {w}_{4} {μ}_{4} t} ) + ( \frac{{w}_{5} {μ}_{5} {λ}_{5}}{{a}_{1} - {w}_{5} {μ}_{5}} ) ( {e}^{- {a}_{1} t} - {e}^{- {w}_{5} {μ}_{5} t} ) + ( \frac{{w}_{6} {μ}_{6} {λ}_{6}}{{a}_{1} - {w}_{6} {μ}_{6}} ) ( {e}^{- {a}_{1} t} - {e}^{- {w}_{6} {μ}_{6} t} ) ) & ( 144 ) \\ and {a}_{1} = {w}_{1} {λ}_{1} + {w}_{2} {λ}_{2} + {w}_{3} {λ}_{3} + {w}_{4} {λ}_{4} + {w}_{5} {λ}_{5} + {w}_{6} {λ}_{6} & ( 145 )\end{matrix}$$

P_{N1 N2}=Probability that the flow line and connecting riser in the normal transition state N1 with the associated repair (μ₁) and hazard rate (λ₁) would be in the normal transition state N2

P_{C1 N2}=Probability that the flow line and connecting riser in a failed operating state C1 caused by common causes with the associated repair (μ₂) and hazard rate (λ₂) would return to the Normal Transition State.

PP1C2=Probability that the flow line and connecting riser be in the failed state due to Inherent Safety Flaws with the associated repair (μ₃) and hazard rate (λ₃) would lead to Failure by Common Causes C1

P_{N1C2}=Probability that the flow line and connecting riser in the normal transition State with associated repair (μ₄) and hazard rate (μ₄) would be transit to a Failed State by Common Causes

P_{N1 P2}=Probability that the flow line would be and the riser in the normal transition state would be in the failed state due to Inherent safety systems failure with associated repair (μ₅) and hazard rate (λ₅).

P_{C1P2}=Probability that the flow line and riser in failed state due to common causes would inevitably lead to inherent safety systems failure if the associated repair (μ₆) and hazard rate (λ₆).

The solution of equation (45) gives the transition states for common failures of Type 2 and failure of safety devices. The solution of equation (5) gives the transition states for common failures of Type 2, which is failure of safety devices.

Table showing transition matrix is presented below

TABLE 3.

| | Transition States | P_{N1N2} | P_{C1N2} | P_{P1C2} | P_{N1C2} | P_{N1P2} | P_{C1P2} |
|---|---|---|---|---|---|---|---|
| 0 | P_{N1N2} | | | | | | |
| 1 | P_{C1N2} | | | | | | |
| 2 | P_{P1C2} | | | | | | |
| 3 | P_{N1C2} | | | | | | |
| 4 | P_{N1P2} | | | | | | |
| 5 | P_{C1P2} | | | | | | |
| | | 0 | 1 | 2 | 3 | 4 | 5 |

5.0 Analysis/Presentation of Results

A computer program was developed to simulate a set of random results. By Monte Carlo simulation, these results can be fitted into a real data. The risk and safety potential of a typical 10-riser-flow line production system evaluated by the computer program, is presented in FIG. 5 to FIG. 10. The hazard rates for the transition states were obtained from data set for assume repair rates of |μ₁=μ₂=μ₃=1| and (μ₁=1<μ₂=2<μ₃=3) for 80% availability. Once the repair and hazard rates for the transition states are known, the probability transition states (P_{N1N2}, P_{N1C1}, and P_{N1P1}) can be evaluated.

FIG. 5 to FIG. 8 shows the probability density function for the three-state system. N1N2 represents (flow line-normal state, riser-normal state), while N1C1 represents flow line-normal state, riser-failed state due to common causes e.g. hydrate formation, corrosion, mechanical failures, etc. N1P1 represents flow line-normal state, riser-failed state, due safety system unreliability.

Three weighting data sets classifications are used in the analysis of the safety and risk potential of the studied riser-flow line system. They are (ω₁=ω₂= . . . ω₆=1), (ω₁=0.1<ω₂=0.2<ω₃=0.3)

(ω₁=0.6>ω₂=0.5>ω₃=0.3). These data sets are the constant, increasing and decreasing weighting data set, respectively. The classification assigns ω₁=N1N2, ω₂=N1C1, and ω₃==N1P1, and μ₁=N1N2, μ₂=N1C1, and μ₃=N1P1 for the transition states respectively.

The plots of FIG. 5 shows that for a situation where riser-flow line has consistently increasing repair rate and a constant weight data set, the probability of the riser-flow line system to exist in the normal transition state decreases to a minimum value. Whereas the probability for the riser-flow line system to exist in the failed transition state of type (N1C1) increases to a maximum value up to two years and then decreases for the remaining operations years. This shows that for same weights assigned to the transition states, the possibility to exist in the failed state is higher than the possibility to exist in the normal state.

However a different trend exist in FIG. 6, where the probability function for all transition states decreases to a minimum value within two years of operations for increasing weighting data sets and repair rate. It can also be observed from the plots that the failed transition state of type N1C1 has a higher transition probability than the other two states. The normal transition state, (N1N2) has the least probability function during operational years. This trend can be explained by the concepts of the weighing function presented in this paper. Since the weight distribution from the data sets assigns the least weight to the normal transition state event, the possibility of having the least probability value is expected.

However FIG. 7 shows that for a decreasing weighting data set and increasing repair rate, the probability function decreases uniformly to a minimum value after four years, with the normal transition state having the highest probability within the first two years of operation. This again can be explained by the weighting function concept where the weight distribution assigns a bigger weight to the normal transition state (N1N2). This invariably makes the normal state have a greater probability of existence within the first two years.

FIG. 8 shows that if the risk potential is below the critical limit of 1 for very high safety reliability of 80%, the reliability of the safety systems fall, the risk of exceeding the critical limit becomes high. This is the undesirable limit.

However FIG. 9 shows that for a decreasing weight data set, the risk potential exist below the critical limit of 1 for safety systems used to safeguard Riser having reliability above 80%. This is so because the weight distribution assigns a bigger weight to exist to normal transition state than the other states as well as the contributing reliability of the Safety System. Hence, a change of weights assigned to each event, changes the way the risk is evaluated. This explains the behavior of complex risk systems, where a change in operating environment alters the risk potential, like hydrates forming in deep offshore flow lines and no hydrates forming on onshore flow lines.

FIG. 10 shows that the safety potential exceeds the critical limit of 1 only for Safety System reliability of 80%. FIG. 11 shows that for a constant data weight sets, which is equal to 1, the safety potential have their plots above the critical state of one at all times for all Safety System Reliability.

Management Factors in Safety

Analysts of Industrial disaster have shown that these are not simply a consequence of technical failure or human error. Underlying causes may lie deeply rooted in the management aspects of the organizational aspects of the organization, such as company policy, management style, communication or procedures. Two lines of development have been identified (1) The Smart Model (2) The Smart Tools. The Smart Model is the Framework, which describes the casual relationship between management factors and safety. It is intended to improve awareness at all levels of company management with respect to the impact of decisions in safety. The smart tools are of more instrumental nature, consisting of assessment guidelines and associated instruments, which will give confidence in the completeness and effectiveness of an organization's management safety.

Fundamentals of the Smart Framework Model

Management decisions making is influenced by various factors, such as time, variation of the environment, external influences, internal organization matters. These constraints may influence decision-making process in such a way that the eventual decisions cause the introduction of additional risks.

Hypotheses and Statements

The smart framework combines existing insights from various disciplines, such as organizational theory and accident analysis to evolve a set of hypotheses and statements

1. Different types of organization exist. Each Type of organization can achieve a high level of safety.
2. There is a limited number of fundamental organizational requirements with respect to safety, which should be taken into account to achieve this level of safety.
3. The way of implementing the organizational requirements i.e. the approach to improve safety, must match the characteristics of the organization.
4. There exist two kinds of failures, symptom failures (token) and type (root) failures.
5. Organizational requirements which have not been taken care of in a sufficient•way are strongly related to type failures.
6. Associated with the distinction between token and type failures. Two kinds of failure are distinguishable in managerial decision making.

i. Decisions that are focused on resolving token failures or characterized by an inadequate balance between resolving type failures and addressing considerations or external pressures (What is decided is wrong)

ii. The way of implementing decisions is characterized by an insufficient balance between organizational requirements for safety and organizational requirements for safety and organizational characteristics, either when managers are not aware of this relationship or when managers are not able to find the right balance between these two aspects

The Management Circle

Policy→Decision→Decisions→Control→Policy

There are a number of external pressures which influence managerial decision making.

Structure of the Smart Framework

The smart framework is based on the following cornerstone which originate from

Management Circle

Fundamental Organization requirements with respect to safety

Organizational Characteristics

External Pressures

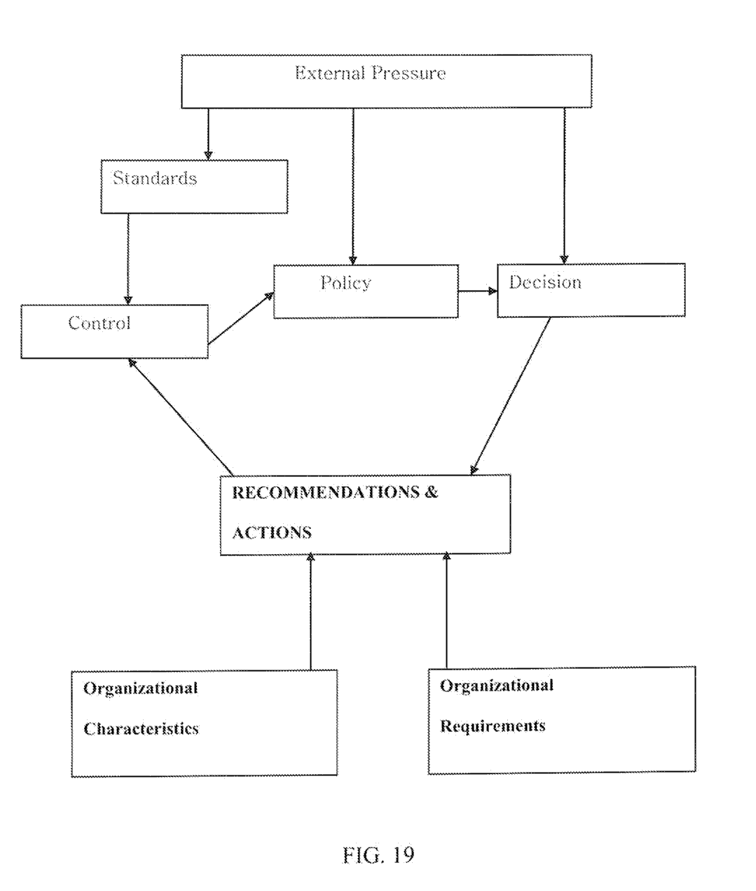

These factors are illustrated in FIG. 19.

Management Cycle

Since safety is an integral part of all business activities, it should be managed in the same way as all other activities. Thus, the management cycle appears in the center of framework. The management cycle express managerial activities, which are inherent to the tasks and function of management. Policy leads to Decisions, which lead to Actions, which lead to Control, which further lead to Policy.

Fundamental Requirements

Managing Safety is an integral part and essential part in managing a successful enterprise. Three different aspects of safety are distinguished.
The necessity of an integral approach to safety.

### Commitment of Management to Safety.

### Risk Awareness.

The way a group or organizational may react to abnormal or crises situation to achieve the goal of safety involves.
Provision of adequate resources.
Allocation of tasks and responsibilities.

### Coordination and Communication.

### Short Term Intervention and Recovery Possibilities.

Organizational Characteristics

The organizational characteristics are.

### Organizational Structure.

### Organizational Culture.

### History of the Organization.

Mintzbergs (1) theory on the structures of organization, distinguishes five key dimensions, which are relevant for organization functioning and design

### Coordinating Mechanism.

### Basic Parts o Organization.

Systems of flow.

### Design Parameters.

### Contingency Factors.

Harrison (2) provides useful approach for identifying and categorizing organizational culture.

### They are

### Power Orientation.

### Role Orientation.

### Tasks Orientation.

### Person Orientation.

External Pressure

External Pressure may affect decisions of management with respect of resources, design, expectations, standards and priorities.

### Commercial and Financial Constraints.

### Legal and Political Constraints.

### Social and Culture.

### Physical and Geographical Constraints.

### Other External Factors.

2.0 Reliability Engineering

### 1. Definitions

(1) Component is the basic unit of the system. A component may be a system in another context
(2) A mission is the objective, tasks, or purpose of a system or component
(3) A fault is a non-compliance with specifications
(4) Failure is the inability of a component to perform its intended function as specified. A component may function, but if it does not function as specified it as a failure
(5) Failure mode is used to refer to the possible ways in which a component may fail e.g. the possible ways through which the piping system could fail (failure modes) include pipe rupture, pipe clogging and pipe leakages
(6) A component is said to be in a normal state if it is not in a failed state

Basic failures refer to failures that are not broken down to contributory failures.

The interval is represented thus

| | |
|---|---|
| (t₁, t₂) | t₁ ≦ t ≦ t₂ |
| (t₁, t₂) | t₁ < t < t₂ |
| (t₁, t₂) | t₁ < t ≦ t₂ |

(8). A component is a repairable component if it is repaired upon detection of its failure. Replacement is equivalent to repair in the context of reliability analysis.
(9) A non-repairable component is not possible to repair after failure is detected
(10) Policy requirement may make a repairable component irreparable
(11) Reliability: Component reliability at time t is the probability that the component is in its normal state from time o to time t. A component may have more than one function and different reliabilities are associated with different function
(12) Unreliability is the complement of reliability. If the reliability at the time t is r(t), then the unreliability at time t, denoted by u(t)

u(t)=1−r(t)

(13) Availability at time t is the probability that the component is in its normal state at time t,given that it was new or as good as new at time zero.
(14) Unavailability is the complement of availability. If the availability at time t is a (t), then the unavailability at time t, denoted by q(t) is given by

q(t)=1−a(t)

(15) Reliability at time t is identical to availability at time t for a non repairable component
(16) Consider N identical components. All the N components are new or as good as new at time zero. Let N-n components fail anytime between 0 and t. Reliability of the component at time t is given by

$$r ( t ) = \frac{n}{N}$$

(17) Cumulative failure probability at time t refer to as failure probability at time t refer to as failure probability at time t is equal to the unreliability at time t

$$f ( t ) = u ( t ) = \frac{N - n}{N} = 1 - r ( t )$$

(18) The reliability can be defined as

r(t)=P(t<t′)

That is, the reliability of a component at time t is equal to the Probability that time t is less than the random variable t′ at which component fails.

(19) Similarly the failure probability or unreliability at time t is given by

f(t)=u(t)=P(t′≦t)

$$r ( t ) = \frac{[ \begin{matrix}Number of Components that are in \\ their normal state from time o to time t\end{matrix} ]}{[ \begin{matrix}Total Number of Components that \\ wer new or as good as new at time zero\end{matrix} ]} \\ f ( t ) = 1 - r ( t ) \qquad ( 20 )$$

(21) The failure probability density function f(t) is the derivative of the cumulative failure probability distribution function f(t) with respect to t

$$f ( t ) = \frac{d F ( t )}{d t} = \frac{d u ( t )}{d t}$$

$$f ( t ) = - \frac{d r ( t )}{d t}$$

The quantity f(t)dt is equal to the probability that the component will fail during the time internal between t and t+dt

(22) The expected life of a component is the effected value of the time at which the component fails given that it was new or as good as new at time zero

$$Mean Time to Failure ( M T T F ) = {\int }_{0}^{∞} r ( t ) d t$$

Alternatively if we test a number of components to failure or observed the failure of a number of components in the field and determine the life (time to failure) of each component (MTTF) is computed as the average of those values

(23) Expected Number of failures (ENF) over the time interval between t1 and t2, given that the component was new or as good as new at time zero is denoted by ω(t₁,t₂) or ENF(t₁,t₂). The expected number of failures of a non-repairable component between 0 and t is equal to the component unreliability at time t

w(0,t)=ENF(0,t)=u(t)

Time has broad meaning, time may be stated as (hours, days, years) or in terms of number of missions, number of cycles of operations, number of demands

The rate at which failure occurs during a specified interval of time is called the failure rate during that interval. The failure rate g between interval t1 and t2 is given by

$$g ( {t}_{1} , {t}_{2} ) = \frac{r ( {t}_{1} ) - r ( {t}_{2} )}{r ( {t}_{1} ) ( {t}_{2} - {t}_{1} )}$$

(26) Constant hazard rate is also referred to in the literature as the failure rate.

The hazard rate at time t denoted by h(t) is the failure rate during the time interval from t to t+Δt, in the limit Δt tends to zero

$$h ( t ) = {Limit}_{Δ t -> 0} [ \frac{r ( t ) - r ( t + Δ t )}{Δ t r ( t )} ] = \frac{f ( t )}{r ( t )}$$

The hazard rate is also known as the instantaneous failure rate and as the hazard function. The hazard rate of a component at time t is also defined as the number of failures per unit time at time t divided by the number of components in their normal state at time t

$$h ( t ) = {Limit}_{Δ t -> 0} [ \frac{n ( t ) - n ( t + Δ t )}{Δ t r ( t )} ] = \frac{f ( t )}{r ( t )}$$

n(t) is the number of components in their normal state at time t. Dividing numerator and denominator by N and equation 2 results in equation 1. A third definition used by analyst, the hazard rate at time t is the rate of change of the conditional probability of failure at time t given that the component is in the normal state at time t

The failure probability density function is given by at time t

$$f ( t ) = \frac{n ( t )}{N}$$

n(t)=Failure per unit time at time t

N=Number of Components at time zero

Whereas the hazard function at time is given by

The failure probability density function uses the total number of component as normalizing factor.

In addition, the system ARCHITECTURE for defining a Smart Framework Expert System by this Invention includes the following steps:

identifying the plurality of fault loops and nodes within the complex process systems; locating the central node from which all loops emanate; identifying the minimum number of loops from the central node, and determining if all nodes are contained within a loop, if a node is not contained in a loop, drawing arbitrary lines to connect the node to the central node, wherein the loops and lines comprise sub-networks; and analyzing each sub-network system to generate risk or safety profile.

During analyzing additional steps include source program to produce a version of the software program source code identify a plurality of code coverage tasks for analyzing Fault Tree Superstructure in complex multifunctional systems for steady and transient modes precipitated by faults or risk events in the system; generating a persistent unique subprogram code for each of the code coverage tasks; incorporating unique coverage program task model for the studied multifunctional process or Systems into a modified format of the program codes for each code coverage task to produce an instrumented version of the program source code; compiling and linking the instrumented version of the program source code into executable program; which identifies a new set of test cases from a plurality of test cases to be run for the code coverage data collection purposes of the code coverage tasks; altering the code coverage database to accommodate one of new, modified and expanded code coverage tasks and the new set of test cases; clearing any code coverage data for the code coverage tasks from the said coverage database; running the executable program with a test case from the identified new set of test cases and collecting code coverage data for the code coverage tasks, until all the test cases have been ran; and updating the code coverage database with the collected coverage data for the non-affected code coverage tasks in database file eliminating the need to run the entire program. Other aspects of the generating step include generating a persistent unique name for each of the code coverage tasks by changing the version indicators in the names of the said codes of coverage tasks.

Included in a flowchart information module are (i) a database for collecting persistent code coverage database interfaced with the SCADA software that is linked with the sensor device, a data storage device that stores the code coverage database; and one or more source programs executed by identifying the program for which the code coverage data should be collected, dividing the program source code statements of the said program into a plurality of code coverage tasks; (ii) a threshold apparatus connected to the database apparatus, the sensor device and the computational apparatus, is for collecting persistent code coverage threshold associated with transfer and computational errors in sub and main program, generating a unifying codes for tracking errors associated with each processing task for each of the code coverage tasks to eliminate completely errors from the final output results for each test case; and (iii) a microprocessor operationally connected to the database comprising: sub program software codes covering boundaries of mathematical & logical program statements incorporated into the main program code for each of the code coverage tasks to produce an instrumented program; compiling and linking the instrumented program into a program executable; identifying a set of test cases from a plurality of test cases to be run for the code processing tasks for the identified set of test cases, running the program executable with a test case from the identified set of test cases and presenting the information about test case and coverage points that are executed into an output file, until all the test cases have been run; and processing the information and producing the output file into code coverage data and populating the code coverage database with the said output for test cases.

Generating a persistent unique name for each of the code coverage tasks of the said plurality of the code coverage tasks for different pipeline system integrated into a mesh of interlocking risk network and safety loops of the process; and (ii) Performance & Reliability & Decision Apparatus which comprises of program codes for checking the certainty of leaks in a pipeline through probability and optimization matrix system methods, wherein the code coverage database comprises a matrix array of trials for each test case in the said identified set of test cases and a column for each code coverage tasks of said plurality of code coverage tasks, wherein the decision variables are generated through a series of program codes to decide on the possibility of leaks in the pipeline system, inventory loss, risk assessment, failure and decision modes.

Included in an output, location and alarm module are an article of manufacture comprising a program storage device readable by a computer to perform method steps for collecting persistent code coverage data using a computer program codes, the computer program comprising program source code statements to detect leak points, locations, inventory or commodity loss, the method which comprising the steps of: identifying the computer program for which the code coverage data should be collected; dividing the program source code statements of said computer program into a plurality of code coverage tasks; generating a persistent unique name for each of the code coverage tasks of said plurality of code coverage tasks; generating a persistent unique name for each code of the code coverage tasks of said plurality of code coverage tasks of test cases; incorporating alarm voice and fax modes codes into the computer program source codes, for each variation from normal case, indicating leak detected for each of the coverage tasks to produce an instrumented program; compiling and linking the instrumented program into a program executable; identifying a set of test cases from a plurality of test cases to be run for the code coverage output data collection purposes, creating a code coverage database using the code coverage tasks and the identified set of test cases; running a program executable with a test case from the identified set of test cases, and running an alarm mode codes for deviation from normal case, and writing the information about the test case and the coverage points that are executed into an output file, until all the test cases have been run; and processing the information contained into the output file, making it available to users into code coverage data and populating the code coverage database with said code coverage data. In our proposed security model we would be implementing two main layers of security and other sub-layers viz;

### Traffic-Based Security

### User-Based Security

Other equipment includes a communication apparatus connecting the SCADA (Supervisor Control and Data Acquisition) software and the Host Computer Server via a Network Protocol, the communication apparatus comprising: Modified Program Source Codes of a Distributed Control System combined with a Programmable Logic Controller, including a printer function, a memory configured to store information protocols from a plurality of protocols, including at least encoding definition protocol, the protocol manager, the history log information protocol, setup user information protocol, and communicating destination address information, the encoding definition protocol describing an encoding source program method of the security management of information and the plurality of task functions; and a transmitter device: run by source program; transmitting the encoded information in the form of encrypted waveforms.

The encoding definition protocol includes management task protocols that create a data encrypted waveform from a plurality of encrypted data waveform; created by a unique encryption model source codes in the apparatus, to enhance security of transported information in a communication pipe network. A computer host server connected through one of a WAN and LAN network device, to the communication apparatus with at least a printer function, comprising: a management protocol program source codes to decode test case encrypted data waveform from a plurality of encrypted data waveform from the communication apparatus, wherein a decoder decodes the encoded encrypted data waveform from a plurality of data waveform; a request protocol to manage print job and history log information, setup user, destination address information, program source codes for receiving decoded data information from a plurality of waveforms, compiling data information, running the leak detection and inventory management program codes for particular test cases from plurality of test cases, and alarm code ran as voice and fax modem, that can present a fax document to various users.

Software codes for information management to be controlled using an identifier protocol codes that classifies types waveform as follows: inserting into the Main Program Source Code sub-program codes that manage a system protocol for organizing input and output information data in a searchable Spreadsheet Format which is interface with a dynamic query database system, where the Output information is accessible to the a Chart device for plotting characteristic plots of output information; under managed and control interface user, with adequate access permission to the searchable Spreadsheet. Manipulation of the spreadsheet is only limited to the Output Chart Presentation, as the Input data information into the spreadsheet is controlled by a dynamic query data base system, while the Output Chart Protocols, can be manipulated and modify to give different visual and numerical forms by user protocols.

Other software aspects include a computer-software assisted implemented detection and inventory loss management system for the process network system comprising: a computer host server, a plurality of computer work stations using one of a LAN (Local Area Network) and a WAN (Wide Area Network) operationally coupled to the computer host server from which respective users have an access code in the form of an authorization password code, combined with a voice recognition modem, wherein the computer includes: the leak detection software, a database component, having both dynamic and static features, a SCADA software system interfaced with a Distributed System Controller in phase with a Programming Logic Controller, linked up to a network of sensor work stations, wherein the sensor work stations are situated at upstream and downstream points of pipeline segment.\

The invention provides for a graphical user host and user computer system, providing both contextual and virtual reality of display Risk and safety mode scenarios of typical network system, for user's display screen when a user moves a cursor arrow over and rest it on a button, a voice modem for communication between user and software query database and controller, using voice activated protocols sub program codes. The system also has built-in-email functionality capability using internet e-mail in which e-mail documents can be separately sent or received from the Output database automatically to the user and vice-versa, inbuilt internet features to accept bulk mails, inbuilt features to accept voice and fax commands from user or automated device to the control task protocol software. Other aspects include a computer-readable medium having computer-readable instructions for performing a method of operating an automated computer based risk and safety status assessment and monitoring on real time basis with very minimal or no false alarms thresholds comprising a web server in inter-communication with browser-enabled user stations, reporting risk events and safety status, such as leak occurrence, size and location, inventory loss, assessment and risk to immediate environment, in voice, fax and virtual format.

Other aspects of the software include an algorithm for providing expert information from a plurality of source information database port system connected to a centralized database server system, whereas the said methods comprising the steps of: displaying useful information to client user server, providing an expert opinion in fax, voice and virtual format, and identifying alternative paths of control; receiving request from client system protocol and interfacing with the server database, the database storing expert information relating to each port and cross referencing user information.

For displaying there is provided a displaying information protocol; comprising program codes that manages a user graphical interface, displaying plurality of information on the pipeline flow system, flow data, leak situation and inventory loss, request protocol; comprising sub program codes to manage a user graphical interface to interact between user and database system. Also included are a comparator protocol, cross reference the expert information: comparing user information, communication language of user to expert information stored on the database including identification of expert system protocols, type of expert system protocols, shift timings of expert system protocols, communication language of expert protocols, and availability of expert system protocols, retrieving available experts protocols based on matching user information with expert information protocols, and sorting the retrievable experts on a selection criteria.

There is also an expert system is designed through an applet implemented that comprises of web based enabled graphical interface constructed in Java Programming Language and the Unix Platform for compiling, executing, testing the plurality of software applications program codes constructed in C language for the expert system, the risk and safety assessment module

These and other aspects, features and advantages of the present invention will become apparent from the following detailed description of preferred embodiments, which is to be read in connection with the accompanying drawings.

System Description Application in Software Development Architecture

The following requirements include at a minimum a description of every input (stimulus) into the system, every output (response) from the system and all internal processes performed by the system in response to an input or in support of an output. This form of analysis is necessary to help the developers get a clearer picture of the overall system and the interconnecting subsystems.

For designers: To design a good system to satisfy the requirements.

For testers: To test the system treasure the system satisfy those require.

Inputs into the system;

### Flow Parameters

### Pressure

### Velocity

### Temperature

Hazard rate
Weights of different risk events

### Design Parameters

Structural Strength
Material

System specifications relating to Gas Export Process System comprise an input of raw materials, processing the raw materials to a value added product, and outputting the value added product.

3.1.1 SCADA Manager

Description: The SCADA Manager is the interface to the SCADA software and there are quite a number of them in the market. What the SCADA manager does is to present an interface to the SCADA software so that they can communicate with the FAULTFINDER software. The SCADA Manager would be abstracted SCADA interfaces which provide different implementations of those for different providers, so that the whole system would not depend on a particular provider, just an interface.

3.1.2 Hazard Monitor

Description: This is a real time database and associated program codes that are connected to the SCADA manager takes input data from the SCADA system and puts into its own database format fit for use by SAFETY_RISK simulator. It not only takes the information from SCADA but tracks/manages the data.

The Hazard monitor database system is connected to the sensors FAULT TRACK MODULES via the SCADA manager (abstracted software) and also to the SAFETY_RISK SIMULATOR, which does risk and safety analysis of the Gas Export Process System system.

The hazard MONITOR and SAFETY_RISK SIMULATOR is linked to the SAFETY MANAGER which solves the risk and safety matrix1, stability profitability2, statistical matrix3 which evaluate the safety potential of the PROCESS_SYSTEM. See FIG. 3.1

Input: Outputs from the SCADA software; measured HAZARD rate, pressure, velocity, density of fluid FLOW from all the node segments.

Output-refined plurality of data put on different ports mainly a database.

3.1.3 Threshold Simulator

Description:

The threshold simulator subsystem is connected to the database subsystem, the HAZARD monitor subsystem, and the computational subsystem (Safety Track, Risk Simulator) allows for the tracking, regulation and correction of all error modes in the system. Typical errors are those from the instrument sensors, logical and computational errors.

Process: Data and capture, analysis and correction.

Inputs: *Instrument Errors (From Sensors).
*Computational Errors (From Safety track)
*Logical Errors (From Computational Subsystem)

Outputs: Unifying Codes for error tracking and Correction. Errors associated with each processing task for each of the code coverage tasks to eliminate errors introduced.

Process Gate Simulator

Description/Process Function: See FIG. 3.2 (Attachment Figures)

PROCESS Gate Simulator provides for the pictorial representation or graphical display of the PROCESS system. The PROCESS gate simulator also provides a design flow chart of the PROCESS network system showing all manifold points, Process System type, distance, diameter and specifications, sensors and value locations.

Inputs:

The basic inputs are the (i) PROCESS (Process System, Topsides, Storage) dimensions (ii) Elevation (iii) Design pressure (iv) Information on nodes, fluid properties (?), etc and basically all inputs required displaying PROCESS system structure.

Outputs:

Outputs are (i) graphical/Pictorial representation of the PROCESS network structure in visual format showing node distances value locations, manifold, sensors, RTUs, network configuration.(ii) Risk Status, Risk from what (System under scrutiny) risks to what, risk of what (measures of harm that we wish to assess), so what (decisions need to be taken) (iii) In the event of a fault, simulate commodity loss from the export Process System, pictorially displaying amount of fluid spilled, economic and risk analysis.

Safety Gate (Simulator)

Description/Functions:

The safety gate simulator does a preliminary assessment of inventory loss, the risk to the immediate environment, safety assessment, which sends this information to the inventory loss manager that does inventory loss assessment and control. The SAFETY gate simulator interfaces directly with the module of FAULT Track that determines if there's a fault or no fault. The SAFETY gate simulator has a real time database that would store all of this information and tells about the environmental consequences, risk.

Inputs:

The input to the SAFETY gate is the output from Fault Track computational subsystem that determines the event of a fault condition.

Outputs:

Fault condition status, volume of spill, time of spill, cause of spill, rendering of spill situation, accidents inventory and database of fault information.

3.1.6 Fault Track Simulator

Description/Function:

The fault track simulator subsystem is the heart of the Safety software system and it is the core computational subsystem which solves the flow matrix, stability matrix (where the eigenvalues of the stability function is evaluated), the probability and statistical matrix, which evaluates the certainty of a fault in the Process System.

The fault track simulator does all these computation to determine the probability or certainty of a fault or no fault and determines the location of the fault all base on new methods for flow in Process Systems.

Refer to algorithm (and flow chart) for analysis of single and complex Process System network system for fault detection included with this SRS.

The fault track works with various inputs from the RISK SIMULATOR, hazard MONITOR and THRESHOLD SIMULATOR to compute the Eigen values for velocity distance, time for various fault factors and does a pattern match to determine the event of a fault or no fault and the size and location of a fault.

Inputs: Inputs to fault Track simulator are the outputs from Flow Monitor, Flow Simulator and the Threshold Simulator which are basically pressure and velocity from different nodes, analyses Process System network segments and error correction values respectively.

Outputs: Typical outputs are fault status (Fault or No fault), fault location, fault size, number of faults, time of fault, etc.

3.1.7 Performance and Reliability Decision Subcomponent

This subcomponent of the FAULT TRACK consists of program codes for checking the certainty of faults in a Process System through probability and optimization matrix methods wherein the code coverage database comprises of matrix array of trials for each test case in the said identified set of test cases and a column for each of the tasks. The decision variables we generated through a series of program codes to decide on the possibility/certainty of faults in the Process System system, inventory loss, and risk assessment, failure and decision modes. Refer to probability and decision algorithms.

3.1.8 Inventory Loss Manager (Release of Contaminant)

### Description/Function:

The basic function of the inventory loss manager is to allow the software system analyze the inventory loss from the Process System and to determine the risk discharge of the fluid commodity in the Process System to the adjourning surrounding. This also does inventory loss analysis and control.

Compares the difference between the inlet and outlet measurements. The inventory loss manager may be regarded as a subcomponent of the spill gate simulator.

Inputs:

Inputs to the inventory loss manager are sensor measurements at the inlet and outlet of different Process System segments. This is taken from the RISKMATRIX Monitor real time database.

Outputs:

The outputs would be difference in measurements in form of fault deviations and analysis of discharge to the surroundings if there's any.

3.1.9 Output and Location Mode Simulator

### Description/Function:

Basic function of the location mode simulator is to track and locate all faults along the Process System, stores in a database subsystem and formats the output in the event of a fault in a format for host devices like the PDA, phone, fax, email. What it does is to identify the software subsystem for which the persistent code coverage data should be collected; turning the program source code statements into a plurality of coverage tasks and incorporating the said output in a format fit for the output devices and the database.

Inputs:

Inputs to the location mode simulator are the output of the location detector from FAULT TRACK SIMULATOR.

### Outputs:

Distance of fault, pinpoint location of fault, nearest shutdown value, etc. in form of alarm codes, warnings to the output devices like a mobile phone, PDA, fax machine, email.

3.1.10 Alarm and Security Mode Subsystem

### Description/Function:

The alarm and security mode subsystem would typically consist of a portion of control code and an alarming device for the client site. The control code would typically a couple (variety) of test cases for different scenarios stored in it's database and when there's a deviation from the norm, an alarm mode code is activated which triggers the audible alarm and writes the scenarios into the master database subsystem.

Inputs: Text cases from the output and location mode simulator.

Outputs: Audible alarm warning, events logs, written to the master database.

3.1.11 Database Management Subsystem

### Description/Function:

The database management system is the master database and it is associated codes that houses all the data collected, analyzed, and computed. This database would cut across all the subsystems of the software system that base to do with data collection and computation. The database should have quick query capabilities and should be rugged (among other required features of a real time system database management system). There would be two database systems one is the real time database and the other the historical database for long term retrieval.

Inputs:

Inputs to the Database include but not limited to (i) code coverage database software interfaced with the SCADA manager software (abstracted, SCADA software interface) linked with the RTUs and sensor devices (ii) code coverage data collected from the inventory loss simulator (iii) Output data from the fault TRACK simulator (velocity, pressure, density, location of spill, distance) (iv) Data from the flow monitor (v) data from the flow simulator (v) data from SAFETYGATE simulator (vi) outputs from the location mode simulator (etc).

Outputs:

Measured data from SCADA system and sensors (V,P,λ,T)

Inventory of Fluid Data

Process System data: Process System dimensions, elevation design pressure.

Fluid properties: Design, Viscosity, Kinematic Viscosity, water cut, Gas oil ratio, Heat Transfer coefficient, composition (natural gas), Thermal conductivity.

Spill Data

Time of spill, cause of spill, duration, and commodity loss

Fault Data

No of faults, Time, location.

Accident History

Functional Requirements of Software

3.2 User Interface Requirements

In our design of the user interfaces and accompanying requirements, the understanding of the users' context is necessary in order to translate the user requirements into a user interface specification. The context considered included the characteristics of the users and tasks.

The look and feel of the user interface shall be consistent with corporate branding standard and colors.

The Safety software system shall have standard windows functions and drop down menu items.

The Safety interface shall have at the bottom of the screen the user who logged on to the system, the fault status, date and time.

The user interface shall be based on a single or multiple windows with dialogue boxes being used to display error or help messages.

The system shall use colors to make the interface attractive and easy to use. However it will be important to avoid colors that contrast poorly when there may be glare on the screen from sunlight.

The system shall provide the user the ability to press a help key to provide context based help in different situations the help window will displayed alongside the main window showing so that users can continue work or apply help as they work.

The error messages shall be concise, polite and informative. They will be tested on intended users before implementation.

All inputs shall receive visual and auditory feedback.

Clear graphical plots of faults and safety analysis shall be provided, with the option to be printed to an output device like a printer.

The Safety software system shall have a web interface accessible from any browser with appropriate security features and permissions.

The user interfaces shall be capable of displaying a plurality of information on the Process System flow system. This display would stimulate the flow of fluid through the Process System and the node segment showing requisite connected devices and status of fluid, fault, no fault or surge, and then predict level of hazards which determines the safety status

There shall be a database menu with features for querying the master database for requisite information and archives.

The user interface shall be capable of displaying the Process System network system in visual format showing nodes, distance, valves, sensors, controllers, RTUs, and network configuration.

The user interface displaying the Process System system, upon clicking on element shall display properties of that element with all relevant details.

The Safety software system shall have a PDA or phone interface for limited query functionality and events display status messages.

The Safety shall be capable of delivering all system responses within 5 seconds or at less on recommended system hardware.

The Safety software system shall have a safety profile window displaying safety profile analysis

The Safety software shall have an alarm and event log window.

Along with all the above display, the following functions display shall be required. (i) Overview Display (ii) Data I/O displays (iii) Fault detection and location status display (iv) Process System product properties display (iv) hazard rate and safety status vi) risk events

The following shall also be captured in the user interface; Station schematics, geographical displays, communications summary, line fill displays, fault detection displays, hydraulic gradient displays.

Hardware Interface Requirement

In this section we specify the logical characteristics of each interface between the software product and the hardware components of the system. This covers such matters as what devices are to be supported how they are to be supported and protocols.

The basic hardware components of the system that the software would interface with is the Intel x86 compatible CPU and instruction set because of it's wide spread support.

The software systems would interface with the field instruments like the RTU, PLC. System software shall interface with a digital card with appropriate operating system drivers.

This card shall have the function of sending out audible alarms in the control room in the events of a fault condition.

Software System Requirements

The Safety software system shall take input data from a SCADA software system via the appropriate SCADA MANAGER/INTERFACE' subsystem software/codes.

The SCADA manager subsystem shall be a subsystem or subcomponent of the FAULTFINDER SOFTWARE SYSTEM and shall be abstracted interfaces (Application Programming Interface) that connects with the SCADA system software.

The basic function of the SCADA manager subsystem shall be able to translate the data provided by the SCADA software

The SCADA manager subsystem shall not be limited to one type of SCADA software, PLC, RTUs or Telemetry system and shall interface with most supported SCADA software system with minimum integration issues.

The SCADA manager shall be capable of data validation because in the real world the data collected by the instrumentation system is rarely perfect.

There shall be a hazardMONITOR2 Software subsystem, which consist of a sub database storing all data froth the SCADA interface and one or more source programs, which identify the interface from which the data is to be collected, formatting the data and putting it into plurality of code statements.

The hazard MONITOR shall continually keep tract of data on (i) Fault (ii) Pressure surges (@ different node segments), flow velocity, density temperature, and viscosity of the fluid in the Process System system.

The software system shall have an online learning capability as PROCESS_Safety Software always changes and instrument drift could occur over a long time period.

There shall be a SAFETY_RISK SIMULATOR3 software subsystem that would be interfaced with the hazard MONITOR and ‘PROCESS GATE4 software subsystem.

The RISK_SAFETY SIMULATOR subsystem shall take inputs from the hazard MONITOR database and perform dynamic hazard analysis of the Gas Export Process System to determine hazard Rates from operation fluctuation as pressure, and flow velocity.

The RISK_SAFETY SIMULATOR subsystem shall be capable of performing safety analysis on the PROCESS under monitoring.

The RISK_SAFETY SIMULATOR subsystem shall interface directly with the PROCESS GATE subsystem to produce visual displays of the PROCESS Gas Export Process System structure and thus give a complete picture under the conditions.

The outputs from the RISK_SAFETY SIMULATOR shall be profiles of SAFETY and RISK POTENTIAL for each PROCESS SYSTEM and time grid.

There shall be a THRESHOLD SIMULATOR 4 subsystem that would interface with the SCADA software through SCADAMANAGER subsystem and the FLOW DATABASE subsystem.

The threshold SIMULATOR shall perform error analysis and correction and provide correction values of instrument error or drift, computational errors and logical errors to the SAFE MATRIX_PROCESS GER System for proper/actual computation.

The threshold SIMULATOR shall input instrument error or drift from the measured values and provide for correction for these results for RISK_SAFETY to utilize.

The THRESHOLD SIMULATOR shall track and regulate computational errors from the main computational subsystem, RISK_SAFETY system Module and provide for error correction.

The Threshold SIMULATOR shall track and normalize errors from the real time database (hazard MONITOR database) and provide for error correction.

The Threshold SIMULATOR shall generate unifying codes for tracking errors associated with each processing task for each of the code coverage tasks to eliminate the errors introduced.

There shall be a PROCESS GATE system which provides Schematic View of the PROCESS network system in real time and does a preliminary simulation based on new methods developed for such system.

The PROCESS GATE simulator shall provide for the pictorial representation or the graphical display of the PROCESS System network using a form collect data like dimensions, elevation and design pressure. Others are the location of nodes or names representing them, distance between them, values (types and features), sensors, RTUs and the network configuration.

Alternatively there shall also be a Process System configuration wizard, which poses queries and dialogue boxes to completely configure the Process System network system.

The PROCESSGATE SIMULATOR shall provide the PROCESS design Flow Chart and analysis, which is the preliminary stage for computation.

FAULTTRACK (COMPUTATIONAL Subsystem)

There shall be a FAULTTRACK or COMPUTATIONAL subsystem which is the heart of the FAULTFINDER software, with interfacing inputs from the FLOWMONITOR, FLOWSIMULATOR AND THRESHOLD subsystems responsible for computation and all the algorithms for detecting faults and fault location.

The FAULTTRACK subsystem shall analyze the flow behaviors for steady or unsteady state using the simulation flow chart provided below and decide on the numerical techniques to use.

See FIG. 11.

The FAULTTARCK subsystem shall use the modified Euler method application to model flow for steady state to evaluate V, P, and mass rate.

The FAULTTRACK subsystem shall use the Explicit/Implicit difference and Finite Element method to model flow for unsteady state to evaluate velocity, pressure, mass rate for each space node J and time grid K.

The FAULTTRACK subsystem shall use the Process System Network Analysis algorithm and flowchart below to analyze the complex Process System network to produce the pressure drop and fault profile. (This provides the design for the Process System network system for fault flow analysis).

See FIG. 11.

The FAULTTRACK subsystem shall generate a matrix equation relating pressure heads at each node and flow distribution in each Process System node segment.

The FAULTTRACK subsystem shall use the markov chain algorithm configured to handle transient state cause by faulting Process System to analyze each network. This is after the Process System is decomposed into a mesh of networks and analyzed using nodal analysis and Kirchoff's laws.

The FAULTTRACK subsystem shall use the algorithm and flowchart in Appendix D for the analysis of complex Process System network system for actual fault detection.

See FIG. 11.

The FAULTTRACK subsystem shall incorporate deterministic criteria based on the theory of LIAPUNOV stability: A system based on LIAPUNOV stability criteria to construct a Stability Matrix Array.

The stability matrix array shall be created or developed for measured (and corrected) values of operational (pressure and velocity) and risk (hazard rate and safety variable) for each Process System section.

The eigenvalues of the characteristic deviation matrix shall be and if it is less than −1 for all process times a fault is indicated. If it is +1 a surge is indicated out if it is the normal region of 1 it is a normal condition.

The performance, reliability and decision subsystem within the FAULTTRACK subsystem shall comprise of program codes for checking the certainly of faults in a Process System through profitability and optimization matrix system methods wherein the code coverage database comprises a matrix array of trials fro each test case identified and compared with the present condition. The decision variables are activated/generated through a series of program code to decide on the possibility of faults, inventory loss, and risk assessment, failure and decision modes.

The fault location shall be determined once the DATA particular to the fault characteristics is evaluated. This is calculated by the product of the wave velocity and the instantaneous time for fault detection.

The instantaneous fault time variation shall be determined by deviation in time that has elapsed between the last measurements that indicated no fault to the next measurement that indicated a fault.

Upon evaluation and the determination of fault status, if the Eigen value is less than −1, the system activity monitor shall activate the fault alarm system and printout location of fault. If eigen values are greater than 1 the system activity monitor shall indicate a surge.

See FIG. 11.

New model for detecting faults in liquid Process System uses a WEIGHTING function in a Fuzzy Belief Class and Stability function.

New model for detecting faults in a gas Process System uses a WEIGHTING function in a Fuzzy Belief Class and Stability function.

Inventory loss shall be evaluated by the difference in input flow and output flow corrected for thresholds. This also represents the size of the fault.

The FAULTFINDER software shall be capable of determining failure modes by studying and comparing fluid dynamic. Failure mode of the type;
Corrosion.
Blowout.
Sabotage.
Accidents.

FAULTFINDER simulator shall solve the flow matrix, safety matrix and stability matrix (where the eigenvalues of the stability function evaluated), the probability and statistical matrix which determine the location of faults in the Process Systems location simulator determines the location of faults in the Process System.

There shall be a software subsystem called SAFETYGATE simulator which shall be responsible for the preliminary safety accidents and assessment of inventory loss.

The SAFETY GATE simulator shall have a real time database (or DATASTORE) that store the following data flows;

Preliminary assessment of inventory loss
Determine the volume of spill and assess the impact on the environment
Safety and reliability threshold values
Time and duration of spill
Visual rendering of spill situation
Failure made type, corrosion, blowouts, and sabotage

The SAFETYGATE simulator shall interface or take input from the FAULTTRACKER module and the inventory loss manager subsystem.

The SAFETY GATE simulator shall contain a database of all types of fluid carried by Process Systems, their characteristics, fluid properties, for assessment in the event of a spill.

The SAFETYGATE simulator shall send fault and risk information to the inventory loss manager that dues inventory loss assessment and control. Which determines the magnitude of the fault and accidents?

The SAFETYGATE simulator shall have the ability of transmitting contents of its real time database into a visual simulation of flow, fault and failure condition using high resolution graphics to illustrate.

The Inventory Loss Manager shall be a subcomponent of the SAFETYGATE simulator which takes data measurements from input and output and evaluates the difference, in the fault measurements to determine the magnitude of a fault.

The outputs from the Inventory Loss Manager which are the difference in fault measurements inform loss of fluid shall form portion of the inputs to the SAFETYGATE simulator.

There shall be an output and location mode subsystem whose basis function is to trace and locate all faults in the Process System network system.

The output and location mode subsystem shall store all data in the main database subsystem.

The output and location mode subsystem shall format output signals (fault status, fault size, fault location) in a format fit for the different types of hosts (PDA, Phone, Fax, email).

The output and location mode subsystem shall identify the software subsystem for which the persistent code coverage data should be collected; dividing the program source code statements into a plurality of coverage tasks and incorporating the said outputs in the a format fit for the output devices and the database.

The inputs to the “output and location” subsystem shall be the output from the FAULTTRACK simulator.

Typical output from the “output n location mode” subsystem shall be (i) distance of fault (ii) Pinpoint location of fault (iii) Nearest shutdown valve (iv) Initiate Full Bore Rupture

There shall be an ALARM subsystem which is a portion of the content code which would typically be a variety of test cases for different scenarios stored in the master database and when there's a deviation from the norm, an alarm mode code is activated which triggers the audible alarm and writes the scenarios into the master database system.

There shall be a MASTER DATABASE subsystem which is the master database of the Safety software system that stores all the data from the SCADA, analyzed and computed data.

The database subsystem shall interface with and collect data from the following subsystems; the hazard MONITOR database, the FAULTTRACK, computational subsystem, the SAFETYGATE subsystem database (including the inventory loss manager) data from the hazard SIMULATOR and the outputs from the Location Mode simulator.

The Database shall be a relational database management system capable of a advanced search, querying and data retrieval capabilities and arching of data for a period of 1 year (12 months).

The database shall be referred to as the historical database management system and shall interface with real-time database.

The master(or historical) database shall be capable of producing the following results upon query, dynamic data retrieval;

(i) Measured and corrected data from SCADA system (hazard, velocity, pressure, Temperature, Density, flow rate)
(ii) Fluid properties; Density, viscosity, kinematics viscosity, water cut, gas-oil ratio, Heat transfer coefficient composition, thermal conductivity;

(iv) Fault data: Time of fault, cause of spill (corrosion, accidents, blowout, subsystem inventory loss, number of faults, and location of fault.

Others

The software shall be capable of learning about the pipe network and tuning the parameters in order to achieve reliable and sensitive fault defection. This could also be done to make up for instrument drift.

Tuning Parameters

Filter length and threshold values for data validation.

Fault sizes to be detected and the corresponding variance values.

Conditions for detecting Process System transients automatically in setting the operating mode to “steady state”, “medium transient” and ‘large transient”.

The FAULTFINDER software shall have the ability to recognize and display the following type of data faults.

Out of range data

Excessively noisy data

Outliers (sudden increase in the rate of change)

Frozen data (no change at all for a certain time period)

Inconsistent data (One measurement is within a different window from the others)

The software system shall implement batch tracking (discriminating between the different contents of the Process System) by using the average density of the fluid.

The software shall provide the operator, at each scan with an automatic serial number, a log of the times of departure and estimated arrival, estimation of the crude volume delivered, Calculation of the average density estimation of the batch velocity and the current batch position within the Process System.

All the above information (batch tracking) shall be displayed on the Process System mimic window using a set of color displays and a table displaying the numerical values.

There shall be hardcopy and logging facilities provided for batch tracking. On the interface there would be a command button to “PRINT BATCH SCHEDULE’.

FAULTFINDER shall have the ability to store all information gathered and processed in a historical database.

FAULTFINDER shall have present the data in form of an Executive Summary which would be available both online and offline (using the event log file)

Faultfinder shall include the data in the executive summary

Operational status (steady state, small, large transient)

Data faults (stopped, run forward, run reverse)

Alarm status (fault warnings, fault alarms)

Estimated Process System Resistance

Average flow difference after the pressure correction.

A Full Bore Rupture (FBR) shall be initiated automatically after the period of time (say 30 secs) as elapsed for a manual instruction by requisite person.

There shall be a server end and a client end of the Faultfinder Software. The server end would be the back-end software installed on a high performance application server interfacing with the SCADA software and the Database system.

The client end shall be made up of three types of interfaces;

Console Interface or a direct administrative interface installed on a workstation computer. It may be remotely connected to the server

Web or internet Interface which facilitate connection to the server through the Internet. This interface further specifies other security features like encryption algorithms, encrypted passwords, Secure Sockets Layer 7.

PDA or phone interface in XML or J2ME for reporting, querying and limited interface features.

There shall be a facility for the software to send an email or fax message to the user in the event of a fault condition or if any if configured to provide the information at different intervals.

There shall be an algorithm for providing expert information, opinion, advice in the event of certain conditions, consisting of displaying useful information to the client. Identifying alternative paths of control, servicing requests for client interfaces, and cross-referencing user information.

The Faultfinder software shall use network protocols and installed in a LAN where different users with the requite authorization code and access tokens provided according privileges required access the server. System administrators, developers, training control management, etc.

The different classes shall be given different access tokens and rights within the software.

The most privileged user or the administrator shall have super user equivalence on the system and total system rights. He shall have the ability to do the following among others.

Setup different users and passwords on the system with the requisite limited access.

Configure the system for different performance scenarios.

Configure security and access feature for different users.

Perform administrative functions on the system including shutdown, backup and recovery, setup database features.

Schedule maintenance on the system.

The Faultfinder software shall be CONFIGURED according to the number of client access licenses purchased by Faultfinder. For example 2 client access licenses allow a maximum of 2 users to access the system at a time. For 48 Client access license a maximum of 48 users can access the system simultaneously.

There shall be a Test and Training environment that allows the generation of a series of Fault “test patterns” and simulation of the field instruments and SCADA system data.

There shall be a subsystem component software called FAULTS WITCH which is an automated, flow state dependent switching and resetting procedure (program codes) for pumps, PCVs and block valves loading to improvements with pumps settings and threshold settings, flow path changes, start up and shut down procedures.

Performance Requirements

### Performance Requirements

High instrument accuracy

Good repeatability of measurement results

Resolution determines the minimum change an instrument can sense. Also determines the minimum fault detectable by any system based on field measurements.

If the resolution of flow and pressure meters is 0.1% for e.g. It's impossible to use the meters to reflect to fault smaller than 0.1%

instrument repeatability is critical in determining fault detection reliability, if it's in region to detect a fault of a magnitude equal to or smaller than instrument repeatability, then false alarms will be generated.

The software system shall support 48 simultaneous users on the software providing each with the maximum processing capability without any reduction in system performance.

The Faultfinder software shall be capable of displaying and transmitting graphics, text and related information to different users.

The Faultfinder Software shall be capable of detecting and locating a fault in less than 60 seconds overall time.

Any interface between the user and the automated system shall have a maximum response time of 2 seconds.

The Faultfinder software shall poll the SCADA software every two seconds to get new data.

All measured data shall be accurate to 2 decimal places.

The response of the system shall be fast enough to avoid interrupting the users' flow of thought.

Response to queries shall take no longer than 7 seconds to load on to the screen after the user submits the query.

The system shall display confirmation messages to users within 4 seconds after the user submits information to the system.

The fault detection software shall be capable of detecting fault size of 1% in an average detection of 60 seconds; bigger faults (50%) shall be detected in about 20 seconds.

Logical Database Requirements

The following are the various functions that generate data within the system.
Process Monitor database (real time) functionsρ, m, P, T, V.

### Fault Track Computations KL, Fault Location, Fault Size,

Threshold Values stored in the database
Spillgate Historical data
Fault Simulator Process System data, dimensions

The software shall have the ability to maneuver through historical, current and projected data thus giving the user the power to foresee the problems that might occur in future.

Information changes through time shall have the ability to be accesses, reviewed, and distributed.

Design Constraints

Design network architecture to ISO OSI 7 Layer architecture

Software quality must meet SEI CMM Level 5 standards

The software shall conform to statutory and legislative requirements

Software System Attributes

3.7.1 Reliability

The software product shall be able to transmit fault location, size and proposed action within 60 seconds of computation.

The software shall monitor the Process System network in real time passing useful information to the users within 120 seconds of the occurrence of a fault and automatically shutting the valves within the next 60 seconds if it receives no other commands.

Availability

The product shall available 24 hrs per day 365 days per year.

The products shall achieve 99% uptime and availability under all operating conditions.

The product shall have the ability of the stopping and restarting a process or service without rebooting the whole system and put it offline.

Robustness

The software shall have the ability to continue to work if the Process System experiences operational changes e.g. throughput changes, pigging.

The software shall continue to operate in an offline mode even after loosing link to the SCADA system.

The software shall continue to operate and detect faults after instrument errors have been detected.

Security

Only the system administrator shall have overall access to the system.

When accessing the data over the web, there shall be an encryption algorithm or through VPN there shall be secure sockets layer 7

There shall be access tokens for the different classes of users giving rights to view, modify, and configure settings according to permissions on the access tokens.

All the passwords for access sent over the web, or through the network shall be encrypted and authenticated before authorization is given.

Users shall be required to log into the system for all system operations with the event log showing all the users online.

Only users who have been authorized to access the software over the web or PDA shall be allowed to do so.

Maintainability

The software shall be able to be maintained by its end users fully trained for the purpose.

There shall be enough documentation for system administrators to be able to use the product.

Every registered user shall have access tour help site via the Internet.

Management Factors in Safety

Analysts of Industrial disaster have shown that these are not simply a consequence of technical failure or human error. Underlying causes may lie deeply rooted in the management aspects of the organizational aspects of the organization, such as company policy, management style, communication or procedures. Two lines of development have been identified (1) The Smart Model (2) The Smart Tools. The Smart Model is the Framework, which describes the casual relationship between management factors and safety. It is intended to improve awareness at all levels of company management with respect to the impact of decisions in safety. The smart tools are of more instrumental nature, consisting of assessment guidelines and associated instruments, which will give confidence in the completeness and effectiveness of an organization's management safety.

Fundamentals of the Smart Framework Model

Management decisions making is influenced by various factors, such as time, variation of the environment, external influences, internal organization matters. These constraints may influence decision-making process in such a way that the eventual decisions cause the introduction of additional risks.

Hypotheses and Statements

The smart framework combines existing insights from various disciplines, such as organizational theory and accident analysis to evolve a set of hypotheses and statements.

Different types of organization exist. Each Type of organization can achieve a high level of safety.

There is a limited number of fundamental organizational requirements with respect to safety, which should be taken into account to achieve this level of safety.

The way of implementing the organizational requirements i.e. the approach to improve safety, must match the characteristics of the organization.

There exist two kinds of failures, symptom failures (token) and type (root) failures.

Organizational requirements which have not been taken care of in a sufficient way are strongly related to type failures.

Associated with the distinction between token and type failures. Two kinds of failure are distinguishable in managerial decision making.

Decisions that are focused on resolving token failures or characterized by an inadequate balance between resolving type failures and addressing considerations or external pressures (What is decided is wrong).

The way of implementing decisions is characterized by an insufficient balance between organizational requirements for safety and organizational requirements for safety and organizational characteristics, either when managers are not aware of this relationship or when managers are not able to find the right balance between these two aspects.

The Management Circle is a concept where Policy leads to Decisions, which lead to Actions, which lead to Control, which further lead to Policy.

There are a number of external pressures which influence managerial decision making.

Structure of the Smart Framework

The smart framework is based on the following cornerstone, shown in FIG. 19 which originate from

Management Circle.

Fundamental Organization requirements with respect to safety.

Organizational Characteristics.

External Pressures.

Management Cycle

Since safety is an integral part of all business activities, it should be managed in the same way as all other activities. Thus, the management cycle appears in the center of framework. The management cycle express managerial activities, which are inherent to the tasks and function of management.

Fundamental Requirements

Managing Safety is an integral part and essential part in managing a successful enterprise. Three different aspects of safety are distinguished
The necessity of an integral approach to safety
Commitment of Management to Safety
Risk Awareness

The way a group or organizational may react to abnormal or crises situation to achieve the goal of safety involves

Provision of adequate resources
Allocation of tasks and responsibilities

### Coordination and Communication

### Short Term Intervention and Recovery Possibilities

Organizational Characteristics

The organizational characteristics are

### Organizational Structure

### Organizational Culture

### History of the Organization

Mintzbergs (1) theory on the structures of organization, distinguishes five key dimensions, which are relevant for organization functioning and design

### Coordinating Mechanism

### Basic Parts o Organization

Systems of flow

### Design Parameters

### Contingency Factors

Harrison (2) provides useful approach for identifying and categorizing organizational culture. They are

### Power Orientation

### Role Orientation

### Tasks Orientation

### Person Orientation

External Pressure

External Pressure may affect decisions of management with respect of resources, design, expectations, standards and priorities

Commercial and Financial Constraints

Legal and Political Constraints

Social and Culture

Physical and Geographical Constraints

Other External Factors

2.0 Reliability Engineering

### 1. Definitions

(1) Component is the basic unit of the system. A component may be a system in another context
(2) A mission is the objective, tasks, or purpose of a system or component
(3) A fault is a non-compliance with specifications
(4) Failure is the inability of a component to perform its intended function as specified. A component may function, but if it does not function as specified it as a failure
(5) Failure mode is used to refer to the possible ways in which a component may fail e.g. the possible ways through which the piping system could fail (failure modes) include pipe rupture, pipe clogging and pipe leakages
(6) A component is said to be in a normal state if it is not in a failed state

Basic failures refer to failures that are not broken down to contributory failures.

The interval is represented thus

(t₁,t₂)t₁≦t≦t₂

(t₁,t₂)t₁<t<t₂

(t₁,t₂)t₁<t≦t₂

(8) A component is a repairable component if it is repaired upon detection of its failure. Replacement is equivalent to repair in the context of reliability analysis.
(9) A non-repairable component is not possible to repair after failure is detected
(10) Policy requirement may make a repairable component irreparable
(11) Reliability: Component reliability at time t is the probability that the component is in its normal state from time o to time t. A component may have more than one function and different reliabilities are associated with different function
(12) Unreliability is the complement of reliability. If the reliability at the time t is r(t), then the unreliability at time t, denoted by u(t)

u(t)=1−r(t)

(13) Availability at time t is the probability that the component is in its normal state at time t,given that it was new or as good as new at time zero.
(14) Unavailability is the complement of availability. If the availability at time t is a (t), then the unavailability at time t, denoted by q(t) is given by

q(t)=1−a(t)

(15) Reliability at time t is identical to availability at time t for a non repairable component
(16) Consider N identical components. All the N components are new or as good as new at time zero. Let N-n components fail anytime between 0 and t. Reliability of the component at time t is given by

$$r ( t ) = \frac{n}{N}$$

(17) Cumulative failure probability at time t refer to as failure probability at time t refer to as failure probability at time t is equal to the unreliability at time t

$$f ( t ) = u ( t ) = \frac{N - n}{N} = 1 - r ( t )$$

(18) The reliability can be defined as

r(t)=P(t<t′)

That is, the reliability of a component at time t is equal to the Probability that time t is less than the random variable t′ at which component fails.
(19) Similarly the failure probability or unreliability at time t is given by

f(t)=u(t)=P(t′≦t)

$$r ( t ) = \frac{[ \begin{matrix}Number of Components that are in their \\ normal state from time o to time t\end{matrix} ]}{[ \begin{matrix}Total Number of Components that wer new or \\ as good as new at time zero\end{matrix} ]}$$

$$f ( t ) = 1 - r ( t )$$

(21) The failure probability density function f(t) is the derivative of the cumulative failure probability distribution function f(t) with respect to t

$$f ( t ) = \frac{d F ( t )}{d t} = \frac{d u ( t )}{d t}$$

$$f ( t ) = - \frac{d r ( t )}{d t}$$

The quantity f(t)dt is equal to the probability that the component will fail during the time internal between t and t+dt

(22) The expected life of a component is the effected value of the time at which the component fails given that it was new or as good as new at time zero

$$Mean Time to Failure ( MTTF ) = {\int }_{0}^{∞} r ( t ) d t$$

Alternatively if we test a number of components to failure or observed the failure of a number of components in the field and determine the life (time to failure) of each component (MTTF) is computed as the average of those values

(23) Expected Number of failures (ENF) over the time interval between t1 and t2, given that the component was new or as good as new at time zero is denoted by ω(t₁,t₂) or ENF(t₁,t₂). The expected number of failures of a non-repairable component between 0 and t is equal to the component unreliability at time t

w(0,t)=ENF(0,t)=u(t)

(24) Time has broad meaning, time may be stated as (hours, days, years) or in terms of number of missions, number of cycles of operations, number of demands
(25) The rate at which failure occurs during a specified interval of time is called the failure rate during that interval. The failure rate 2 between interval t1 and t2 is given by

$$g ( {t}_{1} , {t}_{2} ) = \frac{r ( {t}_{1} ) - r ( {t}_{2} )}{r ( {t}_{1} ) ( {t}_{2} - {t}_{1} )}$$

(26) Constant hazard rate is also referred to in the literature as the failure rate.

The hazard rate at time t denoted by h(t) is the failure rate during the time interval from t to t+Δt, in the limit Δt tends to zero

$$h ( t ) = {Limit}_{Δ t \to 0} [ \frac{r ( t ) - r ( t + Δ t )}{Δ t r ( t )} ] = \frac{f ( t )}{r ( t )}$$

The hazard rate is also known as the instantaneous failure rate and as the hazard function. The hazard rate of a component at time t is also defined as the number of failures per unit time at time t divided by the number of components in their normal state at time t

$$h ( t ) = {Limit}_{Δ t \to 0} [ \frac{n ( t ) - n ( t + Δ t )}{Δ t r ( t )} ] = \frac{f ( t )}{r ( t )}$$

n(t) is the number of components in their normal state at time t. Dividing numerator and denominator by N and equation 2 results in equation 1. A third definition used by analyst, the hazard rate at time t is the rate of change of the conditional probability of failure at time t given that the component is in the normal state at time t

(27) The failure probability density function is given by at time t.

$$f ( t ) = \frac{n ( t )}{N}$$

n(t)=Failure per unit time at time t

N=Number of Components at time zero

Whereas the hazard function at time is given by

The failure probability density function uses the total number of component as normalizing factor.

The FPSO components are:

1. The hull—which contains equipment for oil storage and offloading, accommodation and utilities, heliport, and foundations for topsides, moorings and risers
2. Topsides-the topsides production facilities are designed to process the incoming reservoir stream from the oil field and the layout of the topsides ensures adequate operational and maintenance access
3. Moorings-The vessel is held in place by the mooring system which fixes the vessel heading and limits its excursion due to environmental loads. The mooring system could either be turret mooring systems (used in harsh environment) or spread-moored system often employed in more benign environments.
4. Risers-The export and import risers are attached along both sides of the ship.

The FPSO can be applied in a wide range of water depths and across the full range of environmental conditions. It is a very flexible and economic solution and can be installed in new fields remarkably quickly. The major attraction of the FPSO is that it is a self contained production facility, with its own on board crude storage, which, at the end of useful field life, can be relocated relatively to a new field.

The FPSO is a very complex system involving a lot of risks. Some of the features that make it complicated are;

The vessel is permanently stored in a fixed location, and so must survive the worst weather condition at that location.

Process equipment on deck is vulnerable to green water damage, with potentially dangerous consequences

Being ship shaped, environmental forces and motions vary greatly depending on relative heading to the weather

The vessel will often change heading in order to face in a favorable direction to the weather

The FPSO motions and excursions are the controlling design parameters for the associated riser system

System Fault Tree Analysis of the FPSO Flow Lines and Risers.

System Description

The flow line and riser system connects the wellheads to the processing facilities on the FPSO. A riser provides the flow paths between flow lines on the sea bed and the FPSO; while a flow line connects the subsea wells with the risers. The general functions of the flow line and riser system are listed below;

1. Assure safe transportation of produced fluids from the well heads to the FPSO.
2. Be compatible with the transported fluid, in particular regarding CO2, H2S, and Well treatment chemicals
3. Enable safe transportation of injection water from FPSO to the injector wells
4. Withstand environmental and operational loads

The flow line and riser system is made up of four component sub systems namely:

A. Export risers-the export riser takes gas directly from the sub sea wells to the FPSO where it is exported
B. Production flow line and risers-transport crude from the sub sea wells to the FPSO for storage and processing
C. sub sea gas injection risers
D. sub sea water injection risers

Sub sea gas and water injection risers do not transport any crude to the FPSO they work in series with the production risers. Their function is to ensure that the production risers transport crude to the FPSO at good operating conditions. For the gas and water injectors, the flow is towards the wells, pumping gas and water respectively to ensure the crude comes out of the wells. Water injection flow lines and risers will see a reverse flow during certain operations. Also, a back-flow of corrosive wet gas may occur for up to for up to 24 hrs/month into the gas injection flow lines and risers.

The types of risks which can occur in the system are as follows

Process risks—which arise as a result of the reactions/processes taking place within the pipeline network.

Mechanical risks—this is as a result of machinery and equipment failure due to certain factors.

Operational risks—which occur during the course of operating the system

Human risk—this occurs due to the negligence or oversight of the people operating the system.

Fault Tree Analysis of the FPSO Flow Line and Riser System

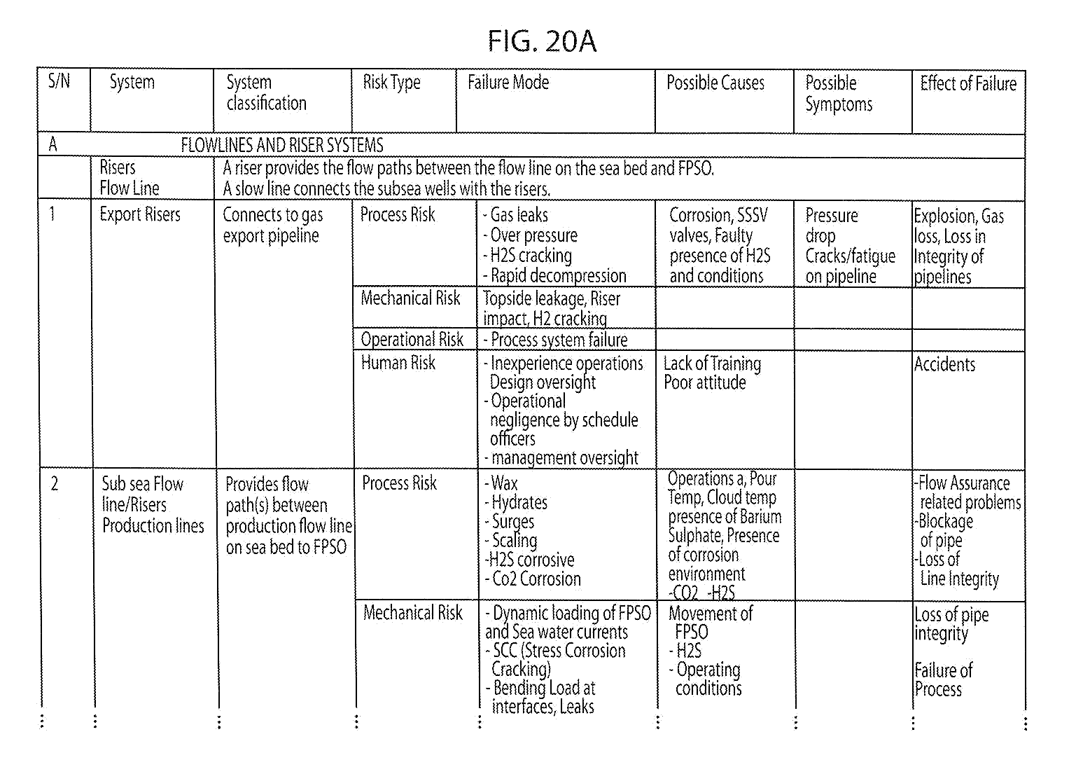

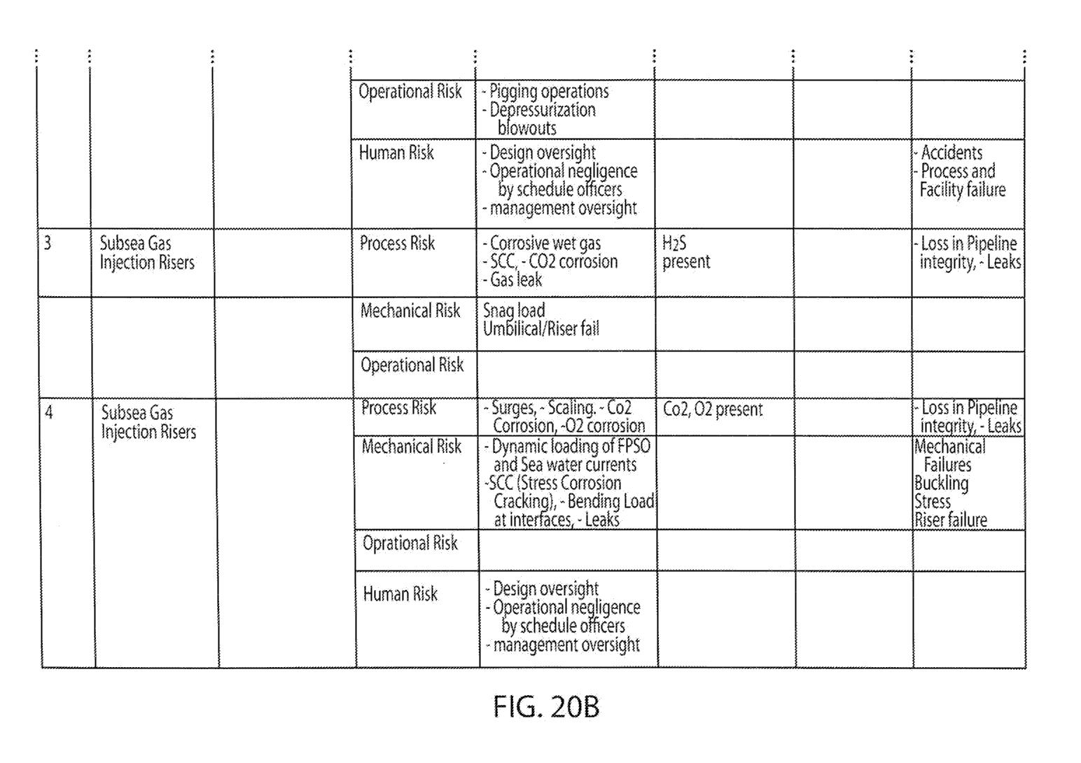

Data in table 3.0 was used in the development of the fault tree FIG. 20. In constructing this fault tree the TOP EVENT was defined as ‘Production target of crude to be delivered to the FPSO is not achieved’. The top event (failure) was then traced down to more causes at progressively lower levels down to the basic events(primary causes). Each event was then given an estimated probability of occurrence which was then used in the construction of the quantitative fault tree diagram (FIG. 3.1).

Quantifying the Probability of Events in the Fault Tree.

All the events were assigned risk probabilities [numerical values to be obtained later], and will be used to calculate the probability of the top event of the fault tree occurring. The risk probability of each event occurring in the fault tree based on the Prime events are obtained using logic; to quantify an AND gate probability, the product of the individual PRIME event probabilities of occurrence is taken. Similarly to quantify an OR gate probability, the product of the probability of non-occurrence [that is, 1-probability of occurrence] of the individual PRIME events is taken and then subtracted from 1. This logic was used to obtain the risk probabilities of all the events in the fault tree diagram, these probabilities are in table 3.1

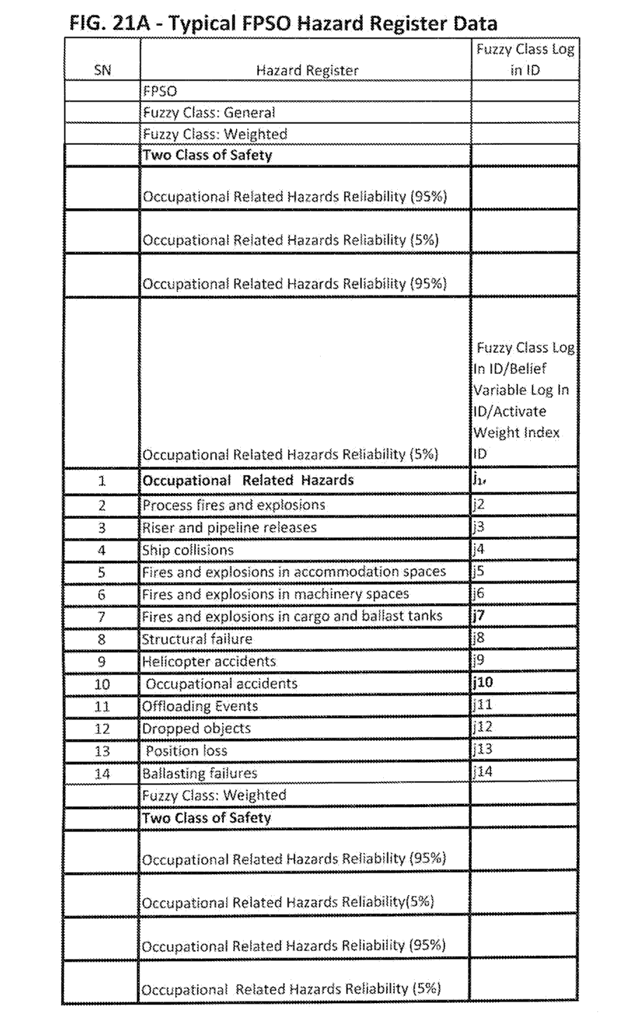

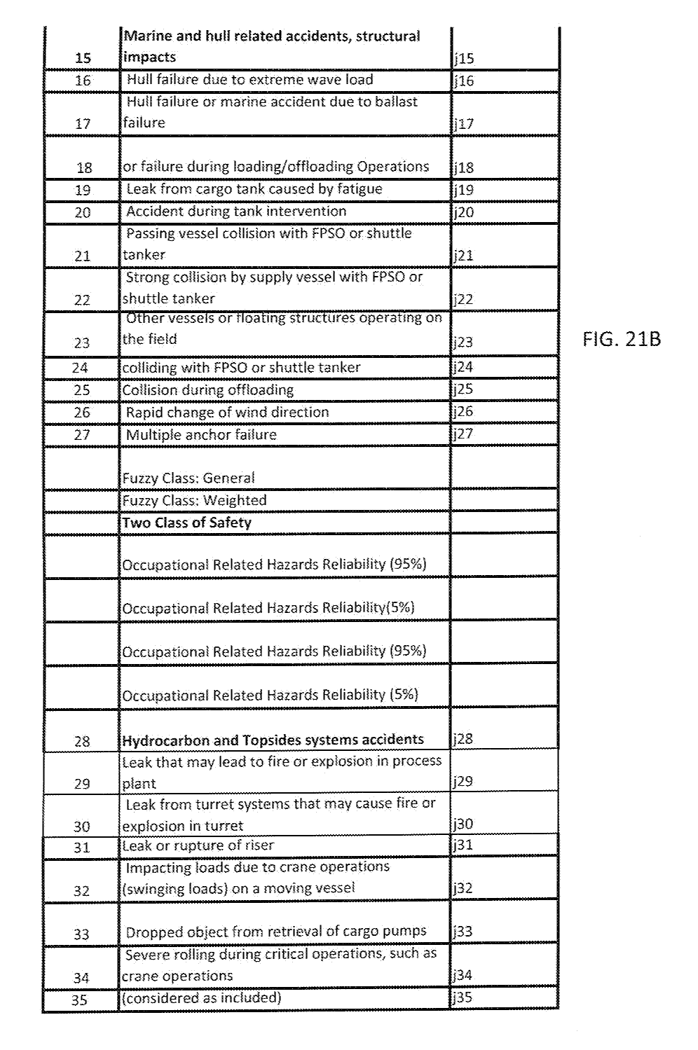

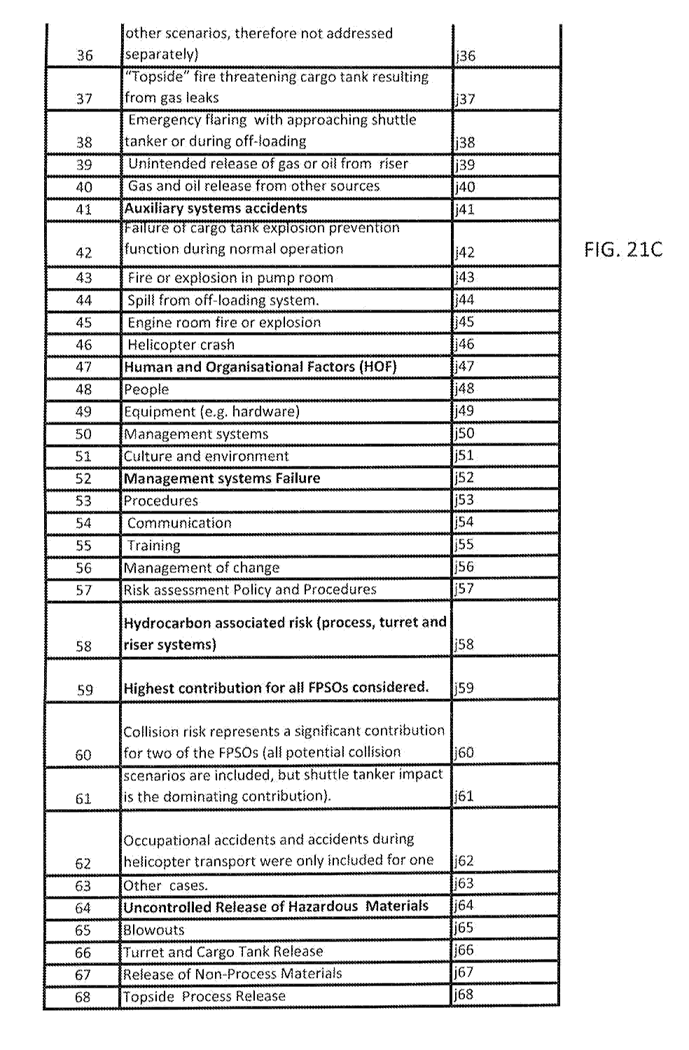

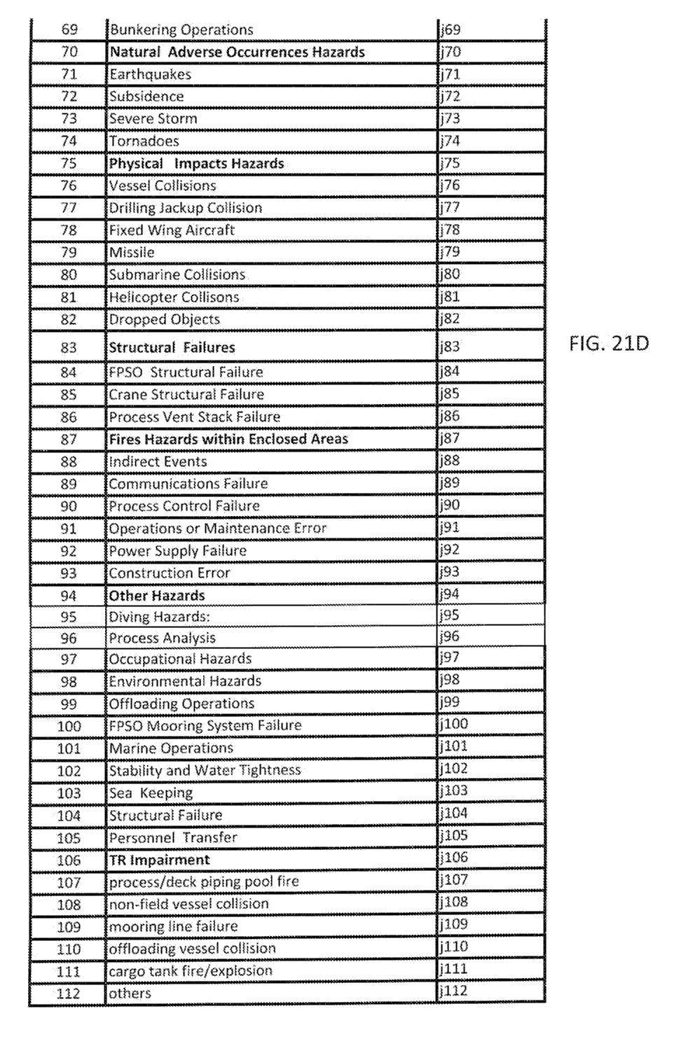

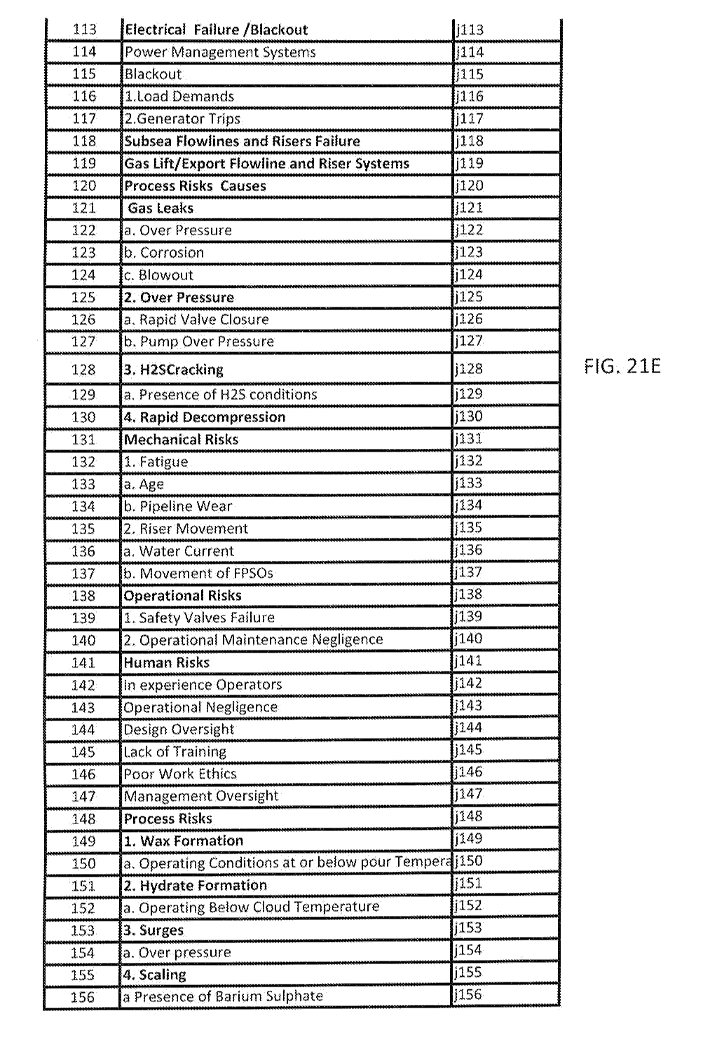

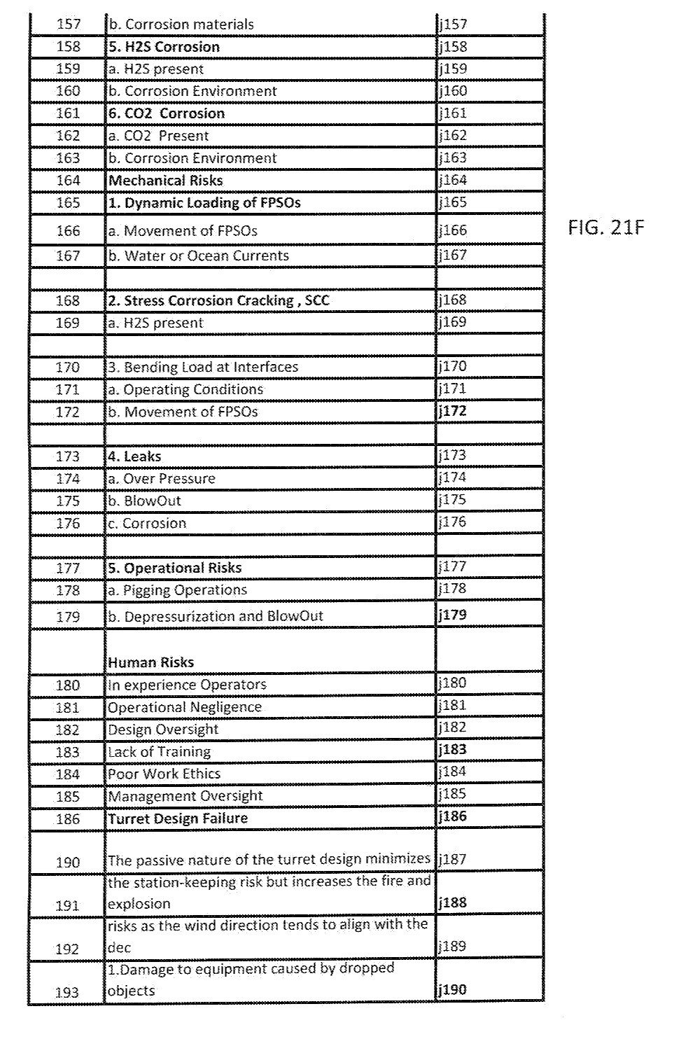

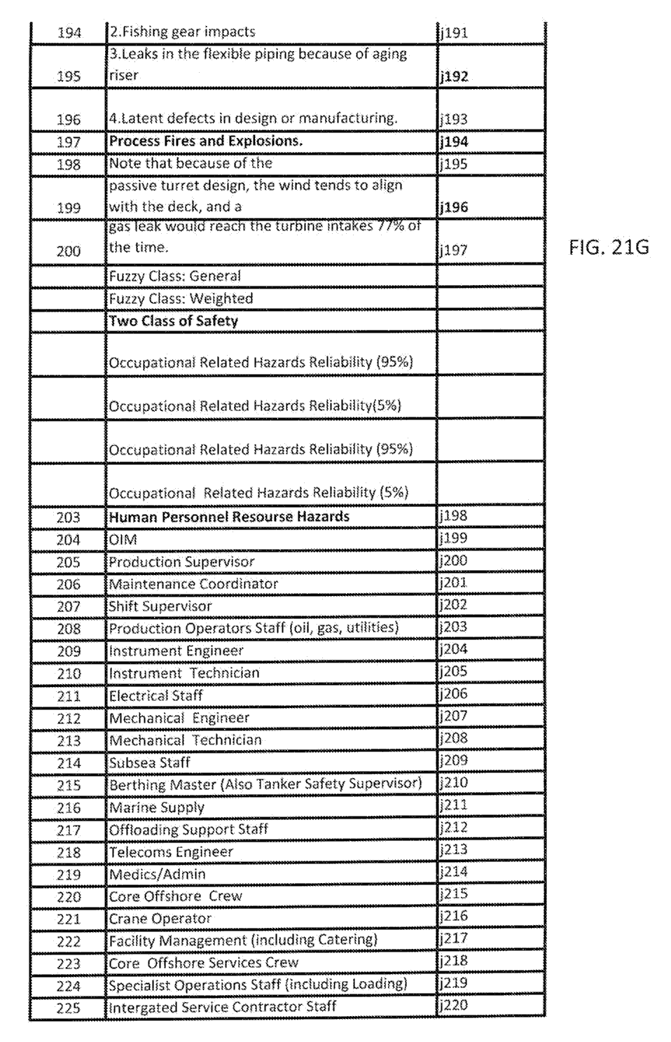

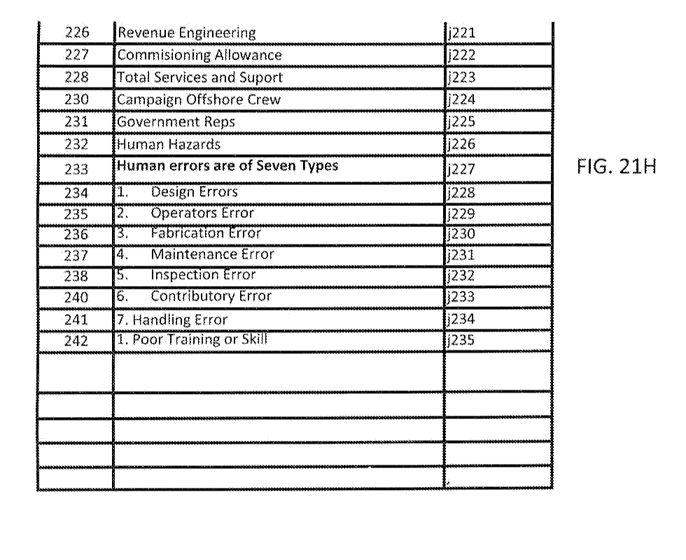

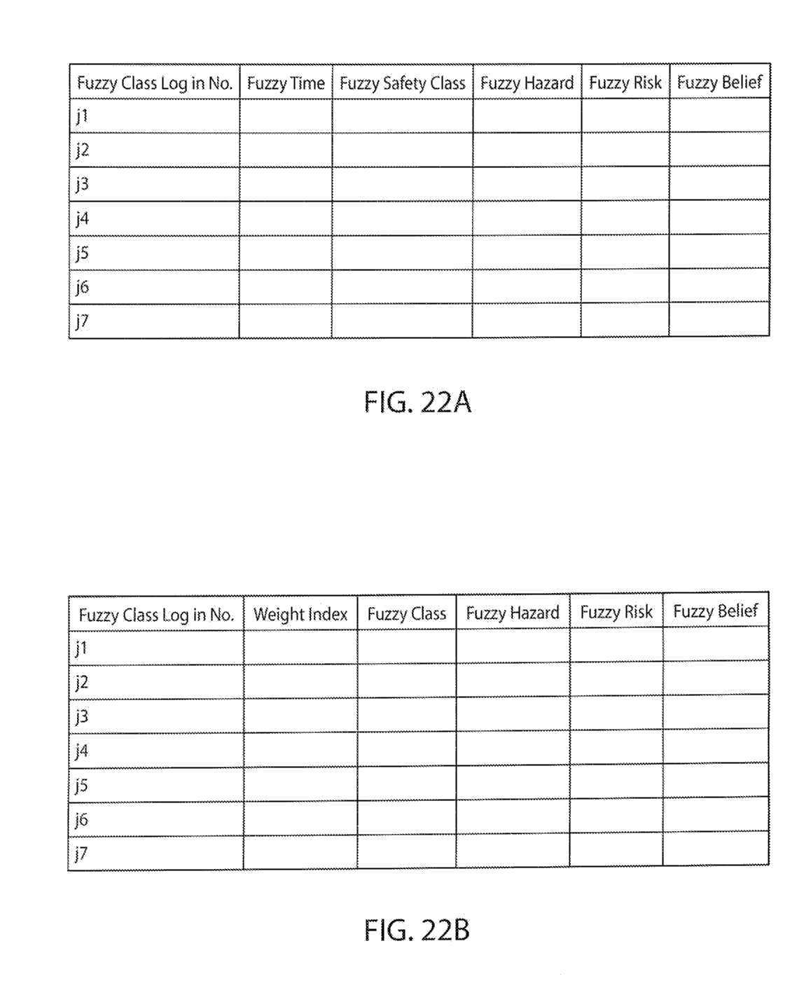

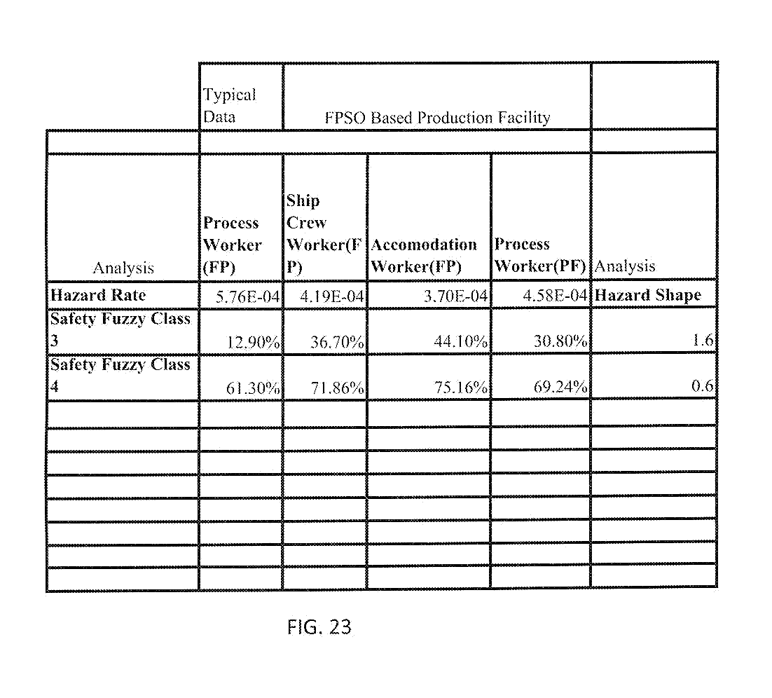

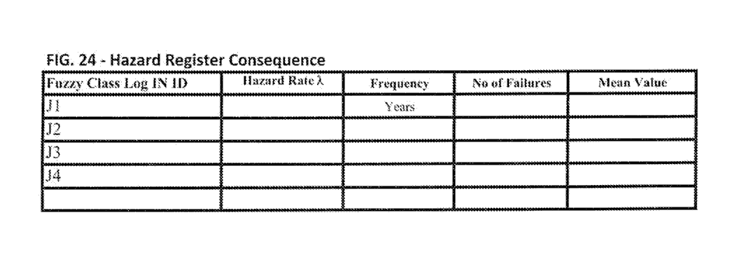

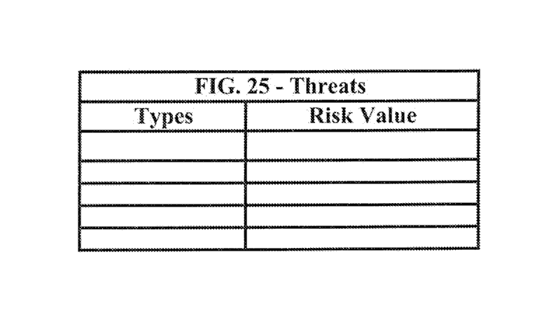

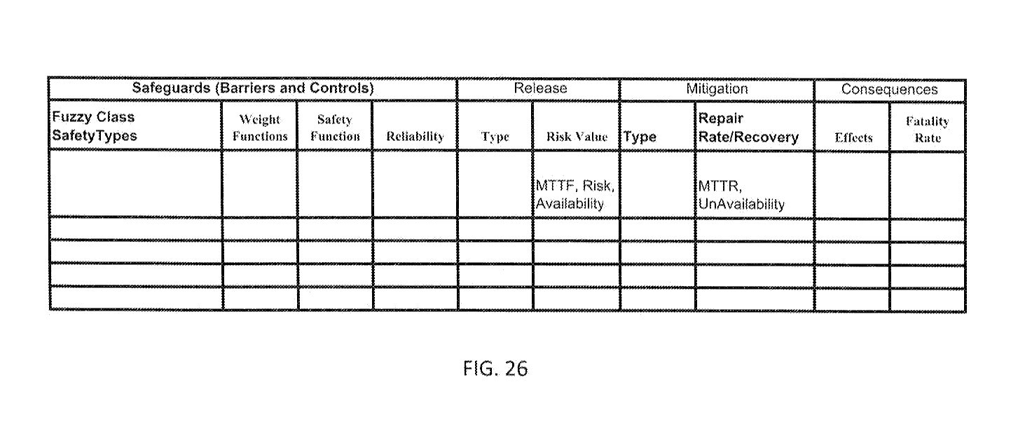

FIGS. 21A through 21H show a Typical FPSO Hazard Register Data. FIG. 22A shows a table with 6 columns, namely, Fuzzy Class Log in No, Fuzzy Time, Fuzzy Safety Class, Fuzzy Hazard, Fuzzy Risk and Fuzzy Belief. The table has 7 rows, namely j1 to j7. FIG. 22B shows a table with 6 columns, namely, Fuzzy Class Log in No, Weight Index, Fuzzy Class, Fuzzy Hazard, Fuzzy Risk, and Fuzzy Belief. The table has 7 rows, namely, j1 to j7. FIG. 23 is a table showing FPSO Based Production in Facility. The table has 4 columns, namely Process Worker (FP), Ship Crew Worker (FP), Accommodation Worker (FP) and Process Worker (PF). FIG. 24 show the Hazard Register Consequence. The table has 5 columns, namely Fuzzy Class Log IN ID, Hazard Rate, Frequency, No of Failures and Mean Value. FIG. 25 shows Threats. The table has two columns, namely Types and Risk Value. FIG. 26 is a table showing Safeguards (Barriers and Controls), Release, Mitigation and Consequences. Under Safeguards, there are 4 columns, namely Fuzzy Class Safety Types, Weight Functions, Safety Function and Reliability. Under Release are two column, namely Type and Risk Value. Under Risk Value is a cell containing MTFF, Risk and Availability. Under Mitigation, there are 2 columns, namely, Type and Repair Rate/Recovery. Under Repair Rate/Recovery is a cell containing MTTR, UnAvailability. Under Consequences are 2 columns, namely, Effects and Fatality Rate.

Hazard Weights Data for FPSO Bow Tie System

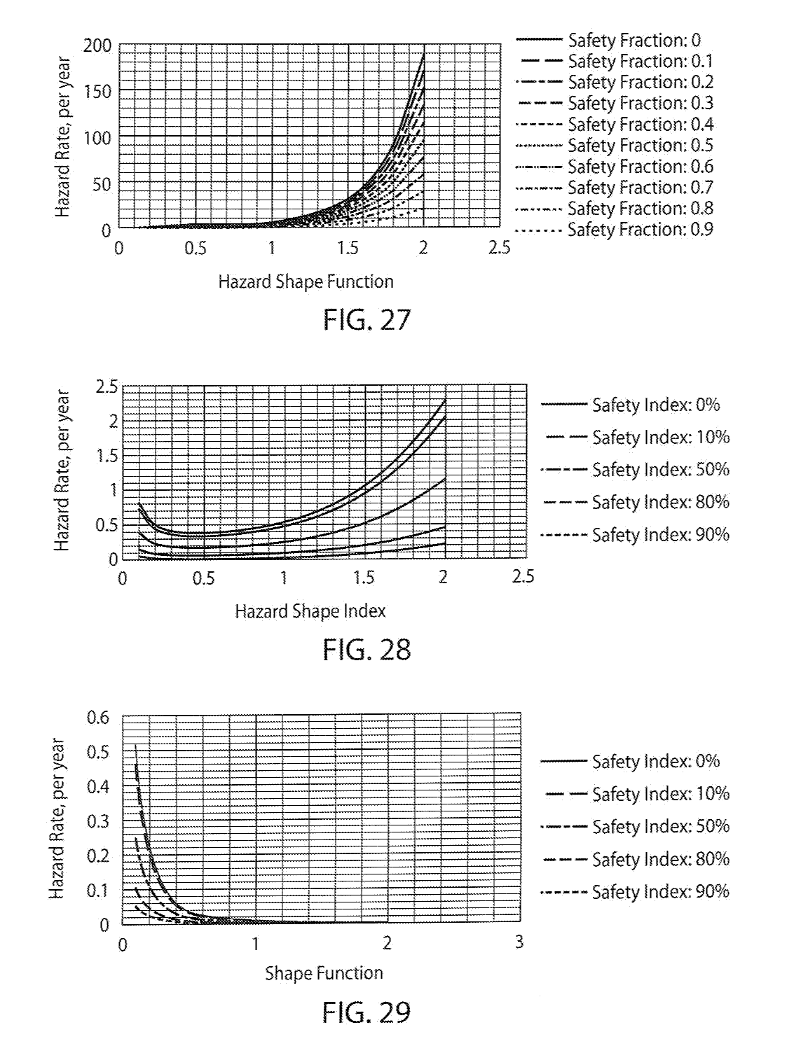

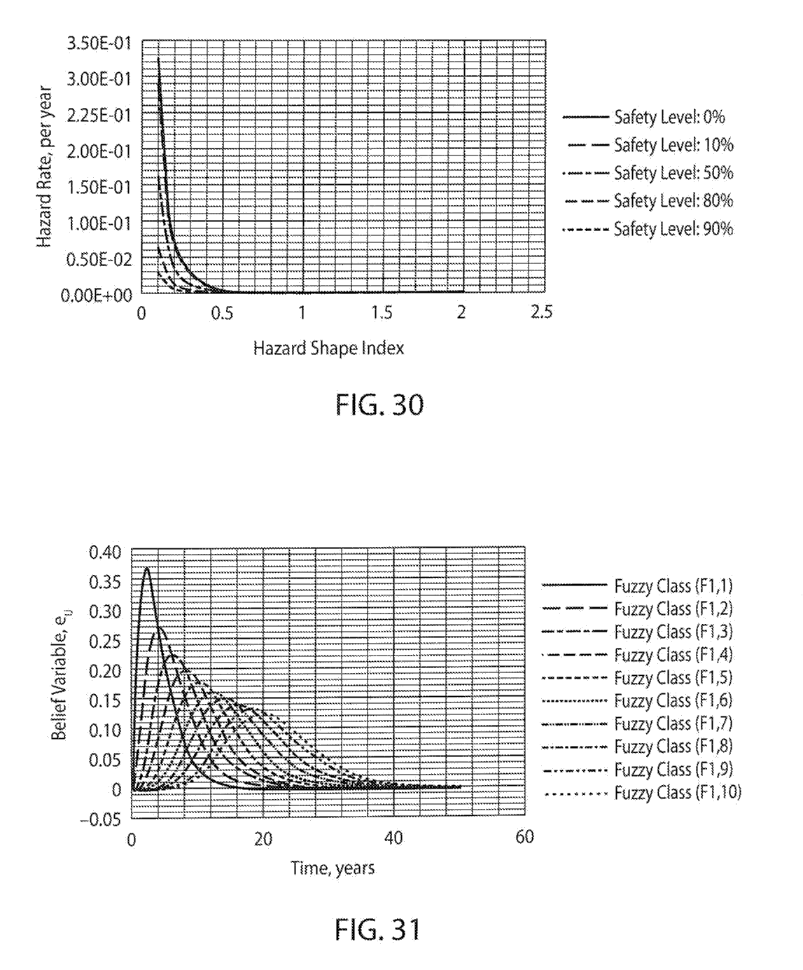

FIG. 8A shows the weight index for different class of safety fraction for fuzzy class 1 (very likely to occur). The weight index for all safety index increases exponentially as the Hazard shape index increases from 0 to 2.0, where safety fraction 0 or 0% shows highest increase than a safety fraction of 0.8; 80% showing least increase.
The simulated weight data for bowtie system is presented in FIG. 8A (Table 1.0). The data connects hazard shape index and its safety index to generate associated weight index. The weight index simulated is used in generating hazard rate data for Fuzzy Classes (1, 2, 3, 4) which are presented in FIG. 8A (Table 1), FIG. 8B (Table 2.0), FIG. 8C (Table 3.0) and FIG. 8D (Table 4.0). The simulated weight index data used for simulation studies is linked with the corresponding hazard shape index and its corresponding safety index used to derive it. From the tabulated values, it is clear that, the Hazard rate decreases with increasing safety index and hazard shape index.
1.1.2 Plots of Hazard Rate with Shape Functions for different Fuzzy Class and Safety Fraction Index for the Bow Tie Case.
FIG. 27 shows the equivalent hazard rate for fuzzy class 1, while FIG. 28 and FIG. 29 shows the Hazard Rate with Shape Function for Fuzzy class 2 and Fuzzy class 3 respectively. For Fuzzy Class 1; there is an exponential increase of Hazard Rate as the Hazard shape function constant and safety fraction increases. However as the Fuzzy Class changes; the shape of the plots changes; with a complete total reversal for Fuzzy class 3; where the hazard rate is unlikely to occur. This complete reversal as the Fuzzy class graduates from very likely to occur (Fuzzy class 1) to unlikely (Fuzzy class 3) is apparent. The trend progress as shown in FIG. 30, however the exponential plots becoming less steep as it graduates to Fuzzy class 4 (very unlikely to occur). This reversal of as the Fuzzy class graduates plots shows the importance of class differentiation in the shapes of hazard rates as the Hazard Shape Function value increases.

### 1.1.3 Plot of Belief Variable for Fuzzy Class 1 at Safety Index 0% & 90%

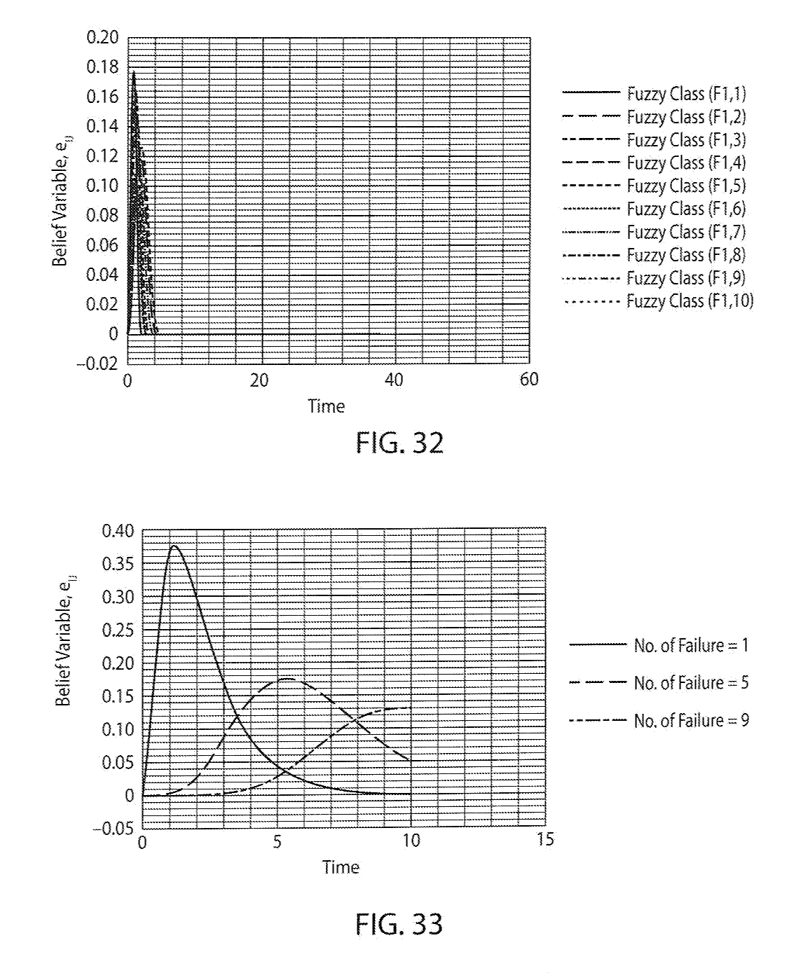

FIG. 31 shows the belief Profile for Fuzzy class 1 with 90% safety index and FIG. 32 with 0% safety index for failure 1 to 10 for a hazard shape index=1.0. The belief variable is a measure of the index of certainty that within a particular time, the probability of occurrence is high. The belief variable represents the uncertainty an expert associates with an input data. It is obvious for a maximum safety index 90% there is a parabolic evenly spread shape profile of belief variable with time than for the case with safe index of 0%, which only steeps to a maximum peak within the first few years and tapers to zero after 4 years. It is also clear that as time progress the belief variable becomes increasingly small. The distinction between plot shape profile of FIG. 31 and FIG. 32 demonstrates the importance of weight index or safety in belief variable perception. The belief variable is correspondingly higher as safety index increases and comparatively takes a longer time to taper for higher safety index.

### 1.1.4 Plot of Belief Variable for Fuzzy Class 1 for Safety Index 0%, 50% and 90% for (1,5,9) no of Failures for Different Class of Hazard Shape Index (0.4,1.0,1.4)

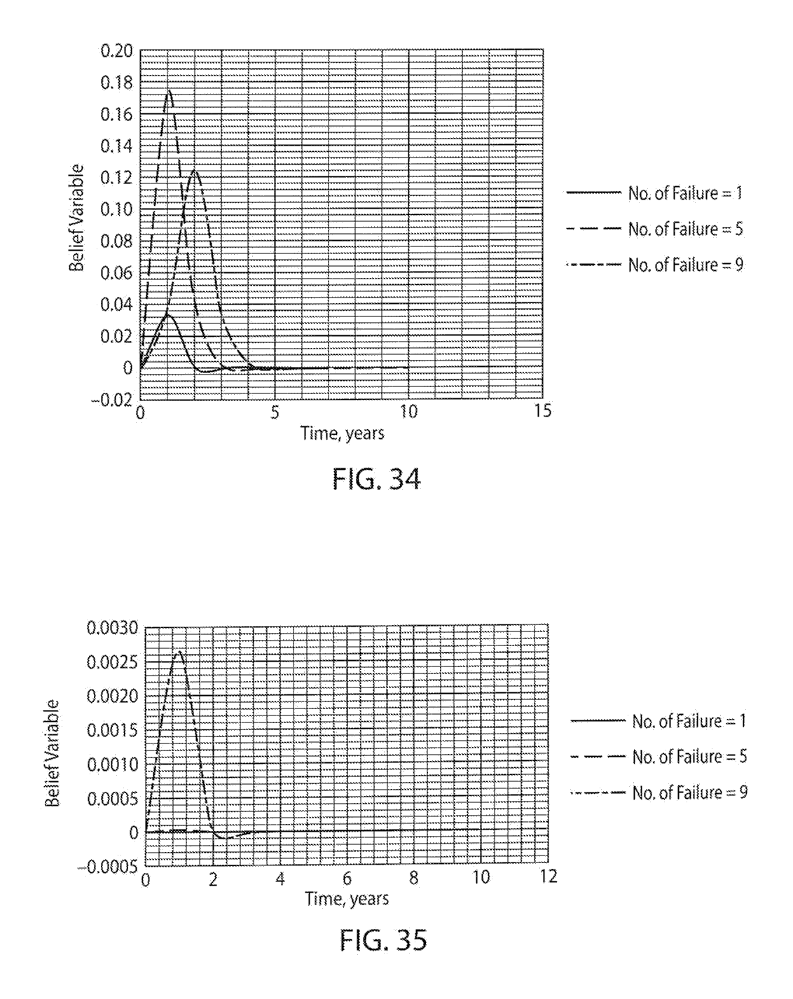

FIG. 33, FIG. 34 and FIG. 35 shows Belief Variable Profile with time for a system which has a hazard shape index=0.4, hazard shape index=1.0, hazard shape index=1.4 for no of failures 1,5,9 and for 0% safety index, that is belief system for risk components which has no safety to protect it. It is clear for a hazard shape index=0.4, the belief is such that for failure of 1,the belief profile increases to a maximum after 2.5 years and decreases as time progress becoming zero at after 8-10 years. But as the failures increases to 5, the maximum belief is lower peaking after years and decreases to 0.5-1% between 8-10 years. As the No of failure reaches 9, the belief increases exponentially after 3 years been zero prior. As the hazard shape index becomes 1, the constant shape index, the profiling is slightly different with all failures increasing exponentially from zero, peaking at a maximum and decreasing to zero at 5 years. The failure with no 5 has the highest belief at the shortest time frame being 17.5% at 1 year, 12% at 2 years if failure no increases to 9 and 3% at 1 year, if the hazard shape index increases from 1 to 1.4, a reversal of trend occurs as belief becomes progressively smaller as the failure nos decreases from 9 to 1.

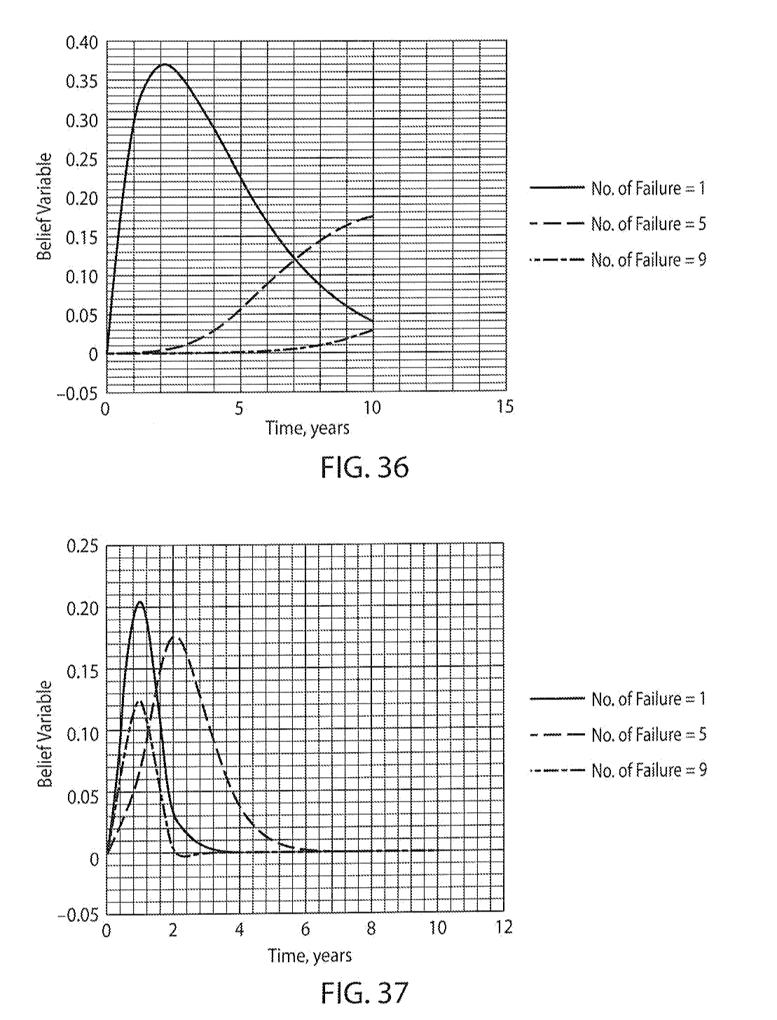

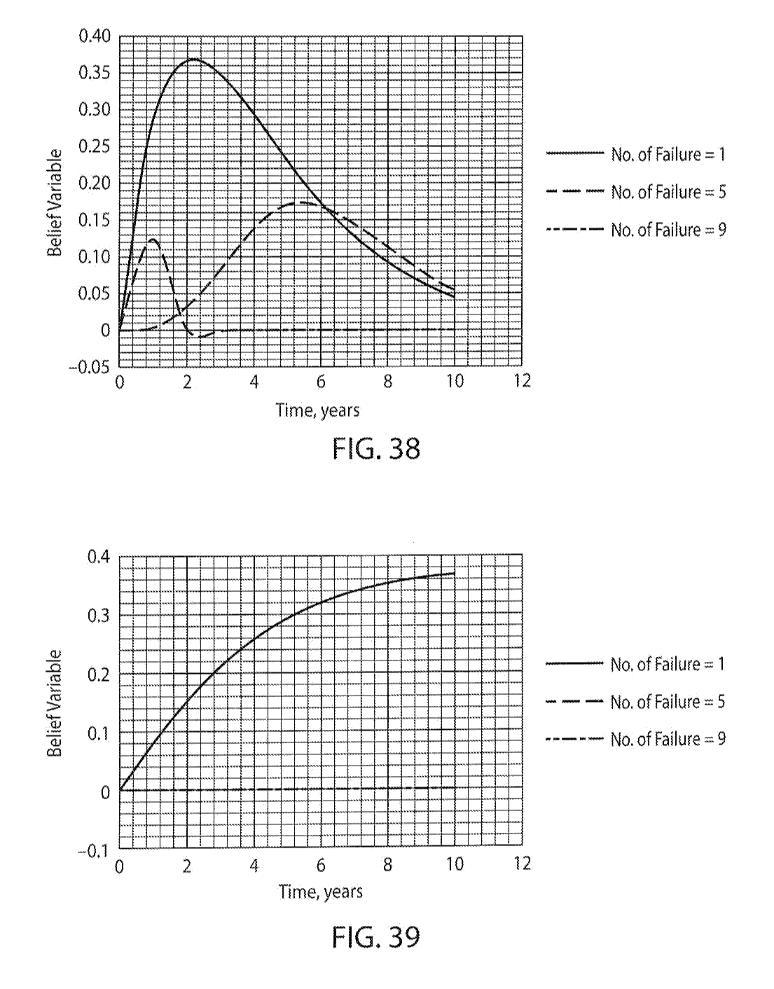

What is the effect if the safety index is increased to 50%, FIG. 36 to FIG. 38 shows different class of belief variable for different class of Hazard Shape Index for different no of failures for increase safety is 50%. It is clear that the different shape profile reflects different degree of belief as the no of failures increase from 1 to 5 then to 9. FIG. 36 shows a parabolic profile for no of failure 1, exponential for failure 5 with a lower belief being constant at zero value from time 0 to 2 years, whereas for failure no 5 being constant from 0 to 5 years and then increases exponentially with a much lesser belief than for 5 years for the decreasing hazard shape index=0.4. But as the Hazard shape index=1 being the constant hazard shape critical index, there is a belief profile which is parabolic being maximum at 1 year for no of failures of 1 and failures being maximum 2 years being for no of failures being 9. For Hazard shape index, the profile spreads uniformly but the belief range spreads more that is more belief is observed over a longer period for the increasing hazard shape index of 1.4

What if the safety index is increased to 90% with the no of failures being 1,5,9, the belief variable with time is exponential for no of failure being 1 and 0 as failure increases to 5, and 9. The results of simulation are provided in FIG. 39, FIG. 40 and FIG. 41. These are for cases with the hazard shape index factor of 0.4, 1 and 1.4. As the hazard shape index becomes 1, the belief becomes more parabolical for failure 1 and exponential as it increases to 5, and 9. Similarly if the hazard shape index is increased to 1.4, the parabolic nature becomes more defined. While the belief for hazard index less than 1(0.4) decreasing hazard index is much more exponential with a value reaching 0.35 (35%) after 10 yrs for failure of 1 and zero as failures increases from 5 to 9 for safety level of 90%. For hazard index=1, constant level the belief level is much more pronounced than that for other hazard shape index, where for failure equal to 1, it is akin to being parabolic peaking at 0.38 (38%), and transiting from zero up to a threshold time from where they begin to increase exponentially up to 0.18 (18%) for no of failures to be 5 and 0.05(5%) for no of failures to be 9. The parabolic profile are pronounced peaking 0.28 (28%) for failure 1, 0.18(18%) for failure 2 and 0.13 (13%) failure 3.

### 6.2.1 Plot of Belief Variable for Fuzzy Class 2 and 3 for Safety Index 0% & 90%

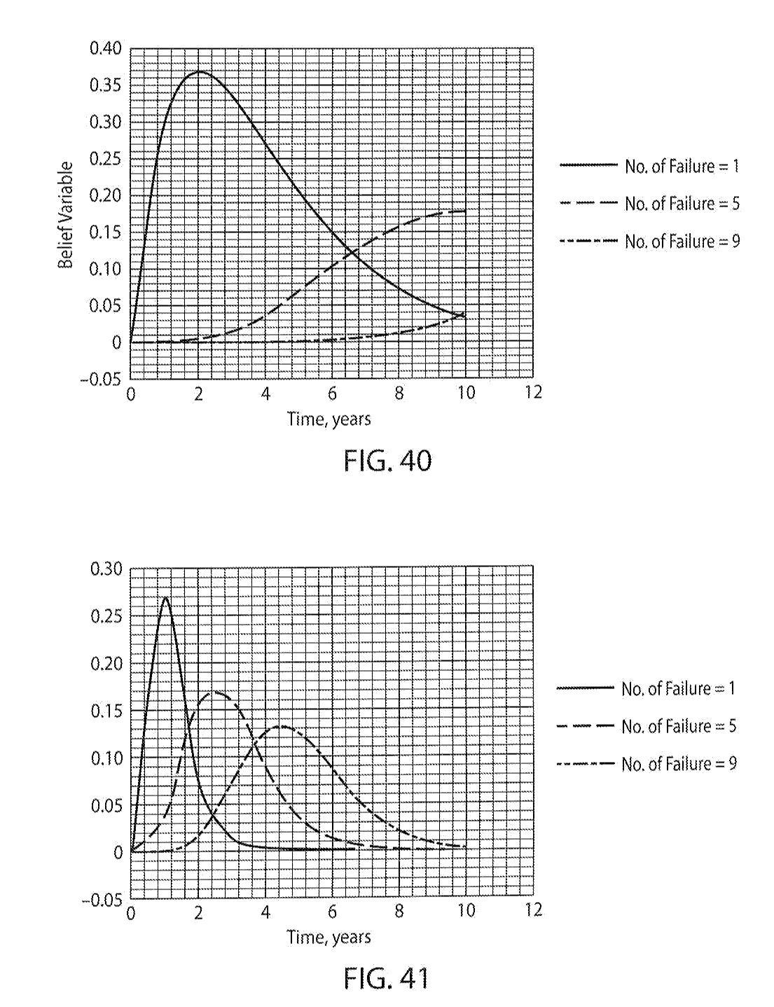

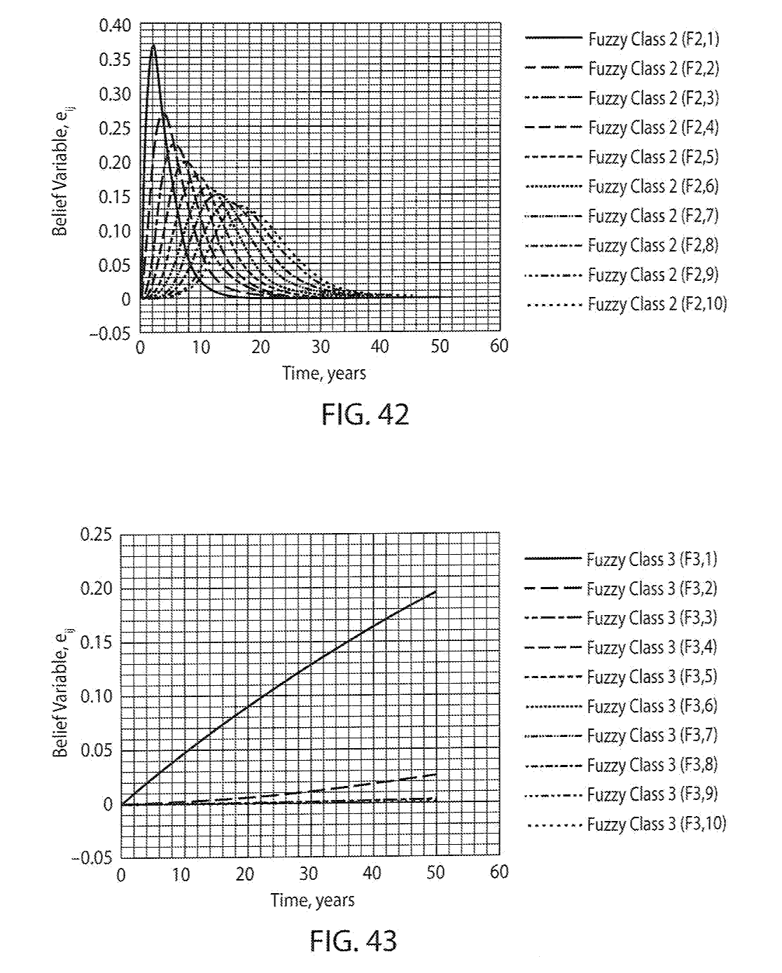

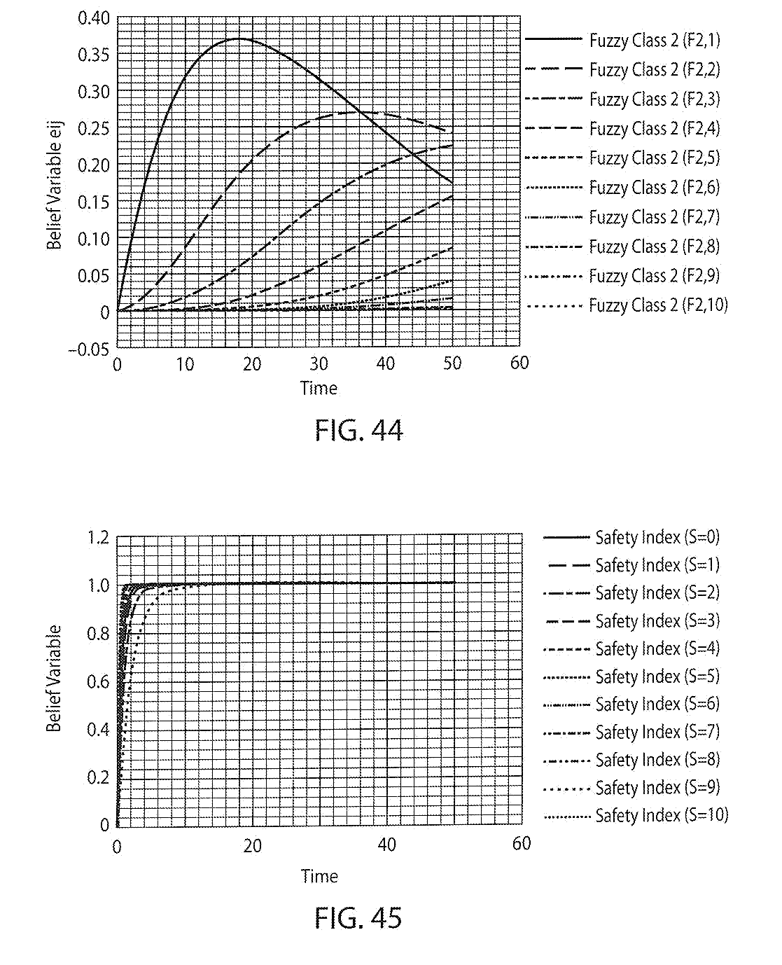

FIG. 42 shows the belief variable plots with time. It is clear with zero % safety, the belief variable with 1 no of failures than when there are 10 failures. The plots of FIG. 43 are largely linear, but as safety index increase 90%, the plots become separate and parabolic in nature. For safety index of 90% as shown in FIG. 44, the belief variable increases with time and peak at a maximum value, and decreases for the remainder of time. Also as the no of failures increases, the belief becomes progressively smaller. This is typical indicating that as failures increases in the system, the belief is a function of the no of failures.

### 6.3 Risk Variable for Different Safety Index

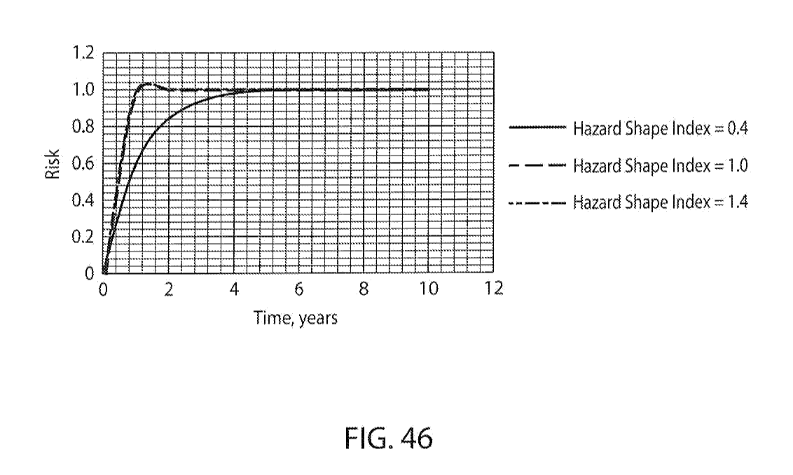

FIG. 45 shows a plot of the risk in a system with time in relationship to the safety index for hazards that are likely to occur, fuzzy class 1 and a shape function 1.0. It is obvious from plots that Risk increases exponentially with time but decreases as the safety index increases. FIG. 46 shows the increase exponentially of risk with time for safety that is non-existent 0% for all hazard indexes. It is clear for hazard shape index less than 1, that is for hazard shape index of 0.4, the risk profile with time is much less than for hazard shape index of 1.0 and 1.4. This is typical as the risk takes lesser values for lower hazard shape index.

### CONCLUSIONS

The fuzzy class and belief systems couple with a weight index have been used to construct a numerical measure for risk and safety of FPSO systems. Several belief profiles with different index of safety of different hazard class was derived and plotted. The profiles of the belief variables peak a maximum as time progress and decreases with increases in the number of failures, diminishing to almost zero as time progress further and further. Since a belief is a measure of the level of certainty an expert assigns to the level of risk, it is clear that a parabolic profile peaking at a maximum in time reflects the belief is not a constant but increases initially as time progress until it peaks at a value from where its descent reflects its level of belief is reducing. Also with a larger number of failures from experience, the level of belief an expert assigns the level of threat is much reduced revealing that with increase no of failures level certainty of judgment reduces per time. This method provides numerical tools to designers and users of FPSO risk systems to ascertain which systems are more akin to failure with some level of accuracy and certainty justifying use of the probability distribution Poisson models originally used to describe belief of the systems. Also as safety index increases the hazard rate decreases hence providing a numerical measure of the bowtie controls in containing risks. These methods provide a method for the designers and user of FPSO systems who had no previous experience of the system, numerical tools to assist in making credible decisions related to the risk and safety of the systems without subjecting knowledge to historical data which may not be readily available.

While certain details have been shown and described with respect to hardware, system, and process steps, it should be understood that other options and variations may be incorporated within the spirit of the invention. Various storage devices, computer systems, software applications and telecommunications links may be used. The items of information can be captured by a variety of devices and communicated to the private servers by all current and future telecommunications means. The elements shown in the Figures may be implemented in various forms of hardware, software or combinations thereof. Preferably, these elements are implemented in software on one or more appropriately programmed general-purpose digital computers having a processor and memory and input/output interfaces.

Implementations of the present principles can take the form of an entirely hardware embodiment, an entirely software embodiment or an embodiment including both hardware and software elements. Certain aspects of the present invention involving data processing, sorting, comparing and identification steps are implemented in software, which includes but is not limited to firmware, resident software, microcode, etc.

The present principles may be implemented and can take the form of a computer program product accessible from a computer-usable or computer-readable medium providing program code for use by or in connection with a computer or any instruction execution system. For the purposes of this description, a computer-usable or computer readable medium can be any apparatus that may include, store, communicate, propagate, or transport the program for use by or in connection with the instruction execution system, apparatus, or device. The medium can be an electronic, magnetic, optical, or semiconductor system (or apparatus or device). Examples of a computer-readable medium include a semiconductor or solid state memory, magnetic tape, a removable computer diskette, a random access memory (RAM), a read-only memory (ROM), a rigid magnetic disk and an optical disk. Current examples of optical disks include compact disk—read only memory (CD-ROM), compact disk—read/write (CD-R/W) and DVD.

A data processing system suitable for storing and/or executing program code may include at least one processor coupled directly or indirectly to a server and memory elements through a system bus. The memory elements can include local memory employed during actual execution of the program code, bulk storage, and cache memories which provide temporary storage of at least some program code to reduce the number of times code is retrieved from bulk storage during execution. Input/output or I/O devices (including but not limited to keyboards, displays, pointing devices, etc.) may be coupled to the system either directly or through intervening I/O controllers. Network adapters may also be coupled to the system to enable the data processing system to become coupled to other data processing systems or remote printers, servers or storage devices through intervening private or public networks including satellite communication systems. Modems, cable modem and Ethernet cards are just a few of the currently available types of network adapters.

Having described preferred embodiments for processes, apparatus and systems used therein for predicting risk and designing safety management systems (which are intended to be illustrative and not limiting), it is noted that modifications and variations can be made by persons skilled in the art in light of the above teachings. The invention may be embodied in other specific forms without departing from its spirit or essential characteristics. The described examples are to be considered in all respects only as illustrative and not restrictive. The scope of the invention is, therefore, indicated by the appended claims rather than by the foregoing description. All changes which come within the meaning and range of equivalency of the claims are to be embraced within their scope. Having thus described the invention with the details and particularity required by the patent laws, what is claimed and desired protected by Letters Patent is set forth in the appended claims.

What is claimed is:

1. An apparatus for detecting faults and risk events of complex multifunctional systems and sub-systems arranged in a hierarchy comprising:
a plant having a pipeline layout design for transporting petroleum products in accordance with a plant process which comprises the systems and sub-systems in the hierarchy;
a sensor that measures operational and design variability of the systems and sub-systems in the hierarchy and provides sensor data output;
a memory device that stores a database and a set of instructions which are programmed to (i) analyze sensor data output and construct a Risk Safety Matrix System within the database having weights for each risk event, and (ii) provide a hazard chain modified safe bowtie system Hazard Risk HR-EFECT-COM-SAFE BOWTIE to identified all hazards, and analyzed threats, provide a safe index systems using the weight index to quantify the level of safety to control and manage the threats against release of containment from complex multifunctional systems and subsystems, wherein the weights are derived from a weight index in a fuzzy class belief variable in the Risk Safety Matrix System to assign the relative numerical value of a safety device.

2. The apparatus of claim 1, wherein the set of instructions are programmed to establish weights according to a Weighting Ranking Function used to construct a Fault Tree Weighted Superstructure that assigns relative weight to each Risk or Safety event in N-interacting Events, the weights being indicative of the safety index of the risk system.

3. The apparatus of claim 2, wherein the Weighting Ranking Function is variable in time, process and system type, operating conditions and environment allowing the capturing of the Overall Risk or Reliability of the system and subsystems.

4. The apparatus of claim 3, further comprising a history of Curve Failure data stored within the database that uses real time measurements from the sensor over a specified period of time.

5. The apparatus of claim 4, wherein the risk is assessed by neural networks and fuzzy belief systems in combination with the Weighting Ranking Function to collectively provide reliability modeling to implement the safety aspects to risk systems.

6. The apparatus of claim 5, wherein the fuzzy belief systems and neural network weights representing actual hazard data are used to construct hazard data from Monte-Carlo Simulations that are stored in the database.

7. The apparatus of claim 6, wherein the safety index is assessed on the basis of three fundamental parameters comprising (1) Failure Rate (FR), (2) Consequence Severity (CS), and (3) Failure Consequence Probability.

8. The apparatus of claim 7, wherein the Failure Rate (FR) is expressed as a Homogeneous Poisson Process (HPP) probability distribution function given by:
$$f ( n ) = \frac{{( {ω}_{avg} λ t )}^{n} exp ( - {ω}_{avg} λ t )}{n !} n = 0 , 1 , 2 … \qquad ( 7 )$$
t is the time and λ is the constant failure or arrival rate. The cumulative failure distribution function is given by
$$\begin{matrix}F = {\sum }_{i = 0}^{n} \frac{{( {ω}_{avg} λ t )}^{i} exp ( - {ω}_{avg} λ t )}{i !} & ( 8 ) \\ {R}_{st} ( t ) = {\sum }_{i = 0}^{n} \frac{{( {ω}_{avg} λ t )}^{i} {e}^{- λ {ω}_{vg} t}}{i !} . & ( 9 )\end{matrix}$$

9. The apparatus of claim 7, wherein the fuzzy belief systems include belief degrees in a rule that are accounted for by considering the relative weight of each rule among all rules (the rule weight), and the relative weight of each antecedent attribute (the attribute weight).

10. The apparatus of claim 9, wherein the weights representing the safety aspects, hazard shape functions and numerical relation between series/parallel hazards in risk and reliability modeling can be combined thus:
$$\begin{matrix}{\sum }_{i} ( {ω}_{i} {⋃}_{i} ) ⊆ {U}_{RPROCES SYSTEM} & ( 1 ) \\ {\prod }_{i = 1}^{N} ( {ω}_{i} {⋃}_{i} ) ⊆ {U}_{RPROCES SYSTEM} & ( 2 )\end{matrix}$$
Where i can represent, human, environment, process, mechanical, operational, environment hazards, and ω̅ᵢ takes only numerical values to qualify contributions of the safety aspects, and wherein the Weibull, gamma and Log-Normal Density functions can be used as representative Probability Functions, where Weights index in risk modeling provides consideration for the critical safety elements that may prevent human failure, in which the risk potential including weights is provided:
$$\begin{matrix}Risk Potential = \frac{1 - {\prod }_{i = 1}^{n} {( 1 - {r}_{i} )}^{{ω}_{I}}}{{\prod }_{i = 1}^{n} {( {R}_{si} )}^{{ω}_{I}}} & ( 3 ) \\ Risk Potential = \frac{{\prod }_{i = 1}^{n} {r}_{i}^{{ω}_{I}}}{1 - {\prod }_{i = 1}^{n} {( 1 - {R}_{si} )}^{{ω}_{I}}} & ( 4 )\end{matrix}$$
Where the ri inputs are expressed as exponential distributions
rᵢ(t)=1−e^{-λ}^{_{ω}}^{t}
Rₛᵢ(t)=e^{-λ}^{_{ω}}^{t}.

11. The apparatus of claim 1, further comprising a sub apparatus for providing a real-time computer based expert management and decision support systems for risk and safety design and management of FPSO's operating in a deepwater not relying on prior experience by using a fuzzy-belief systems to enable operates have a smart framework model for implementing critical safe decisions to advert loss in containment and profits.

12. A method for detecting faults and risk events of complex multifunctional systems and sub-systems arranged in a hierarchy comprising the steps of:
providing a plant having a pipeline layout design for transporting petroleum products in accordance with a plant process which comprises the systems and sub-systems in the hierarchy;
sensing operational and design variability of the systems and sub-systems in the hierarchy and providing sensor data output;
storing a database and a set of instructions in a memory device, programming the set of instructions to perform the steps of (i) analyzing sensor data output and constructing a Risk Safety Matrix System within the database having weights for each risk event, and GO providing a hazard chain modified safe bowtie system Hazard Risk HR-EFECT-COM-SAFE BOWTIE to identify all hazards, and analyzed threats, provide a safe index systems using the weight index to quantify the level of safety to control and manage the threats against release of containment from complex multifunctional systems and subsystems, an deriving the weights from a weight index in a fuzzy class belief variable in the Risk Safety Matrix System to assign the relative numerical value of a safety device.

13. The method of claim 12, wherein said programming step further includes establishing weights according to a Weighting Ranking Function used to construct a Fault Tree Weighted Superstructure and assigning relative weight to each Risk or Safety event in N-interacting Events, the weights being indicative of the safety index of the risk system.

14. The method of claim 13, wherein the Weighting Ranking Function is variable in time, process and system type, operating conditions and environment allowing the capturing of the Overall Risk or Reliability of the system and subsystems.

15. The method of claim 14, further comprising storing a history of Curve Failure data within the database that uses real time measurements from the sensor over a specified period of time.

16. The method of claim 15, further comprising assessing the risk by neural networks and fuzzy belief systems in combination with the Weighting Ranking Function and collectively providing reliability modeling to implement the safety aspects to risk systems.

17. The method of claim 16, wherein the fuzzy belief systems and neural network weights represent actual hazard data, and wherein the method further includes constructing further hazard data from Monte-Carlo Simulations that are stored in the database.

18. The method of claim 17, further including assessing the safety index on the basis of three fundamental parameters comprising (1) Failure Rate (FR), (2) Consequence Severity (CS), and (3) Failure Consequence Probability.

19. The method of claim 18, further comprising expressing the Failure Rate (FR) as a Homogeneous Poisson Process (HPP) probability distribution function given by:
$$f ( n ) = \frac{{( {ω}_{avg} λ t )}^{n} exp ( - {ω}_{avg} λ t )}{n !} n = 0 , 1 , 2 … \qquad ( 7 )$$
t is the time and λ is the constant failure or arrival rate. The cumulative failure distribution function is given by
$$\begin{matrix}F = {\sum }_{i = 0}^{n} \frac{{( {ω}_{avg} λ t )}^{i} exp ( - {ω}_{avg} λ t )}{i !} & ( 8 ) \\ {R}_{st} ( t ) = {\sum }_{i = 0}^{n} \frac{{( {ω}_{avg} λ t )}^{i} {e}^{- λ {ω}_{vg} t}}{i !} . & ( 9 )\end{matrix}$$

20. The method of claim 18, wherein the fuzzy belief systems include belief degrees in a rule that are accounted for by considering the relative weight of each rule among all rules (the rule weight), and the relative weight of each antecedent attribute (the attribute weight).

21. The method of claim 20, wherein the weights representing the safety aspects, hazard shape functions and numerical relation between series/parallel hazards in risk and reliability modeling can be combined thus:
$$\begin{matrix}{\sum }_{i} ( {ω}_{i} {⋃}_{i} ) ⊆ {U}_{RPROCES SYSTEM} & ( 1 ) \\ {\prod }_{i = 1}^{N} ( {ω}_{i} {⋃}_{i} ) ⊆ {U}_{RPROCES SYSTEM} & ( 2 )\end{matrix}$$
Where i can represent, human, environment, process, mechanical, operational, environment hazards, and ω̅ᵢ takes only numerical values to qualify contributions of the safety aspects, and wherein the Weibull, gamma and Log-Normal Density functions can be used as representative Probability Functions, where Weights index in risk modeling provides consideration for the critical safety elements that may prevent human failure, in which the risk potential including weights is provided:
$$\begin{matrix}Risk Potential = \frac{1 - {\prod }_{i = 1}^{n} {( 1 - {r}_{i} )}^{{ω}_{I}}}{{\prod }_{i = 1}^{n} {( {R}_{si} )}^{{ω}_{I}}} & ( 3 ) \\ Risk Potential = \frac{{\prod }_{i = 1}^{n} {r}_{i}^{{ω}_{I}}}{1 - {\prod }_{i = 1}^{n} {( 1 - {R}_{si} )}^{{ω}_{I}}} & ( 4 )\end{matrix}$$
Where the ri inputs are expressed as exponential distributions
rᵢ(t)=1−e^{-λ}^{_{ω}}^{t}
Rₛᵢ(t)=e^{-λ}^{_{ω}}^{t}.

22. The method of claim 12, further comprising a sub apparatus for providing a real-time computer based expert management and decision support systems for risk and safety design and management of FPSO's operating in a deepwater not relying on prior experience by use of a fuzzy-belief systems to enable operates have a smart framework model for implementing critical safe decisions to advert loss in containment and profits.
